(19) United States
(12) Patent Application Publication
(10) Pub. No.: US 2003/0050411 A1
(43) Pub. Date: Mar. 13, 2003

(54) Use of polar monomers in olefin polymerization and polymers thereof

(75) Inventors: Scott Gaynor, Midland, MI (US); Michael Mullins, Lake Jackson, TX (US); Phillip Athey, Lake Jackson, TX (US); Harold Boone, Sugar Land, TX (US)

Correspondence Address: JENKENS & GILCHRIST, A PROFESSIONAL CORPORATION, 1100 LOUISIANA, SUITE 1800, HOUSTON, TX, 77002-5214, US

(73) Assignee: Dow Global Technologies Inc., Midland, MI

(21) Appl. No.: 10/167,972

(22) Filed: Jun. 11, 2002

Related U.S. Application Data
(60) Provisional application No. 60/297,642, filed on Jun. 12, 2001.

(51) Int. Cl. C08F 4/40

(52) U.S. Cl. 526/90; 526/170; 526/335; 526/282; 526/346; 526/348.5; 526/348.2; 526/348.3; 526/344; 526/330; 526/319; 526/316; 526/341; 526/303.1

(57) ABSTRACT

A polymerization process comprises (1) contacting at least one polymerizable monomer in the presence of a metal catalyst in a reactor; (2) effectuating polymerization of the monomer; (3) adding a substituted olefin having at least one polar group to the reactor. The substituted olefin is different from the monomer. Vinyl-terminated macromers preferably are generated which can be homopolymerized or copolymerized with the monomer by the metal catalyst. A polymer of an olefin monomer and a substituted olefin comprising a backbone and a plurality of side chains. The polymer is characterized by an Rᵥ of greater than about 0.85, where Rᵥ is a measure of the relative number of vinyl groups in the polymer. In some polymers, the vinyl endgroups are transformed to other useful end groups.

### PRIOR RELATED APPLICATIONS

This patent application claims priority to U.S. Provisional Application Serial No. 60/297,642, filed on Jun. 12, 2001, the disclosure of which is incorporated by reference in its entirety herein.

### FEDERALLY SPONSORED RESEARCH STATEMENT

Not applicable.

### REFERENCE TO MICROFICHE APPENDIX

Not applicable.

### FIELD OF THE INVENTION

This invention relates to a process for making olefin polymers and products therefrom.

### BACKGROUND OF THE INVENTION

Ethylene homopolymers and copolymers are a well-known class of olefin polymers from which various plastic products are produced. Such products include films, fibers, coatings, and molded articles, such as containers and consumer goods. The polymers used to make these articles are prepared from ethylene, optionally with one or more copolymerizable monomers. There are many types of polyethylene. For example, low density polyethylene (“LDPE”) is generally produced by free radical polymerization and consists of highly branched polymers with long and short chain branches distributed throughout the polymer. Due to its branched structure, LDPE generally is easy to process, i.e., it can be melt processed in high volumes at low energy input. However, films of LDPE have relatively low toughness, low puncture resistance, low tensile strength, and poor tear properties, compared to linear-low density polyethylene (“LLDPE”). Moreover, the cost to manufacture LDPE is relatively high because it is produced under high pressures (e.g., as high as 45,000 psi) and high temperatures. Most LDPE commercial processes have a relatively low ethylene conversion. As such, large amounts of unreacted ethylene must be recycled and repressurized, resulting in an inefficient process with a high energy cost.

A more economical process to produce polyethylene involves use of a coordination catalyst, such as a Ziegler-Natta catalyst, under low pressures. Conventional Ziegler-Natta catalysts are typically composed of many types of catalytic species, each having different metal oxidation states and different coordination environments with ligands. Examples of such heterogeneous systems are known and include metal halides activated by an organometallic co-catalyst, such as titanium chloride supported on magnesium chloride, activated with trialkyl aluminum. Because these systems contain more than one catalytic species, they possess polymerization sites with different activities and varying abilities to incorporate comonomer into a polymer chain. The consequence of such multi-site chemistry is a product with relatively poor control of the polymer chain architecture, when compared to a neighboring chain. Moreover, differences in the individual catalyst site produce polymers of high molecular weight at some sites and low molecular weight at others, resulting in a polymer with a broad molecular weight distribution and a heterogeneous composition. Consequently, the molecular weight distribution of such polymers is fairly broad as indicated by M_{w}/Mₙ (also referred to as polydispersity index or “PDI” or “MWD”) Due to the heterogeneity of the composition, their mechanical and other properties are less desirable.

Recently, a new catalyst technology useful in the polymerization of olefins has been introduced. It is based on the chemistry of single-site homogeneous catalysts, including metallocenes which are organometallic compounds containing one or more cyclopentadienyl ligands attached to a metal, such as hafnium, titanium, vanadium, or zirconium. A co-catalyst, such as oligomeric methyl alumoxane, is often used to promote the catalytic activity of the catalyst. By varying the metal component and the substituents on the cyclopentadienyl ligand, a myriad of polymer products may be tailored with molecular weights ranging from about 200 to greater than 1,000,000 and molecular weight distributions from 1.0 to about 15. Typically, the molecular weight distribution of a metallocene catalyzed polymer is less than about 3, and such a polymer is considered as a narrow molecular weight distribution polymer.

The uniqueness of metallocene catalysts resides, in part, in the steric and electronic equivalence of each active catalyst molecule. Specifically, metallocenes are characterized as having a single, stable chemical site rather than a mixture of sites as discussed above for conventional Ziegler-Natta catalysts. The resulting system is composed of catalysts which have a singular activity and selectivity. For this reason, metallocene catalyst systems are often referred to as “single site” owing to their homogeneous nature. Polymers produced by such systems are often referred to as single site resins in the art.

With the advent of coordination catalysts for ethylene polymerization, the degree of long-chain branching in an ethylene polymer was substantially decreased, both for the traditional Ziegler-Natta ethylene polymers and the newer metallocene catalyzed ethylene polymers. Both, particularly the metallocene copolymers, are linear polymers or substantially linear polymers with a limited level of long chain branching. These polymers are relatively difficult to melt process when the molecular weight distribution is less than about 3.5. Thus, a dilemma appears to exist—polymers with a broad molecular weight distribution are easier to process but may lack desirable solid state attributes otherwise available from metallocene catalyzed copolymers. On the contrary, linear or substantially linear polymers catalyzed by a metallocene catalyst have desirable physical properties in the solid state but may nevertheless lack the desired processability when in the melt.

The introduction of long chain branches into substantially linear olefin copolymers has been observed to improve processing characteristics of the polymers. Current methods for inducing long chain branching include the use of diene comonomers. Incorporation of the first unsaturated group into a polymer chain results in a polymer chain with a pendent unsaturated group which can later be incorporated by a second growing chain, resulting in a branch point. However, the presence of more than one unsaturated group per polymer chain leads to a functionality greater than two (f>2), which is known in the art to lead to crosslinking of polymer chains (See, e.g., Odian, G., Principles of Polymerization, 3^{rd} ed., John Wiley & Sons, Inc., New York, 1991, pp. 510-516). As crosslinking reactions lead to intractable and non-flowable materials the formation of undesirable gels in the material (as determined by xylene extraction, specifically by ASTM 2765), processing of the polymer may become difficult, if not impossible.

Another method of creating long chain branches is post reactor coupling of the polymers through unsaturated functional end groups by radical reactions or other chemical reactions known in the art or by chemical modification of a saturated or unsaturated polymer to form a chemical bond and thus form a branch point. These methods, however, may lead to crosslinking and poor processability if excessive numbers of individual polymer chains become interconnected.

In-reactor formation of long-chain branches has been observed in metallocene-catalyzed polymers where olefinically unsaturated chain ends are produced during the polymerization reaction. The process involves the beta-hydride elimination of a hydrogen from the growing polymer chain via abstraction by the metal catalyst. Beta-hydride elimination, a chain termination step in olefin polymerization, leads to olefinically unsaturated chain ends (Odian, G., Principles of Polymerization, 3^{rd} ed., John Wiley & Sons, Inc., New York, 1991, pp. 646-647). The olefinically unsaturated polymer chains then become “macromonomers” or “macromers” and can be re-inserted with other copolymerizable monomers to form branched copolymers.

For various reasons, the levels of long chain branching attainable with known methods thus far are not as high as those observed in LDPE made by free radical polymerization. For example, in beta-hydride elimination reactions, vinyl, vinylidene and trans-vinylidene end groups in the macromers are formed. Only the vinyl end groups are relatively reactive toward further polymerization.

Branching in metallocene-catalyzed polymers can be increased by improving the yield of vinyl containing macromonomers produced by beta-hydride elimination. For example, methods have been described which use catalysts to induce beta-hydride transfer to produce unsaturated end groups which are mostly vinyl. Furthermore, monomer type and comonomer concentration are known to influence the yield of unsaturated end groups and the percentage of the yield which are vinyl end groups. Catalyst selection, chain transfer agents, temperature, and other process conditions also affect the production of vinyl end groups from beta-hydride elimination. In some polymerization systems, the degree of polymerization is generally proportional to the ratio of the rate of chain propagation to the rate of termination (or transfer). Moreover, an increase in the rate of beta-hydride elimination, although leading to higher vinyl terminated macromers, may result in a decrease in the chain propagation rate. Thus, an increased concentration of vinyl terminated macromers through beta-hydride elimination may come at the expense of the molecular weight of the polymer. Moreover, it has also been found that direct use of macromers in copolymerization requires prior deactivation of the catalyst used to form the macromers; this deactivation requires the use of additional catalysts and constitutes an additional process step.

Therefore, there exists a need for a method for generating vinyl terminated macromers in a polymerization system without substantially affecting the obtainable molecular weight of the polymer. There is also a need for a polymerization method for directing incorporating the vinyl terminated macromers into a growing polymer chain to generate long-chain branching in the resulting polymer.

### SUMMARY OF THE INVENTION

The above needs are met by various embodiments disclosed herein. For example, in some embodiments the invention is directed to a polymerization process that includes (a) contacting at least one polymerizable monomer in the presence of a metal catalyst in a reactor, (b) effectuating polymerization of the monomer (c) adding a substituted olefin having at least one polar group to the reactor, the substituted olefin being different from the monomer wherein the polymerization process is characterized by a chain transfer constant Cₛ=kₚ , in the range from about 10,000 to about 0.0000001. In certain embodiments, the chain transfer constant, Cₛ, is in the range from about 1,000 to about 0.000001 or about 100 to about 0.00001. In other embodiments, the chain transfer constant, Cₛ, is in the range from about 10 to about 0. 00001, about 1 to about 0.0001, or about 0.1 to about 0.001

Some such processes employ a Ziegler-Natta type catalyst. In other processes the catalyst is a metallocene catalyst, including constrained geometry catalysts. Other processes employ a non-metallocene single site catalyst.

Embodiments of the polymerization processes described herein are useful for the polymerization of α-olefin monomers. The alpha-olefin monomers are polymerized with a substituted olefin selected from the group consisting of vinyl fluoride, vinyl chloride, vinyl bromide, vinyl iodide, vinyl acetate, methyl acrylate, methyl vinyl ether, vinyl ketones, isobutyl vinyl ether, vinyl amines, vinyl amides, acrylonitrile, acrylamide, vinyl oxazoles, vinyl thiazoles, and vinyl ethers. In some processes, vinyl chloride is an especially useful substituted olefin.

In certain embodiments, vinyl terminated macromers are formed by the processes described herein. In certain embodiments, the concentration of the substituted olefin is employed to influence the concentration of the macromers in the process. Macromers formed in the process may optionally be copolymerized with the monomer. In other processes, the macromers are homopolymerized. Alternatively, two of the macromers are coupled together via an acyclic diene metathesis reaction.

In other embodiments, processes of making polymers include (a) contacting one or more olefinic monomers in the presence of a catalyst in a reactor, (b) adding a chain transfer agent having a substituted olefin with at least one polar functional group to the reactor, and (c) forming an olefinic macromer from the olefinic monomers and the substituted olefin. In some embodiments, these processes further include incorporating the olefinic macromer into a polymer backbone so that the macromer becomes a long chain branch of the polymer backbone.

Some processes described herein form a polymer that is a substantially linear polymer having vinyl end groups.

Some polymers described herein have 0.01 or more long chain branches per 1000 carbon atoms. Other polymers have 0.1 or more long chain branches per 1000 carbon atoms, 1 or more long chain branches per 1000 carbon atoms, 2 or more long chain branches per 1000 carbon atoms, 5 or more long chain branches per 1000 carbon atoms or 10 or more long chain branches per 1000 carbon atoms. Some polymers are characterized as having a long chain branch for each repeating unit or as having a comb-like structure.

Also described are polymers of an olefin monomer and a substituted olefin in which the polymer has a backbone chain, a plurality of side chains, and is characterized by a Rᵥ value of greater than about 0.85, as defined in the following:

$${R}_{v} = \frac{[ vinyl ]}{[ vinyl ] + [ vinylidene ] + [ cis ] + [ trans ]}$$

wherein [vinyl] is the concentration of vinyl groups in the olefin polymer expressed in vinyls/1,000 carbon atoms; [vinylidene], [cis] and [trans] are the concentration of vinylidene, cis and trans groups in the olefin polymer expressed in the number of the respective groups per 1,000 carbon atoms. Some polymers have an Rᵥ is about 0.90 or greater, about 0.95 or greater. In other polymers, Rᵥ is 1.0

The polymers described herein have a molecular weight distribution (M_{w}/Mₙ) ranging from about 1.5 to about 100. Polymers with a molecular weight distribution (M_{w}/Mₙ) ranging from about 1.5 to about 10 may be preferred in certain embodiments. In other embodiments, a molecular weight distribution (M_hd w/Mₙ) ranging from about 2.5 to about 8 or from about 3 to about 6 may be preferred.

Polymers described herein are also characterized by a molecular weight (M_{w}) ranging from about 1000 to about 100,000,000. Some such polymers have 0.01 or more long chain branches per 1000 carbon atoms, 0.1 or more long chain branches per 1000 carbon atoms. Others have about 0.5 or more long chain branches per 1000 carbon atoms, 1 or more long chain branches per 1000 carbon atoms, or 2 or more long chain branches per 1000 carbon atoms. Still others have 5 or more long chain branches per 1000 carbon atoms or 10 or more long chain branches per 1000 carbon atoms. Alternatively, polymers having such a molecular weight have a long chain branch for each repeating unit.

In some embodiments the polymer includes olefin monomer is an α-olefin. Exemplary α-olefin monomers include ethylene, propylene, 1-butene, 1-hexene, 1-octene, 1-decene, vinyl-cyclohexene, styrene, ethylidene norbornene, norbornadiene, 1,5-hexadiene, 1,7-octadiene, and 1,9-decadiene.

Exemplary substituted olefin monomers in the described polymers include vinyl fluoride, vinyl chloride, vinyl bromide, vinyl iodide, vinyl acetate, methyl acrylate, methyl vinyl ether, vinyl ketones, isobutyl vinyl ether, vinyl amines, vinyl amides, acrylonitrile, acrylamide, vinyl oxazoles, vinyl thiazoles, and vinyl ethers. In some applications polymers wherein the substituted olefin is vinyl chloride monomer are particularly useful.

Some polymers described herein are also characterized by an I₁₀/I₂ ranging from about 1 to about 20. Others have an I₁₀/I₂ ranging from about 2 to about 10 or from about 6 to about 8.

In some embodiments polymers of an olefin monomer and a substituted olefin have a backbone chain having endgroups; and a plurality of side chains, wherein about 85% to 100% of the backbone chain endgroups are vinyl groups. Other polymers comprise a backbone chain having endgroups; and a plurality of side chains, wherein about 85% to 100% of the backbone chain endgroups are selected from the group consisting of halide, amine, azide, carboxylic acid, ester, epoxide, alcohol, silane, siloxane, boron, cyano, isocyanate, phosphonium, sulfate, and ammonium groups. In certain embodiments, such polymers are linear or substantially linear polymers.

Other embodiments provide for articles of manufacture comprising any of the disclosed compositions. Exemplary articles include, but are not limited to, films, fibers, moldings, coatings, profiles, pouches, sealant films, carpet backings, liners, shrink films, stretch films, extrusion coatings, laminating films, rotomoldings, and pipes. Articles such as sacks and bags can also be fabricated. Some sacks and bags are fabricated using form-fill-seal (FFS) equipment or vertical form-fill-seal equipment.

### BRIEF DESCRIPTION OF THE DRAWINGS

FIG. 1. is a plot simulating the concentration distribution of various components in a plug flow reactor in accordance with one embodiment of the invention.

FIG. 2 is a Mark-Houwink plot for the ethylene polymer made in Example 9 at various reaction times.

FIG. 3 is a Mark-Houwink plot for the ethylene polymer made in Example 11.

FIG. 4 is a plot of 1/Xₙ versus [VCM]/[Ethylene] for determining Cₛ.

FIG. 5 is Mark-Houwink Plot of an ethylene polymer made in Example 20A.

### DESCRIPTION OF EMBODIMENTS OF THE INVENTION

Embodiments of the invention provide a new process for making olefin polymers with desired processability and other physical characteristics. The process comprises contacting at least one polymerizable monomer in the presence of a metal catalyst in a reactor; effectuating polymerization of the monomer; and adding a substituted olefin with at least one polar group to the reactor. The substituted olefin is different from the monomer and is selected such that the substituted olefin does not substantially decrease the polymerization activity of the metal catalyst, i.e., it does not completely deactivate the polymerization catalyst. The metal catalyst can be a Ziegler-Natta catalyst, a metallocene catalyst, non-metallocene single site catalyst, or any other polymerization catalyst. Preferably, the metal catalyst is a metallocene catalyst.

The term “polymer” as used herein refers to a macromolecular compound prepared by polymerizing monomers of the same or a different type. A polymer refers to homopolymers, copolymers, terpolymers, interpolymers, and so on. The term “interpolymer” used herein refers to polymers prepared by the polymerization of at least two types of monomers or comonomers. It includes, but is not limited to, copolymers (which usually refers to polymers prepared from two different monomers or comonomers), terpolymers (which usually refers to polymers prepared from three different types of monomers or comonomers), and tetrapolymers (which usually refers to polymers prepared from four different types of monomers or comonomers), and the like. The term “monomer” or “comonomer” refers to any compound with a polymerizable moiety which is added to a reactor in order to produce a polymer. “Metallocene catalyzed polymer” used herein refers to any polymer that is made in the presence of one metallocene catalyst or one constrained geometry catalyst. The term “metallocene” as used herein refers to a metal-containing compound having at least one substituted or unsubstituted cyclopentadienyl group bound to the metal. “Single-site” catalysts refers to a catalyst system wherein each metal center of the catalyst system has one site that is active towards the polymerization of monomers and wherein the active site of each metal center has essentially the same structure and activity towards the monomers under polymerization conditions.

The polymerization process in accordance with some embodiments of the invention combines non-polar monomers with polar monomers (also referred to as “substituted monomer,”“functional monomer,” or “FM”) in a single polymerization reactor in the presence of a metal catalyst. Preferably, the functional monomer is used as a chain transfer agent which generates vinyl terminated macromers (also referred to herein as “macromonomers”) in the polymerization reactor. Suitable non-polar monomers include any polymerizable compounds. However, the selection of a suitable functional monomer depends on the particular metal catalyst used. First, the functional monomer should not substantially decrease the polymerization activity of the catalyst. In other words, the functional monomer should not poison or deactivate the metal catalyst. Moreover, the functional monomer should be able to generate macromers in the polymerization reactor. Preferably, the macromers are vinyl terminated. In some embodiments, by varying the concentration of the functional monomer, it is possible to control the concentration of the macromers generated in the reactor and the molecular weight of the resulting polymer.

Disclosed herein is the use of a functional monomer where upon insertion of the functional monomer in the polymer-metal bond of the growing polymer chain, undergoes beta elimination of the functional group to yield a vinyl terminated macromer. Such a process is possible due to the electrophilic nature of the catalyst's transition metal active site (Mₜ) and the electron rich polar group (X) of the functional monomer. The functional group is transferred to the metal center and the polymer chain is eliminated with the unsaturated vinyl end group as illustrated in Scheme 1. The Mₜ-X complex can be regenerated to its active form by reaction with an activating component in the reaction, by spontaneous dissociation from the metal center, or by direct reaction with monomer. The formed polymer (or macromer) contains substantially vinyl end groups, in comparison to other methods dependent on beta-hydride elimination (vide supra).

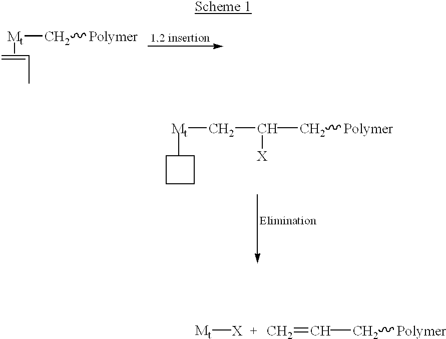

The molecular weight of the polymer chain is attenuated or controlled by the relative rate of insertion of the functional monomer relative to the rate of propagation of the non-functional monomer or monomers in the polymerization. Thus it is possible to control the molecular weight by adjustment of the ratio of FM to the monomer(s) being polymerized by the catalyst; this is done by simple variation of the FM concentration in the reaction mixture. Consequently, the overall concentration of the resulting macromonomer in the reaction mixture is also readily controlled by changing the FM concentration. This is in contrast to other processes where the concentration of the macromonomer is dependent on the rate of beta-hydride elimination by the catalyst, which is a temperature dependent process.

The relative rate of insertion of the FM, compared to that of the monomer or monomers being polymerized, should preferably be such so as to allow for the formation of at least oligomeric species, whereby control of the resulting macromonomer molecular weight can be readily adjusted by variation of the transfer agent concentration in the reaction medium. The relative rate of reaction between the FM and the monomer(s) being polymerized, where reaction with the FM results in a break in the chain propagation, has been described as chain transfer in classical radical reactions. A similar understanding of the process can be applied here, where the molecular weight of the polymer is proportional to the ratio of the relative rate of reaction of the FM to the monomer and the relative concentrations of each, see the following equation,

$$\frac{1}{{X}_{n}} = \frac{1}{{X}_{n0}} + {C}_{s} * \frac{[ X ]}{[ M ]}$$

where Xₙ is the number average degree of polymerization (number of repeat units), Xₙ₀ is the number average degree of polymerization in the absence of a transfer agent, i.e., FM, [X] is the concentration of transfer agent, and [M] is the total concentration of monomer in the reaction medium. The chain transfer constant, Cₛ, is defined as the relative rate of reaction between the transfer agent (kₜᵣ) and the rate of propagation (kₚ) of the monomer by the growing polymer chain, C_{S}=kₜᵣ/kₚ. Since fast elimination of the functional group by beta-X elimination before subsequent insertion of monomer or a second transfer agent is desired, the rate constant kₜᵣ can be equated to the rate of propagation of the FM; therefore Cₛ is also the reactivity ratio of the two monomers.

The reactivity ratios of metal catalysts in general are obtained by known methods, for example, as described in “Linear Method for Determining Monomer Reactivity Ratios in Copolymerization”, M. Fineman and S. D. Ross, J. Polymer Science 5, 259 (1950) or “Copolymerization”, F. R. Mayo and C. Walling, Chem. Rev. 46, 191 (1950) incorporated herein in its entirety by reference. For example, to determine reactivity ratios the most widely used copolymerization model is based on the following equations:

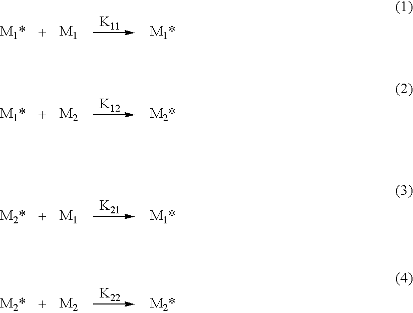

where Mᵢ refers to a monomer molecule which is arbitrarily designated as “i” where i=1, 2; and M₂* refers to a growing polymer chain to which monomer i has most recently attached.

The kᵢⱼ values are the rate constants for the indicated reactions. For example, in ethylene/propylene copolymerization, k₁₁ represents the rate at which an ethylene unit inserts into a growing polymer chain in which the previously inserted monomer unit was also ethylene. The reactivity ratios follow as: r₁=k₁₁/k₁₂ and r₂=k₂₂ /k₂₁ wherein k₁₁, k₁₂, k₂₂ and k₂₁ are the rate constants for ethylene (1) or propylene (2) addition to a catalyst site where the last polymerized monomer is an ethylene (k₁ₓ) or propylene (k₂ₓ).

The transfer reaction step involves the reaction of the active catalyst center with the FM, followed by elimination of the functional group. The rate of elimination is known to be much faster than coordination/insertion , the rate of transfer (kₜᵣ) can be equated to the rate of reaction of the catalyst with the functional monomer, kₜᵣ=k₁₂. The reactivity ratio r₂ is undefined as both k₂₂ and k₂₁ are zero since the active catalyst species Mt-CH₂-CH(X)-polymer does not react with either monomer or FM but undergoes β-X elirtiination to yield a vinyl terminated polymer chain and the metal-X species. Further, the rate of opropagation (kₚ) is the rate of the reaction of the polymerizable monomer with the growing polymer chain, kₚ=k₁₁. Therefore, the chain transfer constant, Cₛ, can be defined as Cₛ=kₜᵣ/kₚ.

Cₛ can be measured from the plot of the average degree of polymerization, 1/Xₙ, versus the ratio concentration of functional monomer to the concentration of monomer. One way to estimate concentrations uses Henry's Law and is described in Macromolecules, 34, 2040-2047 (2001), which is incorporated herein by reference in its entirety. Cₛ is the slope of the straight line fit of this data. However, any suitable method may be used. Cₛ may range from about 10,000 to about 0.0000001, from about 1,000 to about 0.000001, from about 100 to about 0.00001, from about 10 to about 0. 00001, from about 1 to about 0.0001, or from about 0.1 to about 0.001, although other ranges are also possible.

The resulting macromonomer that is prepared can then be used in a variety of other processes to obtain polymers of differing composition, topology and functionality imparting unique physical and mechanical properties to the bulk polymer. For example, and not to be presented as a limiting example, the macromonomer can be substantially linear when the reaction times are kept short so that the formed macromonomer does not have the opportunity to be incorporated into growing chains. Conversely, long reaction times will result in incorporation of the macromonomer and thus form branched polymers. By controlling the concentration of the macromonomer in the reactor, and the reaction time the level of branching of the final polymer can be adjusted: higher concentrations of macromonomer will lead to more highly branched polymer and lower concentrations of macromonomer to less branching. The obtained polymers/macromonomers may be substantially linear, lightly branched, moderately branched or highly branched including polymers with branches upon branches.

Long Chain Branching

The interpolymers produced in accordance with some embodiments of the invention have relatively high levels of long chain branches (“LCB”). Long chain branching is formed in the novel interpolymers disclosed herein by re-incorporation of vinyl-terminated polymer chains. As such, the distribution of the length of the LCBs correspond to the molecular weight distribution of vinyl-terminated polymer molecules within the polymer sample. Long-chain branches for the purposes of this invention represent the branches formed by re-incorporation of vinyl-terminated macromers, not the branches formed by incorporation of the comonomers. The number of carbon atoms on the long chain branches may range from four, five, six or seven to several thousands, depending on the polymerization conditions. The level of LCBs refers to the number of long chain branches per 1000 carbon atoms. Typically, the level of LCBs in the interpolymers is about 0.01 branch/1000 carbons or higher. Some interpolymers may have about 0.05 to 1 LCB/1000 carbons, or even 0.05 to about 3 or 5 LCBs/1000 carbons, whereas other interpolymers may have about 0.1 LCBs/1000 carbons to about 10 LCBs/1000 carbons. Still other interpolymers may have LCB exceeding 10/1000 carbons. The presence of a higher level of LCB may have some beneficial effects. For example, an ethylene interpolymer with LCBs is observed to possess improved processability, such as shear thinning and delayed melt fracture, as described in U.S. Pat. Nos. 5,272,236, 5,278,272, 5,783,638, and 6,348,555, each of which is incorporated herein by reference in its entirety. It is expected that a higher level of LCB in an interpolymer may further improve melt processability.

For certain of the embodiments of the present invention, the polymers can be described as having a “comb-like” LCB structure. For the purposes of this invention, a “comb-like” LCB structure refers to the presence of significant levels of polymer molecules having a relatively long backbone and having a plurality of long chain branches which are relatively short compared to the length of the backbone. LCB's that generally are less than about one third of the length of the polymer backbone on average are considered to be relatively short for the purposes of this invention. For example, a polymer comprising individual molecules having a backbone of about 5,000 carbons on average and 3 long chain branches of about 500 carbons each on average would have a “comb-like” structure.

The interpolymers made in accordance with some embodiments of the invention are unique in the following ways: they differ from LDPE in that they have a relatively narrow molecular weight distribution and a controlled long-chain branch structure; on the other hand, they differ from a typical metallocene catalyzed polymer in that their processability is better. Thus, certain of the interpolymers bridge the gap between LDPE and currently available metallocene catalyzed polymers.

Various methods are known for determining the presence of long chain branches. For example, long chain branching can be determined for some of the inventive interpolymers disclosed herein by using ¹³C nuclear magnetic resonance (NMR) spectroscopy and to a limited extent, e.g. for ethylene homopolymers and for certain copolymers, and it can be quantified using the method of Randall, (Journal of Macromolecular Science, Rev. Macromol.Chem. Phys., C29 (2&3), p. 285-297). Although conventional ¹³C nuclear magnetic resonance spectroscopy cannot determine the length of a long chain branch in excess of about six carbon atoms, there are other known techniques useful for quantifying or determining the presence of long chain branches in ethylene polymers, such as ethylene/1-octene interpolymers. For those interpolymers wherein the 13C resonances of the comonomer overlap completely with the ¹³C resonances of the long-chain branches, either the comonomer or the other monomers (such as ethylene) can be isotopically labeled so that the LCB can be distinguished from the comonomer. For example, a copolymer of ethylene and 1-octene can be prepared using ¹³C-labeled ethylene. In this case, the LCB resonances associated with macromer incorporation will be significantly enhanced in intensity and will show coupling to neighboring ¹³C carbons, whereas the octene resonances will be unenhanced.

Other methods include the technique disclosed in US Pat. No. 4,500,648, incorporated by reference herein in its entirety, which teaches that long chain branching frequency (“LCBF”) can be represented by the equation LCBF=b/M_{w} wherein b is the weight average number of long chain branches per molecule and Mw is the weight average molecular weight. The molecular weight averages and the long chain branching characteristics are determined by gel permeation chromatography and intrinsic viscosity methods, respectively.

Two other useful methods for quantifying or determining the presence of long chain branches in ethylene polymers, such as ethylene/1-octene interpolymers, are gel permeation chromatography coupled with a low angle laser light scattering detector (GPC-LALLS) and gel permeation chromatography coupled with a differential viscometer detector (GPC-DV). The use of these techniques for long chain branch detection and the underlying theories have been well documented in the literature. See, e.g., Zimm, G. H. and Stockmayer, W. H., J. Chem. Phys., 17, 1301 (1949) and Rudin, A., Modem Methods of Polymer Characterization, John Wiley & Sons, New York (1991) pp. 103-112, the disclosures of both of which are incorporated by reference. Still another method for determining long chain branching is using GPC-FTIR as described by Markel, E. J., et al. Macromolecules, 2000, 33, 8541-48 (2000), which is incorporated by reference herein in its entirety.

In addition to the concentration of FM, the formation of long chain branching may also depend on a number of other factors, including but not limited to, monomer (or comonomer) concentration, the use of other transfer agents, reactor temperature, pressure, polymer concentration, and catalyst(s) used. Generally, a higher level of long chain branching may be obtained when a polymerization reaction is operated at a higher temperature, a lower comonomer concentration, a higher polymer concentration, and using catalysts which can generate a relatively high percentage of vinyl end groups. Conversely, a lower level of long chain branching may be obtained when a polymerization reaction is operated at a lower temperature, a higher comonomer concentration, a lower polymer concentration, and using catalysts which can generate a relatively low percentage of vinyl end groups.

Functional Monomer

In the present invention, the polar group containing monomer (FM) is of the formula:

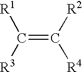

where R¹, R², R³ and R⁴ are independently selected from the group consisting of H, halogen, CN, straight or branched alkyl of from 1 to 20 carbon atoms (preferably from 1 to 6 carbon atoms, more preferably from 1 to 4 carbon atoms) which may be substituted with from 1 to (2n+1) halogen atoms where n is the number of carbon atoms for the alkyl group (e.g., CF₃), alpha, beta-unsaturated straight of branched alkenyl or alkynyl of 2 to 10 carbon atoms (preferably from 2 to 6 carbon atoms, more preferably from 2 to 4 carbon atoms) which may be substituted with from 1 to (2n-1) halogen atoms, where n is the number of carbon atoms of the alkyl group, C₃-C₈ cycloalkyl group which may be substituted with from 1 to (2n-1) halogen atoms where n is the number of carbon atoms of the cycloalkyl group, aryl (where each hydrogen atom may be replaced with halogen, or alkyl of from 1 to 20 carbon atoms), YR⁵, C(=Y)R⁵, C(=Y)NR⁶R⁷, YC(=Y)R⁵, SOR⁵, SO₂R, OSO₂R⁵, NR⁸SO₂R⁵, PR⁵₂, P(=Y)R⁵, YPR⁵₂, YP(=Y)R⁵₂, NR⁸₂, which may be quatemized with and additional R⁸ group, aryl and heterocyclyl; where Y may be NR⁸, S or O (preferably O); R⁵ is alkyl of from 1 to 20 carbon atoms, alkylthio of from 1 to 20 carbon atoms, OR⁹ (where R⁹ is H or an alkali metal), alkoxy of from 1 to 20 carbon atoms, aryloxy or heterocyclyloxy; R⁶ and R⁷ may be joined together to form an alkylene group of from 2 to 7 (preferably 2 to 5) carbon atoms, thus forming a 3- to 8-membered (preferably 3- to 6-membered) ring, and R⁸ is H, straight or branched C₁-C₂₀ alkyl or aryl; at least two of R¹, R², R³ and R⁴ are H or halogen. In some embodiments, the functional monomer includes one and only one polar group.

More specifically, preferred polar group containing monomers include vinyl fluoride, vinyl chloride, vinyl bromide, vinyl iodide, vinyl acetate, acrylate esters of C₁-C₂₀ alcohols, vinyl ketones, vinyl amines, vinyl amides, acrylonitrile, acrylamide, vinyl oxazoles, vinyl thiazoles, and vinyl ethers. The most preferred monomers include vinyl chloride, vinyl bromide, vinyl iodide, vinyl acetate, methyl acrylate, methyl vinyl ether and isobutyl vinyl ether.

Monomers

The process described herein may be employed to prepare any olefin polymers, including but not limited to, ethylene/propylene, ethylene/1-butene, ethylene/1-hexene, ethylene/4-methyl-1-pentene, ethylene/styrene, ethylene/propylene/styrene, and ethylene/1-octene copolymers, isotactic polypropylene/1-butene, isotactic polypropylene/1-hexene, isotactic polypropylene/1-octene, terpolymers of ethylene, propylene and a non-conjugated diene, i.e., EPDM terpolymers, as well as homopolymers of ethylene, propylene, butylene, styrene, etc.

Olefins as used herein refer to a family of unsaturated hydrocarbon-based compounds with at least one carbon-carbon double bond. Depending on the selection of catalysts, any olefin may be used in embodiments of the invention. Preferably, suitable olefins are C₂₋₂₀ aliphatic and aromatic compounds containing vinylic unsaturation, as well as cyclic compounds, such as cyclobutene, cyclopentene, dicyclopentadiene, and norbomene, including but not limited to, norbornene substituted in the 5 and 6 position with C₁₋₂₀ hydrocarbyl or cyclohydrocarbyl groups. Also included are mixtures of such olefins as well as mixtures of such olefins with C₄-₄₀ diolefin compounds.

Examples of olefin monomers include, but are not limited to ethylene, propylene, isobutylene, 1-butene, 1-pentene, 1-hexene, 1-heptene, 1-octene, 1-nonene, 1--decene, and 1-dodecene, 1-tetradecene, 1-hexadecene, 1-octadecene, 1-eicosene, 3-methyl-1-butene, 3-methyl-1-pentene, 4-methyl-1-pentene, 4,6-dimethyl-1-heptene, 4-vinylcyclohexene, vinylcyclohexane, norbornadiene, ethylidene norbornene, cyclopentene, cyclohexene, dicyclopentadiene, cyclooctene, C₄-₄₀ dienes, including but not limited to 1,3-butadiene, 1,3-pentadiene, 1,4-hexadiene, 1,5-hexadiene, 1,7-octadiene, 1,9-decadiene, other C₄₋₄₀ α-olefins, and the like. Although any hydrocarbon containing a vinyl group potentially may be used in embodiments of the invention, practical issues such as monomer availability, cost, and the ability to conveniently remove unreacted monomer from the resulting polymer may become more problematic as the molecular weight of the monomer becomes too high.

The novel processes described herein are well suited for the production of olefin polymers comprising monovinylidene aromatic monomers including styrene, o-methyl styrene, p-methyl styrene, t-butyl styrene, and the like. In particular, interpolymers comprising ethylene and styrene can be advantageously prepared by following the teachings herein. Optionally, copolymers comprising ethylene, styrene and a C₃₋₂₀ alpha olefin, optionally comprising a C₄₋₂₀ diene, having improved properties over those presently known in the art can be prepared.

Suitable non-conjugated diene monomers can be a straight chain, branched chain or cyclic hydrocarbon diene having from 6 to 15 carbon atoms. Examples of suitable non-conjugated dienes include, but are not limited to, straight chain acyclic dienes, such as 1,4-hexadiene, 1,6-octadiene, 1,7-octadiene, 1,9-decadiene, branched chain acyclic dienes, such as 5-methyl-1,4-hexadiene; 3,7-dimethyl-1,6-octadiene; 3,7-dimethyl-1,7-octadiene and mixed isomers of dihydromyricene and dihydroocinene, single ring alicyclic dienes, such as 1,3-cyclopentadiene; 1,4-cyclohexadiene; 1,5-cyclooctadiene and 1,5-cyclododecadiene, and multi-ring alicyclic fused and bridged ring dienes, such as tetrahydroindene, methyl tetrahydroindene, dicyclopentadiene, bicyclo-(2,2,1)-hepta-2, 5-diene; alkenyl, alkylidene, cycloalkenyl and cycloalkylidene norbornenes, such as 5-methylene-2-norbornene (MNB); 5-propenyl-2-norbornene, 5-isopropylidene-2-norbornene, 5-(4-cyclopentenyl)-2-norbornene, 5-cyclohexylidene-2-norbornene, 5-vinyl-2-norbornene, and norbornadiene. Of the dienes typically used to prepare EPDMs, the particularly preferred dienes are 1,4-hexadiene (HD), 5-ethylidene-2-norbornene (ENB), 5-vinylidene-2-norbornene (VNB), 5-methylene-2-norbornene (MNB), and dicyclopentadiene (DCPD). The especially preferred dienes are 5-ethylidene-2-norbornene (ENB) and 1,4-hexadiene (HD).

Catalyst Systems

According to the invention, the individual components of the catalyst system are added to the polymerization reactor and react together in situ to form the activated catalyst system within the reaction stream. Catalysts that can be employed in the present polymerization system include any olefin polymerization catalyst or catalyst system, including so-called homogeneous and heterogeneous catalysts and/or catalyst systems that meet the criteria described herein.

Catalytically effective amounts of the components of the catalyst system (e.g., metal coordination complex and cocatalyst) are fed into the reaction stream, that is, in amounts which, when combined together to form the activated catalyst system, combines with monomer in the reaction stream to successfully result in formation of polymer. Advantageously, in use of the system of the invention, less amount of the activated catalyst system is required to achieve a similar level of polymer output as in a conventional polymerization system in which the formed activated catalyst system is added to the reaction stream. Such amounts may be readily determined by routine experimentation by a skilled artisan.

Preferred amounts of the catalyst components are sufficient to provide an equivalent ratio of mass of addition polymerizable monomer : mass of transition metal catalyst component of from about 1×10¹⁰:1 to about 100:1, preferably from about 1×10⁸:1 to about 500:1, more preferably about 1×10⁷:1 to about 1000:1 wherein any of the upper and lower limits can be interchanged. In a constrained geometry catalyst system, the cocatalyst is generally utilized in an amount to provide an equivalent ratio of molar cocatalyst : molar transition metal catalyst component (i.e., metal coordination complex) from about 1000:1 to about 0.5:1, preferably from about 500:1 to about 0.5:1, most preferably from about 20:1 to about 0.5:1. In a Ziegler-Natta catalyst polymerization system, the cocatalyst or activator compound can be employed in a solution process in amounts that provide a molar ratio of atoms of Group ILIA metal per combined atoms of Ti and V of from about, 1000:1 to about 0.5:1, preferably from about 500:1 to about 0.5:1, more preferably from about 50:1 to about 0.5:1.

Homogeneous Catalysts

Homogeneous catalysts employed in the production of a homogeneous ethylene interpolymer are desirably metallocene species based on those monocyclopentadienyl transition metal complexes described in the art as constrained geometry metal complexes (CGC catalysts), including titanium complexes. These catalysts are highly efficient, meaning that they are efficient enough such that the catalyst residues left in the polymer do not influence the polymer quality.

Suitable metallocene species for use in some embosiments of the invention include constrained geometry metal complexes as disclosed in U.S. Pat. Nos. 5,703,187 (Timmers), 5,677,383 (Chum et al.), 5,844,045 and 5,869,575 (Kolthammer et al.), 5,272,236, 5,278,272, 5,665,800 and 5,783,638 (Lai et al.), all to The Dow Chemical Company, the teachings of all of which are incorporated herein by reference. Methods for the preparation of constrained geometry metal complexes and their use are also disclosed in U.S. Pat. Nos. 5,055,438, 5,057,475 and 5,096,867 (Canich, to Exxon), 5,064,802 and 5,132,380 (Stevens et al., to The Dow Chemical Company), 5,470,993, 5,486,632 and 6,118,013 (Devore et al., to The Dow Chemical Company), 5,321,106 and 5,721,185 (LaPointe, to The Dow Chemical Company), the teachings of all of which are incorporated herein by reference. The monocyclopentadienyl transition metal olefin polymerization catalysts taught in U.S. Pat. No. 5,026,798 (Canich, to Exxon), the teachings of which are incorporated herein by reference, are also suitable for use in preparing polymers using the present polymerization system.

The homogeneous activated catalysts comprise a “catalyst component” which is a metal coordination complex having constrained geometry that is employed in combination with a suitable “activating cocatalyst component” which is one or more activating agents or cocatalysts, or mixtures thereof. The catalyst components are sensitive to both moisture and oxygen and should be handled and transferred in an inert atmosphere such as nitrogen, argon or helium or under vacuum.

A preferred metal coordination complex (i.e., catalyst component) corresponds to the formula:

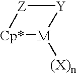

wherein:

M is a metal of group 4 of the Periodic Table of the Elements;

Cp* is a cyclopentadienyl or substituted cyclopentadienyl group bound in an η⁵ bonding mode to M;

Z is a moiety comprising boron, or a member of group 14 of the Periodic Table of the Elements, and optionally sulfur or oxygen, said moiety having up to 20 non-hydrogen atoms, and optionally Cp* and Z together form a fused ring system;

X independently each occurrence is an anionic or neutral ligand group having up to 30 non-hydrogen atoms;

n is 1 or 2; and

Y is an anionic or nonanionic ligand group bonded to Z and M comprising nitrogen, phosphorus, oxygen or sulfur and having up to 20 non-hydrogen atoms, optionally Y and Z together form a fused ring system.

More preferably still, the metal coordination complex corresponds to the formula:

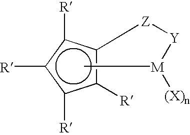

wherein:

R′ each occurrence is independently selected from the group consisting of hydrogen, alkyl, aryl, and silyl, and combinations thereof having up to 20 non-hydrogen atoms;

X each occurrence independently is selected from the group consisting of hydride, halo, alkyl, aryl, silyl, aryloxy, alkoxy, amide, siloxy and combinations thereof having up to 20 non-hydrogen atoms, 1-4-diphenyl-1,3-butadiene, 2,4-hexadiene, or 1,3-pentadiene;

Y is -O-, - S -, - NR*-, - PR*-, or a neutral two electron donor ligand selected from the group consisting of OR*, SR*, NR₂* or PR₂*;

M is a metal of group 4 of the Periodic Table of Elements; and

Z is SiR₂*, CR₂*, SiR₂*SiR₂*, CR₂* CR₂*=CR*, CR₂*SiR₂*, BR*;

wherein R* each occurrence is independently selected from the group consisting of hydrogen, alkyl, aryl, silyl groups having up to 20 non-hydrogen atoms, and mixtures thereof, or two or more R* groups from Y, Z, or both Y and Z form a fused ring system; and

n is 1 or2.

Most highly preferred metal coordination complex compounds are amidosilane- or amidoalkanediyl- compounds corresponding to the formula:

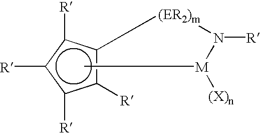

wherein:

M is titanium, zirconium or hafnium, bound in an η⁵ bonding mode to the cyclopentadienyl group;

R′ each occurrence is independently selected from the group consisting of hydrogen, alkyl and aryl and combinations thereof having up to 7 carbon atoms, or silyl;

E is silicon or carbon;

X independently each occurrence is hydride, halo, alkyl, aryl, aryloxy or alkoxy of up to 10 carbons, silyl. 1,3-pentadiene or 1,4-diphenyl-1,3-butadiene;

m is 1 or 2; and

n is 1 or2.

Examples of the above most highly preferred metal coordination compounds include compounds wherein the R′ on the amido group is methyl, ethyl, propyl, butyl, pentyl, hexyl, (including isomers), norbomyl, benzyl, phenyl, etc.; the cyclopentadienyl group is cyclopentadienyl, indenyl, tetrahydroindenyl, fluorenyl, octahydrofluorenyl, etc.; R′ on the foregoing cyclopentadienyl groups each occurrence is hydrogen, methyl, ethyl, propyl, butyl, pentyl, hexyl, (including isomers), norbomyl, benzyl, phenyl, etc.; and X is chloro, bromo, iodo, methyl, ethyl, propyl, butyl, pentyl, hexyl, (including isomers), norbomyl, benzyl, phenyl, etc. Specific compounds include: (tert-butylamido) (tetramethyl-η⁵-cyclopentadienyl)- 1,2-ethanediylzirconium dichloride, (tert-butylamido) (tetramethyl-η⁵-cyclopentadienyl)- 1,2-ethanediyltitanium dichloride, (methylamido) (tetramethyl-η⁵-cyclopentadienyl)-1,2-ethanediylzirconium dichloride, (methylamido) (tetramethyl-η⁵- cyclopentadienyl)-1,2-ethanediyltitanium dichloride, (ethylamido) (tetramethyl-η⁵-cyclopentadienyl)methylenetitanium dichloride, (tertbutylamido)dibenzyl(tetramethyl-η⁵-cyclopentadienyl) silanezirconium dibenzyl, (benzylamido)dimethyl- (tetramethyl-η⁵-cyclopentadienyl)silanetitanium dichloride, (phenylphosphido)dimethyl(tetramethyl-η⁵-cyclopentadienyl)silanezirconium dibenzyl, (tertbutylamido)dimethyl(tetramethyl-η⁵-cyclopentadienyl)silanetitanium dimethyl, and the like.

The metal coordination complexes can be prepared as described, for example, in U.S. Pat. No. 5,703,187 (Timmers et al.), the disclosure of which is incorporated by reference herein. The complexes can be prepared by contacting the metal reactant and a group I metal derivative or Grignard derivative of the cyclopentadienyl compound in a solvent and separating the salt by product. Suitable solvents for use in preparing the metal complexes are aliphatic or aromatic liquids such as cyclcohexane, methylcyclohexane, pentane, hexane, heptane, tetrahydrofuran, diethyl ether, benzene, toluene, xylene, ethylbenzene, etc., or mixtures thereof.

Ionic Metallocene Active Catalysts

Ionic metallocene active catalyst species that can be used to polymerize the polymers described herein correspond to the formula:

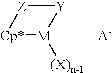

wherein:

M is a metal of group 4 of the Periodic Table of the Elements;

Cp* is a cyclopentadienyl or substituted cyclopentadienyl group bound in an η⁵ bonding mode to M;

Z is a moiety comprising boron, or a member of group 14 of the Periodic Table of the Elements, and optionally sulfur or oxygen, said moiety having up to 20 non-hydrogen atoms, and optionally Cp* and Z together form a fused ring system;

X independently each occurrence is an anionic ligand group having up to 30 non-hydrogen atoms;

n is 1 or2; and

A- is a noncoordinating, compatible anion.

One method of making the ionic metallocene catalyst species which can be utilized to make the polymers of the present invention involve combining:

a) at least one first catalyst component that is a mono(cyclopentadienyl) derivative of a metal of group 4 of the Periodic Table of the Elements (metallocene) containing at least one substituent or ligand that will combine with the cation of a second component (described hereinafter) which first component is capable of forming a cation formally having a coordination number that is one less than its valence, and

b) at least one second catalyst component (“activator” component) that is a salt of a Bronsted acid comprising a cation that will irreversibly react with at least one ligand contained in the group 4 metal compound (first component) and a noncoordinating, compatible anion (i.e., an anion that either does not coordinate to the group 4 metal cation or only weakly coordinates to the cation). The second component reacts with the metallocene (first catalyst component) to activate it to a catalytically active complex.

Illustrative, but not limiting examples of monocyclopentadienyl metal components (first catalyst component) which may be used in the preparation of cationic complexes are the previously disclosed monocyclopentadienyl metal coordinator complexes.

Compounds useful as a second catalyst component in the preparation of the ionic catalysts useful in this invention can comprise a cation, which is a Bronsted acid capable of donating a proton and a compatible noncoordinating anion.

Preferred ionic metallocene catalysts are those having a limiting charge separated structure corresponding to the formula:

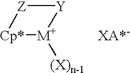

wherein:

M is a metal of group 4 of the Periodic Table of the Elements;

Cp* is a cyclopentadienyl or substituted cyclopentadienyl group bound in an η⁵ bonding mode to M;

Z is a moiety comprising boron, or a member of group 14 of the Periodic Table of the Elements, and optionally sulfur or oxygen, said moiety having up to 20 non-hydrogen atoms, and optionally Cp* and Z together form a fused ring system;

X independently each occurrence is an anionic ligand group having up to 30 non-hydrogen atoms;

n is 1 or 2; and

XA*- is -X(B(C₆F₅)₃).

This class of cationic complexes can also be conveniently prepared by contacting a metal compound corresponding to the formula:

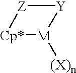

wherein:

Cp*, M, and n are as previously defined, with tris(pentafluorophenyl)borane cocatalyst under conditions to cause abstraction of X and formation of the anion -X(B(C₆F₅)₃).

Preferably X in the foregoing ionic catalyst is C₁-C₁₀ hydrocarbyl, most preferably methyl or benzyl.

The preceding formula is referred to as the limiting, charge separated structure. However, it is to be understood that, particularly in solid form, the catalyst may not be fully charge separated. That is, the X group may retain a partial covalent bond to the metal atom, M. Thus, the catalysts may be alternately depicted as possessing the formula:

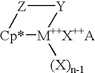

The catalysts are preferably prepared by contacting the derivative of a group 4 metal with the tris(pentafluorophenyl)borane in an inert diluent such as an organic liquid. Tris(pentafluorophenyl)borane is a commonly available Lewis acid that may be readily prepared according to known techniques. The compound is disclosed in Marks, et al., J. Am. Chem. Soc. 1991, 113, 3623-3625 for use in alkyl abstraction of zirconocenes.

The cationic complexes used as homogeneous catalysts may be further activated by the use of an additional activator or cocatalyst such as alkyl aluminoxane. Preferred co-activators or cocatalysts include methylaluminoxane, propylaluminoxane, isbutylaluminoxane, and the like, and combinations thereof, and MMAO.

The Heterogeneous Catalysts

Heterogeneous catalysts that can be employed in the polymerization system of the invention are typical Ziegler-type catalysts that are particularly useful at relatively high polymerization temperatures. The heterogeneous catalysts comprise a supported transition metal compound (e.g., a titanium compound or a combination of a titanium compound and a vanadium compound) and a cocatalyst/activator. Examples of such catalysts are described in U.S. Pat Nos. 4,314,912 (Lowery, Jr. et al.), 4,547,475 (Glass et al.), and 4,612,300 (Coleman, III), 4,076,698 (Anderson et al.) and 5,231,151 (Spencer et al.), all to The Dow Chemical Company, the disclosures of which are incorporated herein by reference.

Preparation of Transition Metal Catalyst Component

The transition metal catalyst component can be prepared as a slurry of a porous inorganic oxide support material mixed with an organomagnesium alkoxide or magnesium dialkoxide, and reacted with a titanium compound or a combination of a titanium compound and a vanadium compound, and a Group IIIA metal alkyl halide, as described in U.S. Pat. No. 5,231,151 (Spencer, et al., to The Dow Chemical Company), the disclosure of which is herein incorporated by reference.

Briefly, a porous inorganic oxide support material is slurried in an inert organic diluent. To this slurry is then added a hydrocarbon-soluble organomagnesium alkoxide or hydrocarbon-soluble magnesium dialkoxide for a time sufficient to react the magnesium compound with surface of the solid support. After the addition of the magnesium compound, a titanium compound or a combination of a titanium compound and a vanadium compound is added for a time sufficient to completely react the titanium compound and the vanadium compound with the reactive silica and magnesium functionalities. The titanium and vanadium compounds can be premixed prior to their addition or they can be added separately in any order to the product resulting from blending the magnesium compound with the slurry of the inorganic oxide support material. Following the addition and mixing of the titanium and/or vanadium compounds, a Group IIIA metal alkyl halide is added and the mixture is stirred for a time sufficient to reduce the titanium compound, and vanadium compound if present, to their final oxidation states. Upon completion of the addition and mixing of the Group IIIA metal alkyl halide, the thus formed transition metal catalyst component can be employed in the polymerization of a-olefins as is without isolation of the solid components from the liquid components. The transition metal catalyst component can be employed immediately upon its preparation or the component can be stored under inert conditions for some length of time, usually for periods of time as long as 90 days.

The components are mixed under conditions which exclude oxygen (air) and moisture at a temperature of from about −20° C. to about 120° C., preferably from about 0° C. to about 100° C., more preferably from about 20° C. to 70° C. Oxygen (air) and moisture can be excluded during catalyst preparation by conducting the preparation in an inert atmosphere such as, for example, nitrogen, argon, xenon, methane and the like.

Components of Transition Metal Catalyst

Porous Support Material. Suitable porous silica or alumina support materials which can be employed herein include those containing not greater than about 5, preferably not greater than about 4, more preferably not greater than about 3 millimoles of hydroxyl groups (OH) per gram of support material. These hydroxyl (OH) groups are isolated silanol groups on the silica surface.

The inorganic oxide support used in the preparation of the catalyst can be any particulate oxide or mixed oxide that has been thermally or chemically dehydrated such that it is substantially free of adsorbed moisture.

The specific particle size, surface area, pore volume and number of surface hydroxyl groups characteristic of the inorganic oxide are not critical, but such characteristics determine the amount of inorganic oxide to be employed in preparing the catalyst and are taken into consideration in choosing an inorganic oxide. In general, optimum results are usually obtained by the use of inorganic oxides having an average particle size of about 1 to about 100 microns, preferably about 2 to about 20 microns; a surface area of about 50 to about 1,000 square meters per gram, preferably about 100 to about 400 square meters per gram; and a pore volume of about 0.5 to about ⅗cm³ per gram, preferably about 0.5 to 2 Cm³ per gram.

In order to further improve catalyst performance, surface modification of the support material may be desired. Surface modification can be accomplished by specifically treating the support material such as silica, alumina or silica-alumina with an organometallic compound having hydrolytic characteristics. More particularly, the surface modifying agents for the support materials comprise the organometallic compounds of the metals of Group IIA and IIIA of the Periodic Table. Most preferably, the organometallic compounds are selected from magnesium and aluminum organometallics and especially from magnesium and aluminum alkyls or mixtures thereof represented by the formulas and R¹MgR² and R¹R²AIR³ wherein each of R¹, R² and R³ which may be the same or different are alkyl groups, aryl groups, cycloalkyl groups, aralkyl groups, alkoxide groups, alkadienyl groups or alkenyl groups. The hydrocarbon groups R¹, R² and R³ can contain between 1 and 20 carbon atoms and preferably from 1 to about 10 carbon atoms. The surface modifying action can be effected by adding the organometallic compound in a suitable solvent to a slurry of the support material.

Inert Liquid Diluent

Suitable inert liquid diluents that can be employed to slurry the inorganic oxide support material include, for example, aliphatic hydrocarbons, aromatic hydrocarbons, naphthinic hydrocarbons, or any combination thereof and the like. Particularly suitable solvents include, for example, pentane, isopentane, hexane, heptane, octane, isooctane, nonane, isononane, decane, cyclohexane, methylcyclohexane, toluene, and the like, and any combination of any two or more of such diluents.

Magnesium Compound

Suitable magnesium compounds that can be employed in the preparation of the transition metal catalyst component include, for example, those hydrocarbon soluble organomagnesium compounds represented by the formula RₓMg(OR)_{y}; wherein each R is independently a hydrocarbyl group having from 1 to about 20, preferably from about 1 to about 10, more preferably from about 2 to about 8, carbon atoms; x+y=2; and 0.5<y<2. Preferably, x has a value of zero or 1 and y has a value of 1 or 2, and most preferably, x has a value of 1 and y has a value of 1.

Particularly suitable magnesium compounds include, for example, n-butylmagnesium butoxide, ethylmagnesium butoxide, butylmagnesium ethoxide, octylmagnesium ethoxide, butylmagensium i-propoxide, ethylmagnesium i-propoxide, butylmagnesium n-propoxide, ethylmagnesium n-propoxide, s-butylmagnesium butoxide, butylmagnesium 2,4-dimethylpent-3-oxide, n-butylmagnesium octoxide, s-butylmagnesium octoxide, and the like, or any combination thereof.

Also suitable are the hydrocarbon soluble reaction product (dialkoxide) of a magnesium dihydrocarbyl (MgR₂) compound and an oxygen-containing compound (ROH) such as, for example, an aliphatic or cycloaliphatic or acyclic C₅-C₁₈ beta or gamma alkyl-substituted secondary or tertiary monohydric alcohol, as disclosed by Kamienski in U.S. Pat. No. 4,748,283, which is incorporated by reference. Particularly suitable oxygen containing compounds include, for example, 2,4-dimethyl-3-pentanol, 2,3-dimethyl-2-butanol, 2,4-dimethyl-3-hexanol, 2,6-dimethyl-4-heptanol, 2,6-dimethyl-cyclohexanol, or any combination thereof and the like. Particularly suitable magnesium dialkyl compounds include, for example, butylethylmagnesium, dibutylmagnesium, dihexylmagnesium, butyloctylmagnesium, and the like, and any combination thereof.

Titanium Compound

Suitable titanium compounds which can be employed in the preparation of the transition metal catalyst component include, for example, those represented by the formula TiX₄₋ₐ (OR′)ₐ; wherein each R′ is independently an alkyl group having from 1 to about 20, preferably from about 1 to about 10, more preferably from about 2 to about 8, carbon atoms; X is a halogen atom, preferably chlorine; and a has a value from zero to 4. Particularly suitable titanium compounds include, for example, titanium tetrachloride (TiCl₄), titanium tetraisopropoxide (Ti(O-i-C₃ H7)₄), titanium tetraethoxide (Ti(OC₂H₅)₄), titanium tetrabutoxide (Ti(OC₄H₉)₄), titanium triisopropoxidechloride (Ti(O-i-C₃H₇)₃C₁), and the like, or any combination thereof.

Vanadium Compound

In a solution process when it is desirable to produce α-olefin polymers that have a high molecular weight and a relatively narrower molecular weight distribution than that produced with the catalyst containing only titanium as the transition metal, a vanadium compound can be added as a portion of the transition metal component during preparation of the catalyst. A narrowing of the molecular weight distribution is indicated by a lowering of the I₁₀/I₂ value of the polymer. By the term “relatively narrow molecular weight distribution,” it is meant that the resulting polymer produced in the presence of a catalyst containing both titanium and vanadium has a narrower molecular weight distribution than the polymer produced under similar conditions with a similar catalyst prepared without the vanadium component.

In a slurry process when it is desirable to produce α-olefin polymers that have a high molecular weight and a relatively broad molecular weight distribution than that produced with the catalyst containing only titanium as the transition metal, a vanadium compound can be added as a portion of the transition metal component during preparation of the catalyst. A broadening of the molecular weight distribution is indicated by an increase of the I₁₀/I₂, high load melt flow ratio (HLMFR), value of the polymer. By the term “relatively broad molecular weight distribution,” it is meant that the resulting polymer produced in the presence of a catalyst containing both titanium and vanadium has a broader molecular weight distribution than the polymer produced under similar conditions with a similar catalyst prepared without the vanadium component.

Suitable vanadium compounds that can be employed in the preparation of the transition metal catalyst include, for example, those represented by the formulas VX₄ and V(O)X₃; wherein each X is independently or a halogen atom, preferably chlorine; each R is independently an alkyl group having from 1 to about 20, preferably from about 2 to about 8, more preferably from about 2 to about 4, carbon atoms. Particularly suitable vanadium compounds include, for example, vanadium tetrachloride (VCl₄), vanadium trichloride oxide (VOCl₃), vanadium triisopropoxide oxide (V(O)(O-i-C₃H₇)₃), vanadium triethoxide oxide (VO(OC₂H₅)₃), and the like, and any combination thereof.

Organo Halide Compounds of a Group IIIA Metal

Suitable organo halide compounds of a group IIIA Metal which can be employed in the preparation of the transition metal catalyst include, for example, those represented by the formula R′_{y}MX_{z}; wherein M is a metal from Group IIIA of the Periodic Table of the Elements, preferably aluminum or boron; each R′ is independently an alkyl group having from 1 to about 20, preferably from about 1 to about 10, more preferably from about 2 to about 8, carbon atoms; X is a halogen atom, preferably chlorine; y and z each independently have a value from 1 to a value equal to the valence of M minus 1 and y+z has a value equal to the valence of M. Particularly suitable such organo halide compounds include, for example, ethylaluminum dichloride, ethylaluminum sesquichloride, diethylaluminum chloride, isobutylaluminum dichloride, diisobutylaluminum chloride, octylaluminum dichloride, and the like, any combination thereof.

Cocatalyst or Activator

The transition metal catalyst component described above requires a cocatalyst or activator in order to efficiently polymerize a-olefin monomer(s). Suitable cocatalysts or activator compounds include, for example, Group IIIA metal alkyl, metal alkoxide or metal alkyl halide compounds, particularly C₁-C₁₀ alkyl compounds of aluminum. Particularly suitable compounds include, for example, triethylaluminum, trimethylaluminum, triisobutylaluminum, trihexylaluminum, trioctylaluminum, diethylaluminum chloride, dietbylaluminum ethoxide, and the like, and any combination of any two or more of such compounds.

Also suitable are the aluminoxanes such as those represented by the formula (Al(O)R)ₓ; wherein R is an alkyl group having from 1 to about 8 carbon atoms and x has a value greater than about 4. Particularly suitable aluminoxanes include, for example, methylaluminoxane, hexaisobutyltetraluminoxane, and the like, and any combination of any two or more of such compounds. Also, mixtures of these aluminoxanes with alkyl aluminum compounds such as triethylaluminum or tributylaluminum, can be employed.

Additional Catalysts

As mentioned above, any catalyst which is capable of polymerizing one or more olefin monomers to make an interpolymer or homopolymer may be used in embodiments of the invention. Suitable catalysts include, but are not limited to, single-site catalysts (both metallocene catalysts and constrained geometry catalysts), multi-site catalysts (Ziegler-Natta catalysts), and variations therefrom. They include any known and presently unknown catalysts for olefin polymerization. It should be understood that the term “catalyst” as used herein refers to a metal-containing compound which is used, along with an activating cocatalyst, to form a catalyst system. The catalyst, as used herein, is usually catalytically inactive in the absence of a cocatalyst or other activating technique. However, not all suitable catalyst are catalytically inactive without a cocatalyst and thus requires activation.

One suitable class of catalysts is the constrained geometry catalysts disclosed in U.S. Pat. No. 5,064,802, No. 5,132,380, No. 5,703,187, No. 6,034,021, EP 0 468 651, EP 0 514 828, WO 93/19104, and WO 95/00526, all of which are incorporated by references herein in their entirety. Another suitable class of catalysts is the metallocene catalysts disclosed in U.S. Pat. No. 5,044,438; No. 5,057,475; No. 5,096,867; and No. 5,324,800, all of which are incorporated by reference herein in their entirety. It is noted that constrained geometry catalysts may be considered as metallocene catalysts, and both are sometimes referred to in the art as single-site catalysts. Other single site catalysts, such as those reported by Dupont, that are not based on metallocenes are also suitable.

Another suitable class of catalysts is substituted indenyl containing metal complexes as disclosed in U.S. Pat. No. 5,965,756 and No. 6,015,868 which are incorporated by reference herein in their entirety. Other catalysts are disclosed in copending applications: U.S. application Ser. No. 09/230,185; and No. 09/715,380, and U.S. Provisional Application Serial No. 60/215,456; No. 60/170,175, and No. 60/393,862. The disclosures of all of the preceding patent applications are incorporated by reference herein in their entirety.

One class of the above catalysts is the indenyl containing metal wherein:

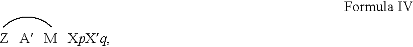

M is titanium, zirconium or hafnium in the +2,+3 or +4 formal oxidation state;

A′ is a substituted indenyl group substituted in at least the 2 or 3 position with a group selected from hydrocarbyl, fluoro-substituted hydrocarbyl, hydrocarbyloxy-substituted hydrocarbyl, dialkylamino- substituted hydrocarbyl, silyl, germyl and mixtures thereof, the group containing up to 40 non-hydrogen atoms, and the A′ further being covalently bonded to M by means of a divalent Z group; Z is a divalent moiety bound to both A′ and M via σ-bonds, the Z comprising boron, or a member of Group 14 of the Periodic Table of the Elements, and also comprising nitrogen, phosphorus, sulfur or oxygen; X is an anionic or dianionic ligand group having up to 60 atoms exclusive of the class of ligands that are cyclic, delocalized, n-bound ligand groups; X′ independently each occurrence is a neutral Lewis base , having up to 20 atoms; p is 0, 1 or 2, and is two less than the formal oxidation state of M, with the proviso that when X is a dianionic ligand group, p is 1; and q is 0, 1 or 2.

The above complexes may exist as isolated crystals optionally in pure form or as a mixture with other complexes, in the form of a solvated adduct, optionally in a solvent, especially an organic liquid, as well as in the form of a dimer or chelated derivative thereof, wherein the chelating agent is an organic material, preferably a neutral Lewis base, especially a trihydrocarbylamine, trihydrocarbylphosphine, or halogenated derivative thereof.

Preferred catalysts are complexes corresponding to the formula:

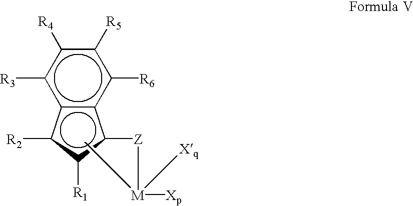

wherein R₁ and R₂ independently are groups selected from hydrogen, hydrocarbyl, perfluoro substituted hydrocarbyl, silyl, germyl and mixtures thereof, the group containing up to 20 non-hydrogen atoms, with the proviso that at least one of R₁ or R₂ is not hydrogen; R₃, R4, R₅, and R₆ independently are groups selected from hydrogen, hydrocarbyl, perfluoro substituted hydrocarbyl, silyl, germyl and mixtures thereof, the group containing up to 20 non-hydrogen atoms; M is titanium, zirconium or hafnium; Z is a divalent moiety comprising boron, or a member of Group 14 of the Periodic Table of the Elements, and also comprising nitrogen, phosphorus, sulfur or oxygen, the moiety having up to 60 non-hydrogen atoms; p is 0, 1 or 2; q is zero or one; with the proviso that: when p is 2, q is zero, M is in the +4 formal oxidation state, and X is an anionic ligand selected from the group consisting of halide, hydrocarbyl, hydrocarbyloxy, di(hydrocarbyl)amido, di(hydrocarbyl)phosphido, hydrocarbyl sulfido, and silyl groups, as well as halo-, di(hydrocarbyl)amino-, hydrocarbyloxy- and di(hydrocarbyl)phosphino-substituted derivatives thereof, the X group having up to 20 non-hydrogen atoms, when p is 1, q is zero, M is in the +3 formal oxidation state, and X is a stabilizing anionic ligand group selected from the group consisting of allyl, 2-(N,N-dimethylaminomethyl)phenyl, and 2-(N,N-dimethyl)-aminobenzyl, or M is in the +4 formal oxidation state, and X is a divalent derivative of a conjugated diene, M and X together forming a metallocyclopentene group, and when p is 0, q is 1, M is in the +2 formal oxidation state, and X′ is a neutral, conjugated or non-conjugated diene, optionally substituted with one or more hydrocarbyl groups, the X′ having up to 40 carbon atoms and forming a π-complex with M.

More preferred catalysts are complexes corresponding to the formula:

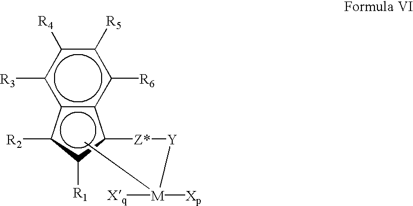

wherein: R₁ and R₂ are hydrogen or C₁₋₆ alkyl, with the proviso that at least one of R₁ or R₂ is not hydrogen; R₃, R₄, R₅, and R₆ independently are hydrogen or C₁₋₆ alkyl; M is titanium; Y is -O-S-, -NR*-, -PR*-; Z* is SiR*₂, CR*₂, SiR*₂SiR*₂, CR*₂CR*₂, CR*=CR*, CR*₂SiR*₂, or GeR*₂; R* each occurrence is independently hydrogen, or a member selected from hydrocarbyl, hydrocarbyloxy, silyl, halogenated alkyl, halogenated aryl, and combinations thereof, the R* having up to 20 non-hydrogen atoms, and optionally, two R* groups from Z (when R* is not hydrogen), or an R* group from Z and an R* group from Y form a ring system; p is 0, 1 or 2; q is zero or one; with the proviso that: when p is 2, q is zero, M is in the +4 formal oxidation state, and X is independently each occurrence methyl or benzyl, when p is 1, q is zero, M is in the +3 formal oxidation state, and X is 2-(N,N-dimethyl)aminobenzyl; or M is in the +4 formal oxidation state and X is 1,4-butadienyl, and when p is 0, q is 1, M is in the +2 formal oxidation state, and X′ is 1,4-diphenyl-1,3-butadiene or 1,3-pentadiene. The latter diene is illustrative of unsymmetrical diene groups that result in production of metal complexes that are actually mixtures of the respective geometrical isomers.

Examples of specific catalysts that may be used in embodiments of the invention include, but are not limited, the following metal complexes:

2-methylindenyl complexes: (t-butylamido)dimethyl(η⁵-2-methylindenyl)silanetitanium (II) 1,4-diphenyl-1,3-butadiene; (t-butylamido) dimethyl(η⁵-2-methylindenyl)silanetitanium (II) 1,3-pentadiene; (t-butylamido) dimethyl(η⁵-2-methylindenyl)silanetitanium (III) 2-(N,N-dimethylamino)benzyl; (t-butylamido) dimethyl (η⁵-2-methylindenyl)silanetitanium (IV) dimethyl; (t-butylamido)dimethyl(η⁵-2-methylindenyl)silanetitanium (IV) dibenzyl; (n-butylamido)dimethyl(η⁵-2-methylindenyl) silanetitanium (II) 1,4-diphenyl-1,3-butadiene; (n-butylamido)dimethyl(η⁵-2-methylindenyl) silanetitanium (II) 1,3-pentadiene; (n-butylamido)dimethyl(η⁵-2-methylindenyl)silanetitanium (III) 2-(N,N-dimethylamino)benzyl; (n-butylamido)dimethyl(η⁵-2-methylindenyl)silanetitanium (IV) dimethyl; (n-butylamido)dimethyl(η⁵-2-methylindenyl)silanetitanium (IV) dibenzyl; (cyclododecylamido) dimethyl(η⁵-2-methylindenyl)silanetitanium (II) 1,4-diphenyl-1,3-butadiene; (cyclododecylamido) dimethyl(η⁵-2-methylindenyl)silanetitanium (II) 1,3-pentadiene, (cyclododecylamido)dimethyl(η⁵-2-methylindenyl)silanetitanium (III) 2-(N,N-dimethylamino)benzyl; (cyclododecylamido) dimethyl(η⁵-2-methylindenyl)silanetitanium (IV) dimethyl; (cyclododecylamido)dimethyl(η⁵-2-methylindenyl)silanetitanium (IV) dibenzyl; (2,4,6-trimethylanilido)dimethyl(η⁵-2-methyl indenyl)silanetitanium (II) 1,4-diphenyl-1,3-butadiene; (2,4,6-trimethylanilido)dimethyl(η⁵-2-methylindenyl)silanetitanium (II) 1,3-pentadiene; (2,4,6-trimethylanilido)dimethyl(η⁵-2-methyl indenyl) sianetitanium (III) 2-(N,N-dimethylamino)benzyl; (2,4,6-trimethylanilido)dimethyl(η⁵-methylindenyl )silanetitaniuum (IV) dimethyl; (2,4,6-trimethylanilido)dimethyl(η⁵-2-methyl indenyl)silanetitanium (IV) dibenzyl; (1-adamantylamido)dimethyl(η⁵-2-methylindenyl) silanetitanium (II) 1,4-diphenyl-1,3-butadiene; (1-adamantylamido)dimethyl(η⁵-2-methylindenyl) silanetitanium (II) 1,3-pentadiene; (1-adamantylamido)dimethyl(η⁵-2-methylindenyl)silanetitanium (III) 2-(N,N-dimethylamino)benzyl; (1-adamantylamido)dimethyl(η⁵-2-methylindenyl)silane titanium (IV) dimethyl; (1-adamantylamido)dimethyl(η⁵-2-methylindenyl)silanetitanium (IV) dibenzyl; (t-butylamido)ditnethyl(η⁵-2-methylindenyl)silanetitanium (II) 1,4-diphenyl-1,3-butadiene; (t-butylamido)dimethyl(η⁵-2-methylindenyl)silanetitanium (II) 1,3-pentadiene; (t-butylamido) dimethyl(η⁵-2-methylindenyl)silanetitanium (III) 2-(N,N-dimethylamino)benzyl; (t-butylamido) dimethyl(η⁵-2-methylindenyl)silanetitanium (IV) dimethyl; (t-butylamido)dimethyl(η⁵-2-methyl indenyl)silanetitanium (IV) dibenzyl; (n-butylamido)diisopropoxy(η⁵-2-methylindenyl) silane titanium (II) 1,4-diphenyl-1,3-butadiene; (n-butylamido)diisopropoxy(η⁵-2-methylindenyl) silanetitanium (II) 1,3-pentadiene; (n-butylamido)diisopropoxy(η⁵-2-methylindenyl) silanetitanium (III) 2-(N,N-dimethylamino)benzyl; (n-butylamido)diisopropoxy(η⁵-2-methylindenyl) silanetitanium (IV) dimethyl; (n-butylamido)diisopropoxy(η⁵-2-methylindenyl) silanetitanium (IV) dibenzyl; (cyclododecylamido)diisopropoxy(η⁵-2-methylindenyl)-silanetitanium (II) 1,4-diphenyl-1,3-butadiene; (cyclododecylamido)diisopropoxy(η⁵-2-methyl indenyl)-silanetitanium (II) 1,3-pentadiene; (cyclododecylamido)diisopropoxy(η⁵-2-methyl indenyl)-silanetitanium (III) 2-(N,N-dimethylamino)benzyl; (cyclododecylamido)diisopropoxy (η⁵-2-methylindenyl)-silanetitanium (IV) dimethyl; (cyclododecylamido)diisopropoxy(η⁵-2-methylindenyl)-silanetitanium (IV) dibenzyl; (2,4,6-trimethylanilido)diisopropoxy(η⁵-2-methyl-indenyl)silanetitanium (II)1,4-diphenyl-1,3-butadiene; (2,4,6-trimethylanilido)diisopropoxy(η⁵-2-methylindenyl)silanetitanium (II) 1,3-pentadiene; (2,4,6-trimethylanilido)diisopropoxy(η⁵-2-methylin-denyl)silanetitanium (III) 2-(N,N-dimethylamino)benzyl; (2,4,6-trimethylanilido) diisopropoxy(η⁵-2-methylindenyl)silanetitanium (IV) dimethyl; (2,4,6-trimethylanilido) diisopropoxy(η⁵-2-methylindenyl)silanetitanium (IV) dibenzyl; (1-adamantylamido) diisopropoxy(η⁵-2-methylindenyl)silanetitanium (II) 1,4-diphenyl-1,3-butadiene; (1-adamantylamido)diisopropoxy(η⁵-2-methylindenyl)silanetitanium (II) 1,3-pentadiene; (1-adamantylamido)diisopropoxy(η⁵-2-methylindenyl)silanetitanium (III) 2-(N,N-dimethylamino) benzyl; (1-adamantylamido)diisopropoxy(η⁵-2-methylindenyl)silanetitaum (IV) dimethyl; (1-adamantylamido)diisopropoxy(η⁵-2-methylindenyl)silanetitanium (IV) dibenzyl; (n-butylamido) dimethoxy((η⁵-2-methylindenyl)silanetitanium (II) 1,4-diphenyl-1,3-butadiene; (n-butylamido) dimethoxy(η⁵-2-methylindenyl)silanetitanium (II) 1,3-pentadiene; (n-butylamido) dimethoxy (η⁵-2-methylindenyl)silanetitanium (III) 2-(N,N-dimethylamino)benzyl; (n-butylamido) dimethoxy(η⁵-2-methylindenyl)silanetitanium (IV) dimethyl; (n-butylamido)dimethoxy(η⁵-2-methylindenyl)silanetitanium (IV) dibenzyl; (cyclododecylamido)dimethoxy(η⁵-2-methyl indenyl) silanetitanium (II) 1,4-diphenyl-1,3-butadiene; (cyclododecylamido)dimethoxy (η⁵-2-methyl indenyl)silanetitanium (II) 1,3-pentadiene; (cyclododecylamido)dimethoxy(η⁵-2-methylindenyl) silanetitanium (III) 2-(N,N-dimethylamino)benzyl; (cyclododecylamido) dimethoxy(η⁵-2-methyl indenyl)silanetitanium (IV) dimethyl; (cyclododecylamido) dimethoxy(η⁵-2-methylindenyl) silanetitanium (IV) dibenzyl; (2,4,6-trimethylanilido)dimethoxy (η⁵-2-methylindenyl)silanetitanium (II) 1,4-diphenyl-1,3-butadiene; (2,4,6-trimethylanilido) dimethoxy(η⁵-2-methylindenyl) silanetitanium (II) 1,3-pentadiene; (2,4,6-trimethylanilido) dimethoxy(η⁵-2-methylindenyl) silanetitanium (III) 2-(N,N-dimethylamino)benzyl; (2,4,6-trimethylanilido)dimethoxy(η⁵-2-methyl indenyl)silanetitanium (IV) dimethyl; (2,4,6-trimethylanilido)dimethoxy(η⁵-2-methylindenyl) silanetitanium (IV) dibenzyl; (1-adamantylamido)dimethoxy(η⁵-2-methylindenyl)silanetitanium (II) 1,4-diphenyl-1,3-butadiene; (1-adamantylamido)dimethoxy(η⁵-2-methylindenyl)silanetitanium (II) 1,3-pentadiene; (1-adamantylamido)dimethoxy(η⁵-2-methylindenyl)silanetitanium (III) 2-(N,N-dimethylamino)benzyl; (1-adamantylamido)dimethoxy(η⁵-2-methylindenyl)silanetitanium (IV) dimethyl; (1-adamantylamido)dimethoxy(η⁵-2-methylindenyl)silanetitanium (IV) dibenzyl; (n-butylamido)ethoxymethyl(η⁵-2-methylindenyl)silanetitanium (II) 1,4-diphenyl-1,3-butadiene; (n-butylamido)ethoxymethyl(η⁵-2-methylindenyl)silanetitanium (II) 1,3-pentadiene; (n-butylamido) ethoxymethyl(η⁵-2-methylindenyl)silanetitanium (III) 2-(N,N-dimethylamino) benzyl; (n-butyl amido)ethoxymethyl(η⁵-2-methylindenyl)silanetitanium (IV) dimethyl; (n-butylamido) ethoxymethyl(η⁵-2-methylindenyl)silanetitanium (IV) dibenzyl; (cyclododecyl amido) ethoxymethyl (η⁵-2-methylindenyl)silanetitanium (II) 1,4-diphenyl-1,3-butadiene; (cyclododecyl amido)ethoxymethyl(η⁵-2-methylindenyl)silanetitanium (II) 1,3-pentadiene; (cyclododecylamido) ethoxymethyl(η⁵-2-methylindenyl)silanetitanium (III) 2-(N,N-dimethyl amino)benzyl; (cyclododecylamido)ethoxymethyl(η⁵-2-methylindenyl)silanetitanium (IV) dimethyl; (cyclododecylamido) ethoxymethyl(η⁵ -2-methylindenyl)silanetitanium (IV) dibenzyl; (2,4,6-trimethylanilido) ethoxymethyl(η⁵-2-methylindenyl)silanetitanium (II) 1,4-diphenyl- 1,3-butadiene; (2,4,6-trim ethylanilido)ethoxymethyl(η⁵-2-methylindenyl)silanetitanium (II) 1,3-pentadiene; (2,4,6-trimethylanilido)ethoxymethyl(η⁵-2-methylindenyl)silanetitanium (III) 2-(NN-dimethylamino) benzyl; (2,4,6-trimethylanilido)ethoxymethyl(η⁵-2-methylindenyl) silanetitanium (IV) dimethyl; (2,4,6-trimethylanilido)ethoxymethyl(η⁵-2-methylindenyl) silanetitanium (IV) dibenzyl; (1 -adamantylamido)ethoxymethyl(η⁵-2-methylindenyl) silanetitanium (II) 1,4-diphenyl-1,3-butadiene; (1-adamantylamido)ethoxymethyl(η⁵-2-methyl indenyl)silanetitanium (II) 1,3-pentadiene; (1 -adamantylamido)ethoxymethyl(η⁵-2-methyl indenyl)silanetitanium (III) 2-(N,N-dimethylamino) benzyl; (1-adamantylamido)ethoxymethyl (η⁵-2-methylindenyl)silanetitanium (IV) dimethyl; (1-adamantylamido)ethoxymethyl(η⁵-²-methylindenyl)silanetitanium (IV) dibenzyl;

2,3-dimethylindenyl complexes: (t-butylamido)dimethyl(η⁵-2,3-dimethylindenyl)silanetitanium (II) 1,4-diphenyl-1,3-butadiene; (t-butylamido)dimethyl(η⁵-2,3-dimethylindenyl)silanetitanium (II) 1,3-pentadiene; (t-butylamido)dimethyl(η⁵-2,3-dimethylindenyl)silanetitanium (III) 2-(N,N-dimethylamino) benzyl; (t-butylamido)dimethyl(η⁵-2,3-dimethylindenyl)silanetitanium (IV) dimethyl; (t-butyl amido)dimethyl(η⁵-2,3-dimethylindenyl)silanetitanium (IV) dibenzyl; (n-butylamido) dimethyl(η⁵-2,3-dimethylindenyl)-silanetitanium (II) 1,4-diphenyl-1,3-butadiene; (n-butyl amido)dimethyl(η⁵-2,3-dimethylindenyl)silanetitanium (II) 1,3-pentadiene; (n-butylamido) dimethyl(η⁵-2,3-dimethylindenyl)-silanetitanium (III) 2-(N,N-dimethylamino)benzyl; (n-butylamido) dimethyl(η⁵-2,3-dimethylindenyl)silanetitanium (IV) dimethyl; (n-butylamido) dimethyl(η⁵-2,3-dimethylindenyl)silanetitanium (IV) dibenzyl; (cyclododecylamido) dimethyl(η⁵-2,3-dimethyl indenyl)silanetitanium (II) 1,4-diphenyl-1,3-butadiene; (cyclo dodecylamido)dimethyl(η⁵-2,3-dimethylindenyl)silanetitanium (II) 1,3-pentadiene; (cyclo dodecylamido)dirnethyl(η⁵-2,3-dimethylindenyl)silanetitanium (III) 2-(N,N-dimethylamino) benzyl; (cyclododecylamido) dimethyl(η⁵-2,3-dimethylindenyl) silanetitanium (IV) dimethyl; (cyclododecylamido)dimethyl(η⁵-2,3-dimethylindenyl) silanetitanium (IV) dibenzyl; (2,4,6-trimethylanilido)dimethyl(η⁵-2,3-dimethyl-indenyl) silanetitanium (II) 1,4-diphenyl-1,3-butadiene; (2,4,6-trimethylanilido) dimethyl(η⁵-2,3-dimethylindenyl)silanetitanium (II) 1,3-pentadiene; (2,4,6-trimethylanilido) dimethyl(η⁵-2,3-dimethylindenyl)silanetitanium (III) 2-(N,N-dimethylamino)benzyl; (2,4,6-trimethylanilido)dimethyl(η⁵-2,3-dimethylindenyl) silanetitanium (IV) dimethyl; (2,4,6-trimethylanilido)dimethyl(η⁵-2,3-dimethylindenyl) silanetitanium (IV) dibenzyl; (1-adamantyl amido)dimethyl(η⁵-2,3-dimethylindenyl) silanetitanium (II) 1,4-diphenyl-1,3-butadiene; (1-adamantylamido)dimethyl(η⁵-2,3-dimethyl indenyl)silanetitanium (II) 1,3-pentadiene; (1-adamantylamido)dimethyl(η⁵-2,3-dimethyl indenyl)silanetitanium (III) 2-(N,N-dimethylamino) benzyl; (1-adamantylamido)dimethyl(η⁵-2,3-dimethylindenyl)silanetitanium (IV) dimethyl; (1-adamantylamido)dimethyl(η⁵-2,3-dimethylindenyl)silanetitanium (IV) dibenzyl; (t-butylamido) dimethyl(η⁵-2,3-dimethylindenyl)silanetitanium (II) 1,4-diphenyl-1,3-butadiene; (t-butyl amido)dimethyl(η⁵-2,3-dimethylindenyl)silanetitanium (II) 1,3-pentadiene; (t-butylamido) dimethyl(η⁵-2,3-dimethylindenyl)silanetitanium (III) 2-(N,N-dimethylamino)benzyl; (t-butyl amido) dimethyl(η⁵-2,3-dimethylindenyl)silanetitanium (IV) dimethyl; (t-butylamido) dimethyl (η⁵-2,3-dimethylindenyl)silanetitanium (IV) dibenzyl; (n-butylamido)diisopropoxy(η⁵-2,3-dimethylindenyl)silanetitanium (II) 1,4-diphenyl-1,3-butadiene; (n-butylamido)diisopropoxy (η⁵-2,3-dimethylindenyl)silanetitanium (II) 1,3-pentadiene; (n-butylamido)diisopropoxy(η⁵-2,3-dimethylindenyl)silanetitanium (III) 2-(N,N-dimethylamino)benzyl; (n-butylamido) diisopropoxy(η⁵-2,3-dimethylindenyl)silanetitanium (IV) dimethyl; (n-butylamido) diisopropoxy(η⁵-2,3-dimethylindenyl)silanetitanium(IV)dibenzyl; (cyclododecylamido) diisopropoxy(η⁵-2,3-dimethylindenyl)-silanetitanium (II) 1,4-diphenyl-1,3-butadiene; (cyclododecylamido) diisopropoxy(η⁵-2,3-dimethylindenyl)-silanetitanium (II) 1,3-pentadiene; (cyclododecylamido) diisopropoxy(η⁵-2,3-dimethylindenyl)-silanetitanium (III) 2-(N,N-dimethylamino)benzyl; (cyclo dodecylamido)diisopropoxy(η⁵-2,3-dimethylindenyl)-silanetitanium (IV) dimethyl; (cyclo dodecylamido)diisopropoxy(η⁵-2,3-dimethylindenyl)-silanetitanium (IV) dibenzyl; (2,4,6-trimethylanilido)diisopropoxy(η⁵-2,3-dimethyl-indenyl)silanetitanium (II) 1,4-diphenyl-1,3-butadiene; (2,4,6-trimethylanilido) diisopropoxy(η⁵-2,3-dimethylindenyl)silanetitanium (II) 1,3-pentadiene; (2,4,6-trimethylanilido)diisopropoxy(η⁵-2,3-dimethylin-denyl)silanetitanium (III) 2-(N,N-dimethyl amino)benzyl; (2,4,6-trimethylanilido)diisopropoxy(η⁵-2,3-dimethylindenyl) silanetitanium (IV) dimethyl; (2,4,6-trimethylanilido)diisopropoxy(η⁵-2,3-dimethylindenyl) silanetitanium (IV) dibenzyl; (1-adamantylamido)diisopropoxy(η⁵-2,3-dimethylindenyl) silanetitanium (II) 1,4-diphenyl-1,3-butadiene; (1-adamantylamido)diisopropoxy(η⁵-2,3-di methylindenyl) silanetitanium (II) 1,3-pentadiene; (1 -adamantylamido)diisopropoxy(η⁵-2,3-dimethylindenyl) silanetitanium (III) 2-(N,N-dimethylamino)benzyl; (1-adamantylamido) diisopropoxy(η⁵-2,3-dimethylindenyl)silanetitanium (IV) dimethyl; (1-adamantylamido) diisopropoxy(η⁵-2,3-dimethylindenyl)silanetitanium (IV) dibenzyl; (n-butylamido) dimethoxy(η⁵-2,3-dimethyl indenyl)silanetitanium (II) 1,4-diphenyl-1,3-butadiene; (n-butyl amido)dimethoxy(η⁵-2,3-dimethylindenyl)silanetitanium (II) 1,3-pentadiene; (n-butylamido) dimethoxy(η⁵-2,3-dimethylindenyl)silanetitanium (III) 2-(N,N-dimethylamino)benzyl; (n-butyl amido) dimethoxy(η⁵-2,3-dimethylindenyl)silanetitanium (IV) dimethyl; (n-butylamido) dimethoxy(η⁵-2,3-dimethylindenyl)silanetitanium (IV) dibenzyl; (cyclododecylamido) dimethoxy (η⁵-2,3-dimethylindenyl)silanetitanium (II) 1,4-diphenyl-1,3-butadiene; (cyclo dodecylamido) dimethoxy(η⁵-2,3-dimethylindenyl)silanetitanium (11) 1,3-pentadiene; (cyclo dodecylamido) dimethoxy(η⁵-2,3-dimethylindenyl)silanetitanium (III) 2-(N,N-dimethyl amino)benzyl; (cyclo dodecylamido)dimethoxy(η⁵-2,3-dimethylindenyl)silanetitanium (IV) dimethyl; (cyclododecyl amido)dimethoxy(η⁵-2,3-dimethylindenyl)silanetitanium (IV) dibenzyl; (2,4,6-tri methylanilido)dimethoxy(η⁵-2,3-dimethyl-indenyl)silanetitanium (II) 1,4-diphenyl-1,3-butadiene; (2,4,6-trimethylanilido)dimethoxy(η⁵-2,3-dimethylindenyl)silane titanium(II) 1,3-pentadiene; (2,4,6-trimethylanilido)dimethoxy(η⁵-2,3-dimethylindenyl) silanetitanium (III) 2-(N,N-dimethylamino)benzyl; (2,4,6-trimethylanilido)dimethoxy(η⁵-2,3-dimethylindenyl) silanetitanium (IV) dimethyl; (2,4,6-trimethylanilido)dimethoxy(η⁵-2,3-dimethylindenyl) silanetitanium (IV) dibenzyl; (1-adamantylamido)dimethoxy(η⁵-2,3-dimethylindenyl) silanetitanium (II) 1,4-diphenyl-1,3-butadiene; (1-adamantyl amido)dimethoxy(η⁵-2,3-dimethyl indenyl)silanetitanium (II) 1,3-pentadiene; (1-adamantylamido)dimethoxy(η⁵-2,3-dimethyl indenyl)silanetitanium (III) 2-(N,N-dimethyl amino)benzyl; (1-adamantylamido)dimethoxy(η⁵-2,3-dimethylindenyl)silanetitanium (IV)dimethyl; (1-adamantylamido)dimethoxy(η⁵-2,3-dimethylindenyl) silanetitanium (IV) dibenzyl; (n-butylamido)ethoxymethyl(η⁵-2,3-dimethylindenyl)-silanetitanium (II) 1,4-diphenyl-1,3-butadiene; (n-butylamido)ethoxy methyl(η⁵-2,3 -dimethylindenyl)silanetitanium (II) 1,3-pentadiene; (n-butylamido) ethoxymethyl(η⁵-2,3-dimethylindenyl)silanetitanium (III) 2-(N,N-dimethylamino)benzyl; (n-butylamido)ethoxymethyl(η⁵-2,3-dimethylindenyl) silane titanium (IV) dimethyl; (n-butylamido) ethoxymethyl(η⁵-2,3-dimethylindenyl) silanetitanium (IV) dibenzyl; (cyclododecylamido) ethoxymethyl(η⁵-2,3-dimethylindenyl) silanetitanium (II) 1,4-diphenyl-1,3-butadiene; (cyclo dodecylamido)ethoxymethyl(η⁵-2,3-dimethyl indenyl)silanetitanium (II) 1,3-pentadiene; (cyclo dodecylamido)ethoxymethyl(η⁵-2,3-dimethylindenyl)silanetitanium (III) 2-(N,N-dimethylamino) benzyl; (cyclododecyl amido)ethoxymethyl(η5-2,3-dimethylindenyl)silanetitanium (IV) dimethyl; (cyclododecyl amido)ethoxymethy (η⁵-2,3-dimethylindenyl)silanetitanium (IV) dibenzyl; (2,4,6-trimethylanilido)ethoxymethyl(η⁵-2,3-dimethylindenyl)silanetitanium (II) 1,4-diphenyl-1,3-butadiene; (2,4,6-trimethylanilido)ethoxymethyl(η⁵-2,3-dimethylindenyl)silanetitanium (II) 1,3-pentadiene; (2,4,6-trimethylanilido)ethoxymethyl(η⁵-2,3-dimethylindenyI)silanetitanium (III) 2-(N,N-dimethylamino)benzyl; (2,4,6-trimethylanilido)ethoxymethyl(η⁵-2,3-dimethyl indenyl) silanetitanium (IV) dimethyl; (2,4,6-trimethylanilido)ethoxymethyl(η⁵-2,3-dimethyl indenyl) silanetitanium (IV) dibenzyl; (1-adamantylamido)ethoxymethyl(η⁵-2,3-dimethylindenyl) silanetitanium (II) 1,4-diphenyl-1,3-butadiene; (1-adamantylamido) ethoxymethyl(η⁵-2,3-dimethylindenyl)silanetitanium (II) 1,3-pentadiene; (1-adamantyl amido)ethoxymethyl(η⁵-2,3-dimethylindenyl)silanetitanium (III) 2-(N,N-dimethyl amino)benzyl; (1-adamantyl amido)ethoxymethyl(η⁵-2,3-dimethylindenyl) silanetitanium (IV) dimethyl; (1-adamantylamido) ethoxymethyl(η⁵-2,3-dimethylindenyl)silanetitanium (IV) dibenzyl;

3-methylindenyl complexes: (t-butylamido)dimethyl(η⁵-3-methylindenyl)silanetitanium (II) 1,4-diphenyl-1,3-butadiene; (t-butylamido)dimethyl(η⁵-3-methylindenyl)silanetitanium (II) 1,3-pentadiene; (t-butylamido) dimethyl(η⁵-3-methylindenyl)silanetitanium (III) 2-(N,N-dimethylamino)benzyl; (t-butyl amido)dimethyl(η⁵-3-methylindenyl)silanetitanium (IV) dimethyl; (t-butylamido) dimethyl(η⁵-3-methylindenyl)silanetitanium (IV) dibenzyl; (n-butylamido)dimethyl(η⁵-3-methylindenyl) silanetitanium (II) 1,4-diphenyl-1,3-butadiene; (n-butylamido)dimethyl(η⁵-3-methylindenyl) silanetitanium (II) 1,3-pentadiene; (n-butylamido)dimethyl(η⁵-3-methylindenyl)silanetitanium (III) 2-(N,N-dimethylamino)benzyl; (n-butylamido) dimethyl(η⁵-3-methylindenyl)silanetitanium (IV) dimethyl; (n-butylamido)dimethyl(η⁵-3-methylindenyl)silanetitanium (IV) dibenzyl; (cyclododecylamido)dimethyl(η⁵-3-methyl indenyl)silanetitanium (II) 1,4-diphenyl-1,3-butadiene; (cyclododecylamido)dimethyl(η⁵-3-methylindenyl)silanetitanium (II) 1,3-pentadiene; (cyclododecylamido)dimethyl(η⁵-3-methylindenyl)silanetitanium (III) 2-(N,N-dimethyl amino)benzyl; (cyclododecylamido) dimethyl(η⁵-3-methylindenyl)silanetitanium (IV) dimethyl; (cyclododecylamido) dimethyl(η⁵-3-methylindenyl)silanetitanium (IV) dibenzyl; (2,4,6-trimethylanilido) dimethyl(η⁵-3-methylindenyl)silanetitanium (II) 1,4-diphenyl-1,3-butadiene; (2,4,6-trimethylanilido)dimethyl(η⁵-3-methylindenyl)silanetitanium (II) 1,3-pentadiene; (2,4,6-trimethylanilido)dimethyl(η⁵-3-methylindenyl)silanetitanium (III) 2-(N,N-dimethylamino) benzyl; (2,4,6-trimethylanilido)dimethyl(η⁵-3-methylindenyl)silanetitanium (IV) dimethyl; (2,4,6-trimethylanilido)dimethyl -3-methylindenyl)silanetitanium (IV) dibenzyl; (1-adamantylamido)dimethyl(η⁵-3-methylindenyl)silanetitanium (II) 1,4-diphenyl- 1,3-butadiene; (1-adamantylamido)dimethyl(η⁵-3-methylindenyl)silanetitanium (II) 1,3-pentadiene; (1-adamantylamido)dimethyl(η⁵-3-methylindenyl)silanetitanium (III) 2-(N,N-dimethylamino) benzyl; (1-adamantylamido)dimethyl(η⁵-3-methylindenyl)silanetitanium (IV) dimethyl; (1-adamantylamido)dimethyl(η⁵-3-methylindenyl)silanetitanium (IV) dibenzyl; (t-butyl amido)dimethyl(η⁵-3-methylindenyl)silanetitanium (II) 1,4-diphenyl-1,3-butadiene; (t-butyl amido)dimethyl(η⁵-3-methylindenyl)silanetitanium (II) 1,3-pentadiene; (t-butylamido) dimethyl (η⁵-3-methylindenyl)silanetitanium (III) 2-(N,N-dimethylamino)benzyl; (t-butylamido)dimethyl(η⁵-3-methylindenyl)silanetitanium (IV) dimethyl; (t-butylamido)dimethy 1(η⁵-3-methylindenyl) silanetitanium (IV) dibenzyl; (n-butylamido)diisopropoxy(η⁵-3-methylindenyl)silanetitanium (II) 1,4-diphenyl- 1,3-butadiene; (n-butylamido)diisopropoxy(η⁵-3-methylindenyl)silanetitanium (II) 1,3-pentadiene; (n-butylamido)diisopropoxy(η⁵-3-methylindenyl)silanetitanium (III) 2-(N,N-dimethylamino)benzyl; (n-butylamido)diisopropoxy(η⁵-3-methylindenyl)silanetitanium (IV) dimethyl; (n-butylamido)diisopropoxy(η⁵-3-methylindenyl)silanetitanium (IV) dibenzyl; (cyclododecylamido)diisopropoxy(η⁵-3-methylindenyl)-silanetitanium (II) 1,4-diphenyl-1,3-butadiene; (cyclododecylamido)diisopropoxy(η⁵-3-methylindenyl)-silanetitanium (II) 1,3-pentadiene; (cyclododecylamido)diisopropoXy(η⁵-3-methylindenyl)-silanetitanium (III) 2-(N,N-dimethylamino)benzyl; (cyclododecylamido)diisopropoxy(η⁵-3-methylindenyl)-silanetitanium (IV) dimethyl; (cyclododecylamido)diisopropoxy(η⁵-3-methylindenyl)-silanetitanium (IV) dibenzyl; (2,4,6-trimethylanilido)diisopropoxy(η⁵-3-methyl-indenyl)silanetitanium (II) 1,4-diphenyl-1,3-butadiene; (2,4,6-trimethylanilido) diisopropoxy(η⁵-3-methylindenyl)silanetitanium (II) 1,3-pentadiene; (2,4,6-trimethylanilido) diisopropoxy(η⁵-3-methylin-denyl)silanetitanium (III) 2-(N,N-dimethylamino)benzyl; (2,4,6-trimethylanilido)diisopropoxy(η⁵-3-methylindenyl) silanetitanium (IV) dimethyl; (2,4,6-trimethylanilido)diisopropoxy(η⁵-3-methylindenyl) silanetitanium (IV) dibenzyl; (1-adamantylamido) diisopropoxy(η⁵-3-methylindenyl) silanetitanium (II) 1,4-diphenyl-1,3-pebutadiene; (1-adamantylamido)diisopropoxy(η⁵-3-methyl indenyl)silanetitanium (II) 1,3-pentadiene; (1-adamantylamido)diisopropoxy(η⁵-3-methyl indenyl)silanetitanium (III) 2-(N,N-dimethylamino)benzyl; (1-adamantylamido)diisopropoxy(η⁵-3-methylindenyl) silanetitanium (IV) dimethyl; (1-adamantylamido)diisopropoxy(η⁵-3-methylindenyl) silanetitanium (IV) dibenzyl; (n-butylamido)dimethoxy(η⁵-3-methylindenyl) silanetitanium (II) 1,4-diphenyl-1,3-butadiene; (n-butylamido)dimethoxy(η⁵-3 -methylindenyl) silane titanium (II) 1,3-pentadiene; (n-butylamido)dimethoxy(η⁵-3-methylindenyl)silanetitanium (III) 2-(N,N-dimethylamino)benzyl; (n-butylamido)dimethoxy(η⁵-3-methylindenyl)silane titanium (IV) dimethyl; (n-butylamido)dimethoxy(η⁵-3-methylindenyl)silanetitanium (IV) dibenzyl; (cyclododecylamido)dimethoxy(η⁵-3-methylindenyl)silanetitanium (II) 1,4-diphenyl-1,3-butadiene; (cyclododecylamido)dimethoxy(η⁵-3-methylindenyl)silanetitanium (II) 1,3-pentadiene; (cyclododecylamido)dimethoxy(η⁵-3-methylindenyl)silanetitanium (III) 2-(N,N-dimethylamino)benzyl; (cyclododecylamido)dimethoxy(η⁵3-methylindenyl) silane titanium (IV) dimethyl; (cyclododecylamido)dimethoxy(η⁵-3-methylindenyl) silanetitanium (IV) dibenzyl; (2,4,6-trimethylanilido)dimethoxy(η⁵-3-methylindenyl) silanetitanium (II) 1,4-diphenyl-1,3-butadiene; (2,4,6-trimethylanilido)dimethoxy(η⁵-3-methylindenyl) silane titanium (II) 1,3-pentadiene; (2,4,6-trimethylanilido)dimethoxy(η⁵-3-methylindenyl) silane titanium (III) 2-(N,N-dimethylamino)benzyl; (2,4,6-trimethylanilido)dimethoxy(η⁵-3-methylindenyl)silanetitanium (IV) dimethyl; (2,4,6-trimethylanilido)dimethoxy(η⁵-3-methylindenyl)silanetitanium (IV) dibenzyl; (1-adamantylamido)dimethoxy(l5-3-methylindenyl)silanetitanium (II) 1,4-diphenyl-1,3-butadiene; (1-adamantylamido) dimethoxy(η⁵-3-methylindenyl)silanetitanium (II) 1,3-pentadiene; (1-adamantylamido) dimethoxy(η⁵-3-methylindenyl)silanetitanium (III) 2-(N,N-dimethylamino)benzyl; (1-adamantylamido)dimethoxy(η⁵-3-methylindenyl)silanetitanium (IV) dimethyl; (1-adamantylamido)dimethoxy(η⁵-3-methylindenyl)silanetitanium (IV) dibenzyl; (n-butylamido)ethoxymethyl(η⁵-3-methylindenyl)silanetitanium (II) 1,4-diphenyl- 1,3-butadiene; (n-butylamido)ethoxymethyl(η⁵-3-methylindenyl)silanetitanium (II) 1,3-pentadiene; (n-butylamido)ethoxymethyl(η⁵-3-methylindenyl)silanetitanium (III) 2-(N,N-dimethyl amino)benzyl; (n-butylamido)ethoxymethyl(η⁵-3-methylindenyl)silanetitanium (IV) dimethyl; (n-butylamido)ethoxymethyl(η⁵-3-methylindenyl)silanetitanium (IV) dibenzyl; (cyclododecyl amido)ethoxymethyl(η⁵-3-methylindenyl)silanetitanium (II) 1,4-diphenyl-1,3-butadiene; (cyclo dodecylamido)ethoxymethyl(η⁵-3-methylindenyl)silanetitanium (II) 1,3-pentadiene; (cyclo dodecylamido)ethoxymethy(η⁵-3-methylindenyl)silanetitanium (III) 2-(N,N-dimethylamino) benzyl; (cyclododecylamido)ethoxymethyl(η⁵-3-methylindenyl) silane titanium (IV) dimethyl; (cyclododecylamido)ethoxymethyl(η⁵-3-methylindenyl) silane titanium (IV) dibenzyl; (2,4,6-tri methylanilido)ethoxymethy(η⁵1-3-methylindenyl) silanetitanium (II) 1,4-diphenyl-1,3-butadiene; (2,4,6-trimethylanilido)ethoxymethyl(η⁵l-3-methylindenyl)silanetitanium (II) 1,3-pentadiene; (2,4,6-trimethylanilido)ethoxymethyl(η⁵-3-methylindenyl)silanetitanium (III) 2-(N,N-dimethyl amino)benzyl; (2,4,6-trimethylanilido)ethoxymethyl(η⁵-3-methylindenyl)silanetitanium (IV) dimethyl; (2,4,6-trimethylanilido)ethoxymethyl(η⁵-3-methylindenyl)silanetitanium (IV) dibenzyl; (1-adamantylamido)ethoxymethyl(η⁵-3-methylindenyl)silanetitanium (II) 1,4-diphenyl-1,3-butadiene; (1-adamantylamido)ethoxymethyl(η⁵-3-methylindenyl)silanetitanium (II) 1,3-pentadiene;(1-adamantylamido)ethoxymethyl(η⁵-3-methylindenyl)silanetitanium (III) 2-(N,N-dimethylamino)benzyl; (1-adamantylamido)ethoxymethyl(η⁵-3-methylindenyl)silane titanium (IV) dimethyl; (1-adamantylamido)ethoxymethyl(η⁵-3-methylindenyl)silanetitanium (IV) dibenzyl;

2-methyl-3-ethylindenyl complexes: (t-butylamido)dimethyl(η⁵-2-methyl-3-ethylindenyl)silanetitanium (II) 1,4-diphenyl-1,3-butadiene; (t-butylamido)dimethyl(η⁵-2-methyl-3-ethylindenyl)silanetitanium (II) 1,3-pentadiene; (t-butylamido)dimethyl(η⁵-2-methyl-3-ethylindenyl)silanetitanium (III) 2-(N,N-dimethyl amino)benzyl; (t-butylamido)dimethyl(η⁵-2-methyl-3-ethylindenyl)silanetitanium (IV) dimethyl; (t-butylamido)dimethyl(η⁵-2-methyl-3-ethylindenyl)silanetitanium (IV) dibenzyl; (n-butyl amido)dimethyl(η⁵-2-methyl-3-ethylindenyl)-silanetitanium (II) 1,4-diphenyl-1,3-butadiene; (n-butylamido)dimethyl(η⁵-2-methyl-3-ethylindenyl)silanetitanium (II) 1,3-pentadiene; (n-butyl amido)dimethyl(η⁵-2-methyl-3-ethylindenyl)-silanetitanium (III) 2-(N,N-dimethylamino)benzyl; (n-butylamido)dimethyl(η⁵-2-methyl-3-ethylindenyl) silane titanium (IV) dimethyl; (n-butyl amido)dimethyl(η⁵-2-methyl-3-ethylindenyl)silanetitanium (IV) dibenzyl; (cyclododecylamido) dimethyl(η⁵-2-methyl-3-ethylindenyl)silanetitanium (II) 1,4-diphenyl- 1,3-butadiene; (cyclo dodecylamido)dimethyl(η⁵-2-methyl-3-ethylindenyl) silanetitanium (II) 1,3-pentadiene; (cyclo dodecylamido)dimethyl(η⁵-2-methyl-3-ethylindenyl)silanetitanium (III) 2-(N,N-dimethyl amino) benzyl; (cyclododecyl amido)dimethyl(-2-methyl-3-ethylindenyl)silanetitanium (IV) dimethyl; (cyclododecyl amido)dimethyl(η⁵-2-methyl-3-ethylindenyl)silanetitanium (IV) dibenzyl; (2,4,6-trimethylanilido)dimethyl(η⁵-2-methyl-3-ethyl-indenyl)silanetitanium (II) 1,4-diphenyl-1,3-butadiene; (2,4,6-trimethylanilido)dimethyl(η⁵-2-methyl-3-ethylindenyl)silanetitanium (II) 1,3-pentadiene; (2,4,6-trimethylanilido)dimethyl(η⁵-2-methyl-3-ethylindenyl)silanetitanium (III) 2-(N,N-dimethylamino)benzyl; (2,4,6-trimethylanilido)dimethyl(η⁵-2-methyl-3-ethylindenyl) silanetitanium (IV) dimethyl; (2,4,6-trimethylanilido)dimethyl(η⁵-2-methyl-3-ethylindenyl) silanetitanium (IV) dibenzyl; (1-adamantylamido)dimethyl(η⁵-2-methyl-3-ethylindenyl) silanetitanium (II) 1,4-diphenyl-1,3-butadiene; (1-adamantylamido) dimethyl(η⁵-2-methyl-3-ethylindenyl)silanetitanium (II) 1,3-pentadiene; (1-adamantylamido) dimethyl(η⁵-2-methyl-3-ethylindenyl)silanetitanium (III) 2-(N,N-dimethylamino)benzyl; (1-adamantylamido) dimethyl(η⁵-2-methyl-3-ethylindenyl)silanetitanium (IV) dimethyl; (1-adamantylamido) dimethyl(η⁵-2-methyl-3-ethylindenyl)silanetitanium (IV) dibenzyl; (t-butylamido)dimethyl(η⁵-2-methyl-3-ethylindenyl)-silanetitanium (II) 1 ,4-diphenyl-1,3-butadiene; (t-butylamido)dimethyl(η⁵-2-methyl-3-ethylindenyl)silanetitanium (II) 1,3-pentadiene; (t-butylamido)dimethyl(η⁵-2-methyl-3-ethylindenyl)-silanetitanium (III) 2-(N,N-dimethylamino)benzyl; (t-butylamido) dimethyl(η⁵-2-methyl-3-ethylindenyl)silanetitanium (IV) dimethyl; (t-butylamido)dimethyl(η⁵-2-methyl-3-ethylindenyl)silanetitanium (IV) dibenzyl; (n-butylamido)diisopropoxy(η⁵-2-methyl-3-ethyl-indenyl)silanetitanium (II) 1,4-diphenyl-1,3-butadiene; (n-butylamido)diisopropoxy(η⁵-2-methyl-3-ethylindenyl) silane titanium (II) 1,3-pentadiene; (n-butylamido)diisopropoxy(η⁵-2-methyl-3-ethylindenyl) silanetitanium (III) 2-(N,N-dimethylamino)benzyl; (n-butylamido) diisopropoxy(η⁵-2-methyl-3-ethylindenyl)silanetitanium (IV) dimethyl; (n-butylamido) diisopropoxy(η⁵-2-methyl-3-ethylindenyl)silanetitanium (IV) dibenzyl; (cyclododecylamido) diisopropoxy(-2-methyl-3-ethyl-indenyl)silanetitanium (II) 1,4-diphenyl-1,3-butadiene; (cyclo dodecylamido)diisopropoxy(η⁵-2-methyl-3-ethylindenyl)-silanetitanium (II) 1,3-pentadiene; (cyclododecylamido)diisopropoxy(η⁵-2-methyl-3-ethylindenyl)-silanetitanium (III) 2-(N,N-dimethylamino)benzyl; (cyclododecylamido)diisopropoxy(η⁵-2-methyl-3-ethylindenyl)-silane titanium (IV) dimethyl; (cyclododecylamido)diisopropoxy(η⁵-2-methyl-3-ethylindenyl)-silanetitanium (IV) dibenzyl; (2,4,6-trimethylanilido)diisopropoxy(η⁵-2-methyl-3-ethylindenyl) silanetitanium (II) 1,4-diphenyl-1,3-butadiene; (2,4,6-trimethylanilido)diisopropoxy(η⁵-2-methyl-3-ethylindenyl)silanctitanium (II) 1,3-pentadiene; (2,4,6-trimethylanilido)diisopropoxy(η⁵-2-methyl-3-ethylindenyl)silanetitanium (III) 2-(NN-dimethylamino)benzyl; (2,4,6-tri methylanilido)diisopropoxy(η⁵-2-methyl-3--ethylindenyl)silanetitanium (IV) dimethyl; (2,4,6-trimethylanilido)diisopropoxy(η⁵-2-methyl-3-ethylindenyl)silanetitanium (IV) dibenzyl; (1-adamantylamido)diisopropoxy(η⁵-2-methyl-3-ethyl-indenyl)silanetitanium (II) 1,4-diphenyl-1,3-butadiene; (1-adamantylamido) diisopropoxy(η⁵-2-methyl-3-ethylindenyl)silanetitanium (II) 1,3-pentadiene; (1-adamantylamido)diisopropoxy(η⁵-2-methyl-3-ethylindenyl)silanetitanium (III) 2-(N,N-dimethylamino)benzyl; (1-adamantylamido)diisopropoxy(η⁵-2-methyl-3-ethylindenyl) silane titanium (IV) dimethyl; (1-adamantylamido)diisopropoxy(η⁵-2-methyl-3-ethylindenyl) silane titanium (IV) dibenzyl; (n-butylamido)dimethoxy(η⁵-2-methyl-3-ethylindenyl)silane titanium (II) 1,4-diphenyl-1,3-butadiene; (n-butylamido)dimethoxy(η⁵-2-methyl-3-ethylindenyl) silanetitanium (II) 1,3-pentadiene; (n-butylamido)dimethoxy(η⁵-2-methyl-3-ethylindenyl) silanetitanium (III) 2-(N,N-dimethylamino)benzyl; (n-butylamido)dimethoxy(η⁵-2-methyl-3-ethylindenyl)silanetitanium (IV) dimethyl; (n-butylamido)dimethoxy(η⁵-2-methyl-3-ethylindenyl)silanetitanium (IV) dibenzyl; (cyclododecylamido)dimethoxy(η⁵-2-methyl-3-ethyl-indenyl)silanetitanium (II) 1,4-diphenyl- 1,3-butadiene; (cyclododecylamido) dimethoxy(η⁵-2-methyl-3-ethylindenyl)silanetitanium (II) 1,3-pentadiene; (cyclododecyl amido)dimethoxy(η⁵-2-methyl-3-ethylindenyl)silanetitanium (III) 2-(N,N-dimethylamino) benzyl; (cyclododecylamido) dimethoxy(η⁵-2-methyl-3-ethylindenyl) silanetitanium (IV) dimethyl; (cyclododecylamido) dimethoxy(η⁵-2-methyl-3-ethylindenyl) silanetitanium (IV) dibenzyl; (2,4,6-trimethylanilido) dimethoxy(η⁵-2-methyl-3-ethylindenyl)silanetitanium (II) 1,4-diphenyl-1,3-butadiene; (2,4,6-trimethylanilido) dimethoxy(η⁵-2-methyl-3-ethylindenyl) silanetitanium (II) 1,3-pentadiene; (2,4,6-trimethylanilido)dimethoxy(η⁵-2-methyl-3-ethyl indenyl)silanetitanium (III) 2-(N,N-dimethylamino)benzyl; (2,4,6-trimethylanilido) dimethoxy(η⁵-2-methyl-3-ethylindenyl) silanetitanium (IV) dimethyl; (2,4,6-trimethyl anilido)dimethoxy(η⁵-2-methyl-3-ethylindenyl) silanetitanium (IV) dibenzyl; (1-adamantylamido)dimethoxy(η⁵-2-methyl-3-ethylindenyl) silanetitanium (II) 1 ,4-diphenyl-1,3-butadiene; (1-adamantylamido)dimethoxy(η⁵-2-methyl-3-ethylindenyl)silanetitanium (II) 1,3-pentadiene; (1-adamantylamido)dimethoxy(η⁵-2-methyl-3-ethylindenyl)silanetitanium (III) 2-(N,N-dimethylamino)benzyl; (1-adamantylamido) dimethoxy(η⁵-2-methyl-3-ethylindenyl)silanetitanium (IV) dimethyl; (1-adamantylamido) dimethoxy(η⁵-2-methyl-3-ethylindenyl)silanetitanium (IV) dibenzyl; (n-butylamido) ethoxymethy(η⁵-2-methyl-3-ethyl-indenyl)silanetitanium (II) 1,4-diphenyl-1,3-butadiene; (n-butylamido)ethoxy methyl(η⁵-2-methyl-3-ethylindenyl)silanetitanium (II) 1,3-pentadiene; (n-butylamido)ethoxy methyl(η⁵-2-methyl-3-ethylindenyl)silanetitanium (III) 2-(N,N-dimethyl arnino)benzyl; (n-butylamido)ethoxymethyl(η⁵-2-methyl-3-ethylindenyl)silanetitanium (IV) dimethyl; (n-butylamido)ethoxymethy(η⁵-2-methyl-3-ethylindenyl)silanetitanium (IV) dibenzyl; (cyclododecylamido)ethoxymethyl(η⁵-2-methyl-3-ethyl-indenyl)silane-titanium (II) 1,4-diphenyl-1,3-butadiene; (cyclododecylaniido)ethoxymethyl(η⁵-2-methyl-3-ethylindenyl) silane-titanium (II) 1,3-pentadiene; (cyclododecylamido)ethoxymethyl(η⁵-2-methyl-3-ethylindenyl) silane-titanium (III) 2-(N,N-dimethylamino)benzyl; (cyclododecylamido) ethoxytnethyl(η⁵-2-methyl-3-ethylindenyl)silanetitanium (IV) dimethyl; (cyclododecyl amido)ethoxymethyl(η⁵-2-methyl-3-ethylindenyl)silanetitanium (IV) dibenzyl; (2,4,6-trimethylanilido)ethoxymethyl(η⁵-2-methyl-3-ethylindenyl)silanetitanium (II) 1,4-diphenyl-1,3-butadiene; (2,4,6-trimethylanilido) ethoxymethyl(η⁵-2-methyl-3-ethylindenyl) silanetitanium (II) 1,3-pentadiene; (2,4,6-trimethylanilido)ethoxymethyl(η⁵-2-methyl-3-ethyl indenyl)silanetitanium (III) 2-(N,N-dimethylamino)benzyl; (2,4,6-trimethylanilido) ethoxymethyl(η⁵-2-methyl-3-ethylindenyl) silanetitanium (IV) dimethyl; (2,4,6-trimethylanilido)ethoxymethyl(η⁵-2-methyl-3-ethylindenyl) silanetitanium (IV) dibenzyl; (1-adamantylamido)ethoxymethyl(η⁵-2-methyl-3-ethylindenyl) silanetitanium (11) 1,4-diphenyl-1,3-butadiene; (1-adamantylamido)ethoxymethyl(η⁵-2-methyl-3-ethylindenyl)silanetitanium (II) 1,3-pentadiene; (1-adamantylamido)ethoxymethyl(η⁵-2-methyl-3-ethylindenyl) silanetitanium (III) 2-(N,N-dimethylamino)benzyl; (1-adamantylamido) ethoxymethyl(,9⁵-2-methyl-3-ethylindenyl)silanetitanium (IV) dimethyl; (1-adamantylamido) ethoxymethyl(η⁵-2-methyl-3-ethylindenyl)silanetitanium (IV) dibenzyl;

2,3,4,6-tetramethylindenyl complexes: (t-butylamido)dimethyl(η⁵-2,3,4,6-tetramethylindenyl)silanetitanium (II) 1,4-diphenyl-1,3-butadiene; (t-butylamido)dimethyl(η⁵-2,3,4,6-tetramethylindenyl)silanetitanium (II) 1,3-pentadiene; (t-butylamido)dimethyl(η⁵-2,3,4,6-tetramethylindenyl)silanetitanium (III) 2-(N,N-dimethylamino)benzyl; (t-butylamido)dimethyl(η⁵-2,3,4,6-tetramethylindenyl)silane titanium (IV) dimethyl; t-butylamido)dimethyl(η⁵-2,3,4,6-tetramethylindenyl)silanetitanium (IV) dibenzyl; (n-butylamido)dimethyl(η⁵-2,3,4,6-tetramethylindenyl)silanetitanium (II) 1,4-diphenyl-1,3-butadiene; (n-butylamido)dimethyl(η⁵-2,3,4,6-tetramethylindenyl)silane titanium (II) 1,3-pentadiene; (n-butylamido)dimethyl(η⁵-2,3,4,6-tetramethylindenyl)-silane titanium (III) 2-(N,N-dimethylamino)benzyl; (n-butylamido)dimethyl(η⁵-2,3,4,6-tetra methylindenyl)silanetitanium (IV) dimethyl; (n-butylamido)dimethyl(η⁵-2,3,4,6-tetra methylindenyl)silanetitanium (IV) dibenzyl; (cyclododecylamido)dimethyl(η⁵-2,3,4,6-tetra methylindenyl)silanetitanium (II) 1,4-diphenyl-1,3-butadiene; (cyclododecylamido) dimethyl(η⁵-2,3,4,6-tetramethylindenyl) silane titanium (II) 1,3-pentadiene; (cyclododecylamido)dimethyl(η⁵-2,3,4,6-tetramethylindenyl) silane titanium (III) 2-(N,N-dimethylamino)benzyl; (cyclododecylamido)dimethyl(η⁵-2,3,4,6-tetramethylindenyl)silane titanium (IV) dimethyl; (cyclododecylamido)dimethyl(η⁵-2,3,4,6-tetramethylindenyl) silanetitanium (IV) dibenzyl; (2,4,6-trimethylanilido)dimethyl(η⁵-2,3,4,6-tetramethylindenyl) silanetitanium (II)1,4-diphenyl-1,3-butadiene; (2,4,6-trimethylanilido) dimethyl(i 5-2,3,4,6-tetramethylindenyl)silanetitanium (II) 1,3-pentadiene; (2,4,6-tri methylanilido)dimethyl(η⁵-2,3,4,6-tetramethylindenyl)silanetitanium (III) 2-(N,N-dimethyl amino)benzyl; (2,4,6-trimethylanilido)dimethyl(η⁵-2,3,4,6-tetramethylindenyl)silane titanium (IV) dimethyl; (2,4,6-trimethylanilido)dimethyl(η⁵-2,3,4,6-tetramethylindenyl)silane titanium (IV) dibenzyl; (1-adamantylamido)dimethyl(η⁵-2,3,4,6-tetramethylindenyl) silanetitanium (II) 1,4-diphenyl-1,3-butadiene; (1-adamantylamido)dimethyl(η⁵-2,3,4,6-tetramethylindenyl)silane titanium (II) 1,3-pentadiene; (1-adamantylamido)dimethyl(η⁵-2,3,4,6-tetramethylindenyl) silane titanium (III) 2-(N,N-dimethylamino)benzyl; (1-adamantylamido)dimethyl(η⁵-2,3,4,6-tetra methylindenyl)silanetitanium (IV) dimethyl; (1-adamantylamido)dimethyl(η⁵-2,3,4,6-tetra methylindenyl)silanetitanium (IV) dibenzyl; (t-butylamido)dimethyl(η⁵-2,3,4,6-tetramethyl indenyl)-silanetitanium (II) 1 ,4-diphenyl- 1,3-butadiene; (t-butylamido) dimethyl(η⁵-2,3,4,6-tetramethylindenyl)silanetitanium (II) 1,3-pentadiene; (t-butylamido) dimethyl(η⁵-2,3,4,6-tetramethylindenyl)-silanetitanium (III) 2-(N,N-dimethylamino)benzyl; (t-butylamido) dimethyl(η⁵-2,3,4,6-tetramethylindenyl)silanetitanium (IV) dimethyl; (t-butylamido)dimethyl (η⁵-2,3,4,6-tetramethylindenyl)silanetitanium (IV) dibenzyl; (n-butylamido)diisopropoxy(η⁵-2,3,4,6-tetramethylindenyl)silane-titanium (II)1 ,4-diphenyl-1,3-butadiene; (n-butylamido) diisopropoxy(η⁵-2,3,4,6-tetramethylindenyl)silane-titanium (II) 1,3-pentadiene; (n-butylamnido) diisopropoxy(η⁵-2,3,4,6-tetramethylindenyl)-silanetitanium (III) 2-(N,N-dimethylamino)benzyl; (n-butylamido)diisopropoxy(η⁵-2,3,4,6-tetramethyl indenyl)silane-titanium (IV) dimethyl; (n-butylamido)diisopropoxy(η⁵-2,3,4,6-tetramethyl indenyl)silane-titanium (IV) dibenzyl; (cyclo dodecylamido)diisopropoxy(η⁵-2,3,4,6-tetramethylindenyl)-silanetitanium (II) 1,4-diphenyl-1,3-butadiene; (cyclododecylamido) diisopropoxy(η⁵ -2,3,4,6-tetramethylindenyl)silanetitanium (II) 1,3 -pentadiene; (cyclododecyl amido)diisopropoxy(-2,3,4,6-tetramethylindenyl)silanetitanium (III) 2-(N,N-dimethylamino) benzyl; cyc.ododecylamido)diisopropoxy(η⁵-2,3,4,6-tetramethyl indenyl)silanetitanium (IV) dimethyl; (cyclododecylamido)diisopropoxy(η⁵-2,3,4,6-tetramethyl indenyl)silanetitanium (IV) dibenzyl; (2,4,6-trimethylanilido)diisopropoxy(η⁵-2,3,4,6-tetramethylindenyl) silanetitanium (II) 1,4-diphenyl- 1,3-butadiene; (2,4,6-trimethylanilido) diisopropoxy(η⁵-2,3,4,6-tetramethylindenyl)silanetitanium (II) 1,3-pentadiene; (2,4,6-trimethyl anilido)diisopropoxy(η⁵-2,3,4,6-tetramethylindenyl)silanetitanium (III) 2-(N,N-dimethylamino) benzyl; (2,4,6-trimethylanilido)diisopropoxy(η⁵-2,3,4,6-tetramethyl indenyl)silanetitanium (IV) dimethyl; (2,4,6-trimethylanilido)diisopropoxy(η⁵-2,3,4,6-tetramethylindenyl)silanetitanium (IV) dibenzyl; (1-adamantylamido)diisopropoxy(η⁵-2,3,4,6-tetramethylindenyl)silanetitanium (II) 1,4-diphenyl-1,3-butadiene; (1-adamantylamido)diisopropoxy(η⁵-2,3,4,6-tetramethyl indenyl)silanetitanium (II) 1,3-pentadiene; (1-adamantylamido)diisopropoxy(η⁵-2,3,4,6-tetramethylindenyl)silanetitanium (III) 2-(N,N-dimethylamino)benzyl; (1-adamantyl amido)diisopropoxy(η⁵-2,3,4,6-tetramethylindenyl)silanetitanium (IV) dimethyl; (1-adamantyl amido)diisopropoxy(η⁵-2,3,4,6-tetramethylindenyl)silanetitanium (IV) dibenzyl; (n-butyl amido)dimethoxy(η⁵-2,3,4,6-tetramethylindenyl)silanetitanium (II) 1,4-diphenyl-1,3-butadiene; (n-butylaniido)dimethoxy(η⁵-2,3,4,6-tetramethylindenyl)silanetitanium (II) 1,3-pentadiene; (n-butylamido)dimethoxy(η⁵-2,3,4,6-tetramethylindenyl)silanetitanium (III) 2-(N,N-dimethyl amino)benzyl; (n-butylamido)dimethoxy(η⁵-2,3,4,6-tetramethylindenyl)silanetitanium (IV) dimethyl; (n-butylamido)dimethoxy(η⁵-2,3,4,6-tetramethylindenyl)silanetitanium (IV) dibenzyl; (cyclododecylamido)dimethoxy(η⁵-2,3,4,6-tetramethylindenyl)silanetitanium (II) 1,4-diphenyl-1,3-butadiene; (cyclododecylamido)dimethoxy(η⁵-2,3,4,6-tetramethylindenyl) silanetitanium (II) 1,3-pentadiene; (cyclododecylamido)dimethoxy(η⁵-2,3,4,6-tetramethyl indenyl)silanetitanium (III) 2-(N,N-dimethylamino)benzyl; (cyclododecylamido) dimethoxy(η⁵-2,3,4,6-tetramethyl indenyl)silanetitanium (IV) dimethyl; (cyclododecylamido) dimethoxy(η⁵-2,3,4,6-tetramethyl indenyl)silanetitanium (IV) dibenzyl; (2,4,6-trimethylanilido)dimethoxy(η⁵-2,3,4,6-tetramethyl indenyl)silanetitanium (II) 1,4-diphenyl-1,3-butadiene; (2,4,6-trimethylanilido)dimethoxy(η⁵-2,3,4,6-tetramethylindenyl)silane titanium (II) 1,3-pentadiene; (2,4,6-trimethylanilido) dimethoxy(η⁵-2,3,4,6-tetramethyl indenyl)silanetitanium (III) 2-(N,N-dimethylamino)benzyl; (2,4,6-trimethylanilido) dimethoxy(η⁵-2,3,4,6-tetramethylindenyl)silanetitanium (IV) dimethyl; (2,4,6-trimethylanilido)dimethoxy η⁵-2,3,4,6-tetramethylindenyl)silanetitanium (IV) dibenzyl; (1-adamantylamido)dimethoxyη⁵-2,3,4,6-tetramethylindenyl)silanetitanium (II) 1,4-diphenyl-1,3-butadiene; (1-adamantylamido)dimethoxy(η⁵-2,3,4,6-tetramethylindenyl)silanetitanium (II) 1,3-pentadiene; (1-adamantylamido)dimethoxy(η⁵-2,3,4,6-tetramethylindenyl) silanetitanium (III) 2-(N,N-dimethylamino)benzyl; (1-adamantylamido)dimethoxy(η⁵-2,3,4,6-tetramethyl indenyl)silanetitanium (IV) dimethyl; (1-adamantylamido)dimethoxy(η⁵-2,3,4,6-tetramethyl indenyl)silanetitanium (IV) dibenzyl; (n-butylamido)ethoxymethyl(η⁵-2,3,4,6-tetramethylindenyl)silanetitanium (II) 1,4-diphenyl- 1,3-butadiene; (n-butylamido)ethoxymethyl(η⁵-2,3,4,6-tetramethylindenyl)silanetitanium (II) 1,3-pentadiene; (n-butylamido)ethoxymethyl(η⁵-2,3,4,6-tetramethylindenyl)silanetitanium (III) 2-(N,N-dimethylamino)benzyl; (n-butylamido)ethoxymethyl(η⁵-2,3,4,6-tetramethylindenyl)silane titanium (IV) dimethyl; (n-butylamido)ethoxymethyl(η⁵-2,3,4,6-tetramethylindenyl)silane titanium (IV) dibenzyl; (cyclododecylamido)ethoxymethyl(η⁵-2,3,4,6-tetramethylindenyl) silanetitanium (II) 1,4-diphenyl- 1,3-butadiene; (cyclododecylamido)ethoxymethyl(η⁵-2,3,4,6-tetramethylindenyl) silanetitanium (II) 1,3-pentadiene; (cyclododecylamido) ethoxymethyl(η⁵-2,3,4,6-tetramethyl indenyl)silanetitanium (III) 2-(N,N-dimethylamino)benzyl; (cyclododecylamido)ethoxymethyl(η⁵-2,3,4,6-tetramethylindenyl) silan etitanium (IV) dimethyl; (cyclododecylamido)ethoxymethyl(η⁵-2,3,4,6-tetramethylindenyl)silanetitanium (IV) dibenzyl; (2,4,6-trimethylanilido)ethoxy methyl(η⁵-2,3,4,6-tetramethylindenyl)silanetitanium (II) 1,4-diphenyl- 1,3-butadiene; (2,4,6-trimethylanilido)ethoxymethyl(η⁵-2,3,4,6-tetramethylindenyl)silanetitanium (II) 1,3-pentadiene; (2,4,6-trimethylanilido)ethoxymethyl(η⁵-2,3,4,6-tetamethylindenyl)silane titanium (III) 2-(N,N-dimethylamino)benzyl; (2,4,6-trimethylanilido)ethoxymethyl(η⁵-2,3,4,6-tetramethylindenyl) silanetitanium (IV) dimethyl; (2,4,6-trimethylanilido)ethoxymethyl(η⁵-2,3,4,6-tetramethyl indenyl)silanetitanium (IV) dibenzyl; (1-adamantylamido)ethoxymethyl(η⁵-2,3,4,6-tetramethylindenyl)silanetitanium (II) 1,4-diphenyl-1,3-butadiene; (1-adamantylamido)ethoxymethyl(η⁵-2,3,4,6-tetramethylindenyl) silanetitanium (II) 1,3-pentadiene; (1-adamantylamido)ethoxymethyl(q⁵-2,3,4,6-tetramethyl indenyl)silanetitanium (III) 2-(N,N-dimethylamino)benzyl; (1-adamantylamido) ethoxymethyl(η⁵-2,3,4,6-tetramethylindenyl)silane titanium (IV) dimethyl; and (1-adamantylamido)ethoxymethyl(η⁵-2,3,4,6-tetramethyl indenyl)silanetitanium (IV) dibenzyl.

2,3,4,6,7-pentamethylindenyl complexes: (t-butylamido)dimethyl(η⁵-2,3,4,6,7-pentamethyl-indenyl)silanetitanium (II) 1,4-diphenyl-1,3-butadiene; (t-butylamido)dimethyl(η⁵-2,3,4,6,7-pentamethylindenyl)silanetitanium (II) 1,3-pentadiene; (t-butylamido)dimethyl(η⁵-2,3,4,6,7-pentamethylindenyl )silanetitanium (III) 2-(N,N-dimethylamino)benzyl; (t-butylamido)dimethyl(η⁵-2,3,4,6,7-pentamethylindenyl) silanetitanium (IV) dimethyl; (t-butylamido)dimethyl(η⁵-2,3,4,6,7-pentamethylindenyl) silanetitanium (IV) dibenzyl; (n-butylamido)dimethyl(η⁵-2,3,4,6,7-pentamethyl-indenyl)silanetitanium (II) 1,4-diphenyl-1,3-butadiene; (n-butylamido)dimethyl(η⁵-2,3,4,6,7-pentamethylindenyl)silanetitanium (II) 1,3-pentadiene; (n-butylamido)dimethyl(η⁵-2,3,4,6,7-pentamethylindenyl)-silanetitanium (III) 2-(N,N-dimethylamino)benzyl; (n-butylamido) dimethyl(η⁵-2,3,4,6,7-pentamethylindenyl) silanetitanium (IV) dimethyl; (n-butylamido) dimethyl(η⁵-2,3,4,6,7-pentamethylindenyl)silane titanium (IV) dibenzyl; (cyclododecyl amido)dimethyl(η⁵-2,3,4,6,7-pentamethylindenyl)silane titanium (II) 1,4-diphenyl-1,3-butadiene; (cyclododecylamido)dimethyl(η⁵-2,3,4,6,7-pentamethylindenyl) silanetitanium (II) 1,3-pentadiene; (cyclododecylamido)dimethyl(η⁵-2,3,4,6,7-pentamethylindenyl) silanetitanium (III) 2-(N,N-dimethylamino)benzyl; (cyclododecyl amido)dimethyl(η⁵-2,3,4,6,7-pentamethylindenyl)silanetitanium (IV) dimethyl; (cyclododecyl amido)dimethyl(η⁵-2,3,4,6,7-pentamethylindenyl)silanetitanium (IV) dibenzyl; (2,4,6,7-trimethylanilido)dimethyl(η⁵-2,3,4,6,7-pentamethyl-indenyl)silanetitanium (II) 1,4-diphenyl-1,3-butadiene; (2,4,6-trimethylanilido)dimethyl(η⁵-2,3,4,6,7-pentamethylindenyl)silane titanium (II) 1,3-pentadiene;2,4,6-trimethylanilido)dimethyl(η⁵-2,3,4,6,7-pentamethyl-indenyl)silane titanium (III) 2-(N,N-dimethylamino)benzyl; (2,4,6-trimethylanilido) dimethyl(η⁵-2,3,4,6,7-pentamethylindenyl)silanetitanium (IV) dimethyl; (2,4,6-trimethylanilido)dimethyl(η⁵-2,3,4,6,7-pentamethylindenyl)silanetitanium (IV) dibenzyl; (1-adamantylamido)dimethyl(η⁵-2,3,4,6,7-pentamethylindenyl)silanetitanium (II) 1,4-diphenyl-1,3-butadiene; (1-adamantylamido)dimethyl(η⁵-2,3,4,6,7-pentamethylindenyl)silanetitanium (II) 1,3-pentadiene; (1-adamantylamido) dimethyl(η⁵-2,3,4,6,7-pentamethylindenyl) silanetitanium (III) 2-(N,N-dimethylamino)benzyl; (1-adamantylamido)dimethyl(η⁵-2,3,4,6,7-pentamethylindenyl)silanetitanium (IV) dimethyl; (1-adamantylamido)dimethyl(η⁵-2,3,4,6,7-pentamethylindenyl)silanetitanium (IV) dibenzyl; (t-butylamido)dimethyl(η⁵-2,3,4,6,7-pentamethylindenyl)-silanetitanium (II) 1,4-diphenyl-1,3-butadiene; (t-butylamido)dimethyl(η⁵-2,3,4,6,7-pentamethylindenyl)silanetitanium (II) 1,3-pentadiene; (t-tylamio)butyamido)dimethyl(η⁵-2,3,4,6,7-pentamethylindenyl)-silanetitanium (III) 2-(NN-dimethylamino)benzyl; (t-butylamido)dimethyl(η5-2,3,4,6,7-pentametylindenyl) silane titanium (IV) dimethyl; (t-butylamido)dimethyl(η⁵-2,3,4,6,7-pentamethylindenyl) silanetitanium (IV) dibenzyl; (n-butylamido)diisopropoxy(η⁵-2,3,4,6,7-pentamethyl-indenyl) silane-titanium (II) 1,4-diphenyl-1,3-butadiene; (n-butylamido)diisopropoxy(η⁵-2,3,4,6,7-pentamethylindenyl)silane-titanium (II) 1,3-pentadiene; (n-butylamido)diisopropoxy(η⁵-2,3,4,6,7-pentamethylindenyl)-silanetitanium (III) 2-(N,N-dimethylamino)benzyl; (n-butylamido)diisopropoxy(η⁵-2,3,4,67-pentamethylindenyl)silane-titanium (IV) dimethyl; (n-butylamido)diisopropoxy(η⁵-2,3,4,6,7-pentamethylindenyl)silane-titanium (IV) dibenzyl; (cyclododecylamido)diisopropoxy(η⁵-2,3,4,6,7-pentamethyl-indenyl)-sianetitanium (II) 1,4-diphenyl-1,3-butadiene; (cyclododecylamido)diisopropoxy(η⁵-2,3,4,6,7-pentamethylindenyl) silanetitanium (II) 1,3-pentadiene; (cyclododecylamido)diisopropoxy(η⁵-2,3,4,6,7-penta methylindenyl)silanetitanium (III) 2-(N,N-dimethylamino)benzyl; (cyclododecylamido) diisopropoxy(η⁵-2,3,4,6,7-pentamethylindenyl)silanetitanium (IV) dimethyl; (cyclododecyl amido)diisopropoxy(η⁵-2,3,4,6,7-pentamethylindenyl)silanetitanium (IV) dibenzyl; (2,4,6-trimethylanilido)diisopropoxy(η⁵-2,3,4,6,7-pentamethylindenyl)silanetitanium (II) 1,4-diphenyl-1,3-butadiene; (2,4,6-trimethylanilido)diisopropoxy(η⁵ -2,3,4,6,7-pentamethyl indenyl)silane titanium (II) 1,3-pentadiene; (2,4,6-trimethylanilido)diisopropoxy(η⁵-2,3,4,6,7-pentamethyl indenyl)silanetitanium (III) 2-(N,N-dimethylamino)benzyl; (2,4,6-trimethylanilido) diisopropoxy(η⁵-2,3,4,6,7-pentamethylindenyl)silanetitanium (IV) dimethyl; (2,4,6-trimethyl anilido)diisopropoxy(η⁵-2,3,4,6,7-pentamethylindenyl) silanetitanium (IV) dibenzyl; (1-adamantylamido)diisopropoxy(η⁵-2,3,4,6,7-pentamethyl-indenyl)silanetitanium (II) 1,4-diphenyl-1,3-butadiene; (1-adamantylamido)diisopropoxy(η⁵-2,3,4,6,7-pentamethylindenyl) silanetitanium (II) 1,3-pentadiene; (1-adamantylamido)diisopropoxy(η⁵-2,3,4,6,7-penta methylindenyl)silanetitanium (III) 2-(N,N-dimethylamino)benzyl; (1-adamantylamido) diisopropoxy(η⁵-2,3,4,6,7-pentamethylindenyl) silanetitanium (IV) dimethyl; (1-adamantyl amido)diisopropoxy(η⁵-2,3,4,6,7-pentamethylindenyl)silanetitanium (IV) dibenzyl; (n-butylamido)dimethoxy(η⁵-2,3,4,6,7-pentamethylindenyl)silanetitanium (II) 1,4-diphenyl-1,3-butadiene; (n-butylamido) dimethoxy(η⁵-2,3,4,6,7-pentamethylindenyl)silanetitanium (II) 1,3-pentadiene; (n-butylamido)dimethoxy(η⁵-2,3,4,6,7-pentamethylindenyl)silanetitanium (III) 2-(N,N-dimethylamino)benzyl; (n-butylamido)dimethoxy(η⁵-2,3,4,6,7-pentamethylindenyl)silane titanium (IV) dimethyl; (n-butylamido)dimethoxy(η⁵-2,3,4,6,7-pentamethylindenyl)silane titanium (IV) dibenzyl; (cyclododecylamido)dimethoxy(η⁵-2,3,4,6,7-pentamethylindenyl) silanetitanium (II) 1,4-diphenyl-1,3-butadiene; (cyclododecylamido)dimethoxy(η⁵-2,3,4,6,7-pentamethylindenyl)silanetitanium (II) 1,3-pentadiene; (cyclododecylamido)dimethoxy(η⁵-2,3,4,6,7-pentamethylindenyl)silanetitanium (III) 2-(N,N-dimethylamino)benzyl; (cyclododecyl amido)dimethoxy(η⁵-2,3,4,6,7-pentamethylindenyl)silanetitanium (IV) dimethyl; (cyclododecylamido)dimethoxy(η⁵-2,3,4,6,7-pentamethylindenyl)silanetitanium (IV) dibenzyl; (2,4,6-trimethylanilido)dimethoxy(η⁵-2,3,4,6,7-pentamethylindenyl)silane titanium (II) 1,4-diphenyl-1,3-butadiene; (2,4,6-trimethylanilido)dimethoxy(η⁵-2,3,4,6,7-pentamethylindenyl) silanetitanium (II) 1,3-pentadiene; (2,4,6-trimethylanilido) dimethoxy(η⁵-2,3,4,6,7-pentamethyl indenyl)silanetitanium (III) 2-(N,N-dimethylamino)benzyl; (2,4,6-trimethylanilido) dimethoxy(η⁵-2,3,4,6,7-pentamethyl indenyl)silanetitanium (IV) dimethyl; (2,4,6-trimethyl anilido)dimethoxy(η⁵-2,3,4,6,7-pentamethylindenyl)silanetitanium (IV) dibenzyl; (1-adamantyl amido)dimethoxy(η⁵-2,3,4,6,7-pentamethylindenyl)silanetitanium (II) 1,4-diphenyl-1,3-butadiene; (1-adamantylamido)dimethoxy(η⁵-2,3,4,6,7-pentamethylindenyl)silanetitanium (II) 1,3-pentadiene; (1-adamantylamido)dimethoxy(η⁵-2,3,4,6,7-pentamethylindenyl)silanetitanium (III) 2-(N,N-dimethylamino)benzyl; (1-adamantylamido)dimethoxy(η⁵-2,3,4,6,7-pentamethyl indenyl)silanetitanium (IV) dimethyl; (1 -adamantylamido)dimethoxy(η⁵-2,3,4,6,7-pentamethyl indenyl)silanetitanium (IV) dibenzyl; (n-butylamido)ethoxymethyl(η⁵-2,3,4,6,7-pentamethyl-indenyl)silanetitanium (II) 1,4-diphenyl-1,3-butadiene; (n-butylamido)ethoxymethyl(η⁵-2,3,4,6,7-pentamethylindenyl)silanetitanium (II) 1,3-pentadiene; (n-butylamido)ethoxymethyl(η⁵-2,3,4,6,7-pentamethylindenyl)silanetitanium (III) 2-(N,N-dimethylamino)benzyl; (n-butyl amido)ethoxymethyl(η⁵-2,3,4,6,7-pentamethylindenyl)silanetitanium (IV) dimethyl; (n-butyl amido)ethoxymethyl(η⁵-2,3,4,6,7-pentamethylindenyl)silanetitanium (IV) dibenzyl; (cyclo dodecylamido)ethoxymethyl(η⁵-2,3,4,6,7-pentamethylindenyl)silanetitanium (II) 1,4-diphenyl-1,3-butadiene; (cyclododecylamido)ethoxymethyl(η⁵-2,3,4,6,7-pentamethylindenyl)silane titanium (II) 1,3-pentadiene; (cyclododecylamido)ethoxymethyl(η⁵-2,3,4,6,7-pentamethyl indenyl)silane titanium (III) 2-(N,N-dimethylamino)benzyl; (cyclododecylamido)ethoxymethyl(η⁵-2,3,4,6,7-pentamethylindenyl)silanetitanium (IV) dimethyl; (cyclododecylamido) ethoxymethyl(η⁵-2,3,4,6,7-pentamethylindenyl)silanetitanium (IV) dibenzyl; (2,4,6-trimethylanilido)ethoxymethyl(η⁵-2,3,4,6,7-pentamethylindenyl)silanetitanium (II) 1,4-diphenyl-1,3-butadiene; (2,4,6-trimethylanilido)ethoxymethyl(η⁵-2,3,4,6,7-pentamethyl indenyl)silane titanium (II) 1,3-pentadiene; (2,4,6-trimethylanilido) ethoxymethyl(η⁵-2,3,4,6,7-pentamethyl indenyl)silanetitanium (III) 2-(N,N-dimethylamino)benzyl; (2,4,6-trimethylanilido) ethoxymethyl(η⁵-2,3,4,6,7-pentamethylindenyl)silanetitanium (IV) dimethyl; (2,4,6-trimethylanilido)ethoxymethyl(η⁵-2,3,4,6,7-pentamethylindenyl)silane titanium (IV) dibenzyl; (1-adamantylamido)ethoxymethyl(η⁵-2,3,4,6,7-pentamethyl-indenyl)silanetitanium (II)1,4-diphenyl- 1,3-butadiene; (1-adamantylamido)ethoxymethyl(η⁵-2,3,4,6,7-pentamethylindenyl) silanetitanium (II) 1,3-pentadiene; (1-adamantylamido)ethoxymethyl(η⁵-2,3,4,6,7-pentamethyl indenyl)silanetitanium (III) 2-(N,N-dimethylamino)benzyl; (1-adamantylamido) ethoxymethyl(η⁵-2,3,4,6,7-pentamethylindenyl) silanetitanium (IV) dimethyl; and (1-adamantylamido)ethoxymethyl(η⁵-2,3,4,6,7-pentamethylindenyl)silanetitanium (IV) dibenzyl.

Methods for preparing the aforementioned catalysts are described, for example, in U.S. Pat. No. 6,015,868. In some embodiments, the following catalysts are used: 1) (N-1,1-dimethylethyl)-1,1-(4-methylphenyl)-1-((1,2,3,3a,7a-n)-3-(1,3-dihydro-2H-isoindol-2-yl)-1H-inden-1-yl)silanaminato-(2-)-N-)dimethyltitanium; and 2) (N-1,1-dimethylethyl)-1,1-(4-butylphenyl)-1-((1,2,3,3a,7a-n)-3-( 1,3-dihydro-2H-isoindol-2-yl)- 1H-inden-1-yl) silanaminato-(2-)-N-) dimethyltitanium.

Cocatalysts

The above-described catalysts may be rendered catalytically active by combination with an activating cocatalyst or by use of an activating technique. Suitable activating cocatalysts for use herein include, but are not limited to, polymeric or oligomeric alumoxanes, especially methylalumoxane, triisobutyl aluminum modified methylalumoxane, or isobutylalumoxane; neutral Lewis acids, such as C₁₋₃₀ hydrocarbyl substituted Group 13 compounds, especially tri(hydrocarbyl)aluminum- or tri(hydrocarbyl)boron compounds and halogenated (including perhalogenated) derivatives thereof, having from 1 to 30 carbons in each hydrocarbyl or halogenated hydrocarbyl group, more especially perfluorinated tri(aryl)boron and perfluorinated tri(aryl)aluminum compounds, mixtures of fluoro- substituted(aryl)boron compounds with alkyl-containing aluminum compounds, especially mixtures of tris(pentafluorophenyl)borane with trialkylaluminum or mixtures of trispentafluorophenyl)borane with alkylalumoxanes, more especially mixtures of tris(pentafluorophenyl)borane with methylalumoxane and mixtures of tris(pentafluorophenyl)borane with methylalumoxane modified with a percentage of higher alkyl groups (MMAO), and most especially tris(pentafluorophenyl)borane and tris(pentafluorophenyl)aluminum; non-polymeric, compatible, non-coordinating, ion forming - compounds (including the use of such compounds under oxidizing conditions), especially the use of ammonium-, phosphonium-, oxonium-, carbonium-, silylium- or sulfonium- salts of compatible, non-coordinating anions, or ferroceniumh salts of compatible, non-coordinating anions; bulk electrolysis and combinations of the foregoing activating cocatalysts and techniques. The foregoing activating cocatalysts and activating techniques have been previously taught with respect to different metal complexes in the following references: EP-A-277,003, US-A-5,153,157, US-A-5,064,802, EP-A-468,651 (equivalent to U.S. Ser. No. 07/547,718), EP-A-520,732 (equivalent to U.S. Ser. No. 07/876,268), and EP-A-520,732 (equivalent to U.S. Ser. Nos. 07/884,966 filed May 1, 1992). The disclosures of the all of the preceding patents or patent applications are incorporated by reference herein in their entirety.

Combinations of neutral Lewis acids, especially the combination of a trialkyl aluminum compound having from 1 to 4 carbons in each alkyl group and a halogenated tri(hydrocarbyl)boron compound having from 1 to 20 carbons in each hydrocarbyl group, especially tris(pentafluorophenyl)borane, further combinations of such neutral Lewis acid mixtures with a polymeric or oligomeric alumoxane, and combinations of a single neutral Lewis acid, especially tris(pentafluorophenyl)borane with a polymeric or oligomeric alumoxane are especially desirable activating cocatalysts. It has been observed that the most efficient catalyst activation using such a combination of tris(pentafluoro- phenyl)borane/alumoxane mixture occurs at reduced levels of alumoxane. Preferred molar ratios of Group 4 metal complex:tris(pentafluoro-phenylborane:alumoxane are from 1:1:1 to 1:5:10, more preferably from 1:1:1 to 1:3:5. Such efficient use of lower levels of alumoxane allows for the production of olefin polymers with high catalytic efficiencies using less of the expensive alumoxane cocatalyst. Additionally, polymers with lower levels of aluminum residue, and hence greater clarity, are obtained.

Suitable ion forming compounds useful as cocatalysts in some embodiments of the invention comprise a cation which is a Bronsted acid capable of donating a proton, and a compatible, non-coordinating anion, A-. As used herein, the term “non-coordinating” means an anion or substance which either does not coordinate to the Group 4 metal containing precursor complex and the catalytic derivative derived therefrom, or which is only -weakly coordinated to such complexes thereby remaining sufficiently labile to be displaced ; by a neutral Lewis base. A non-coordinating anion specifically refers to an anion which, when functioning as a charge balancing anion in a cationic metal complex, does not transfer an anionic substituent or fragment thereof to the cation thereby forming neutral complexes during the time which would substantially interfere with the intended use of the cationic metal complex as a catalyst.. “Compatible anions” are anions which are not degraded to neutrality when the initially formed complex decomposes and are non-interfering with desired subsequent polymerization or other uses of the complex.

Preferred anions are those containing a single coordination complex comprising a charge-bearing metal or metalloid core which anion is capable of balancing the charge of the active catalyst species (the metal cation) which may be formed when the two components are combined. Also, the anion should be sufficiently labile to be displaced by olefinic, diolefinic and acetylenically unsaturated compounds or other neutral Lewis bases such as ethers or nitrites. Suitable metals include, but are not limited to, aluminum, gold and platinum. Suitable metalloids include, but are not limited to, boron, phosphorus, and silicon. Compounds containing anions which comprise coordination complexes containing a single metal or metalloid atom are, of course, known in the art and many, particularly such compounds containing a single boron atom in the anion portion, are available commercially.

Preferably such cocatalysts may be represented by the following general formula:

(L*-H)⁺(A)^{d-}

Formula VII

wherein L* is a neutral Lewis base; (L*-H)+is a Bronsted acid; A^{d-}is an anion having a charge of d−, and d is an integer from 1 to 3. More preferably A^{d-}corresponds to the formula: [M′Q₄]⁻, wherein M′ is boron or aluminum in the +3 formal oxidation state; and Q independently each occurrence is selected from hydride, dialkylamido, halide, hydrocarbyl, hydrocarbyloxide, halosubstituted-hydrocarbyl, halosubstituted hydrocarbyloxy, and halo-substituted silylhydrocarbyl radicals (including perhalogenated hydrocarbyl- perhalogenated hydrocarbyloxy- and perhalogenated silylhydrocarbyl radicals), the Q having up to 20 carbons with the proviso that in not more than one occurrence is Q halide. Examples of suitable hydrocarbyloxide Q groups are disclosed in U.S. Pat. No. 5,296,433.

In a more preferred embodiment, d is one, that is, the counter ion has a single v negative charge and is A⁻. Activating cocatalysts comprising boron which are particularly useful in the preparation of catalysts of this invention may be represented by the following general formula:

(L*-H)+(M′Q₄)⁻

Formula VIII

wherein L* is as previously defined; M′ is boron or aluminum in a formal oxidation state of 3; and Q is a hydrocarbyl-, hydrocarbyloxy-, fluorinated hydrocarbyl-, fluorinated hydrocarbyloxy-, or fluorinated silylhydrocarbyl- group of up to 20 non-hydrogen atoms, with the proviso that in not more than one occasion is Q hydrocarbyl. Most preferably, Q in each occurrence is a fluorinated aryl group, especially a pentafluorophenyl group. Preferred (L*-H)+cations are N,N-dimethylanilinium, N,N-di(octadecyl)anilinium, di(octadecyl)methylammonium, methylbis(hydrogenated tallowyl)ammonium, and tributylammonium.

Illustrative, but not limiting, examples of boron compounds which may be used as an activating cocatalyst are tri-substituted ammonium salts such as: trimethylammonium tetrakis(pentafluorophenyl) borate; triethylammonium tetrakis(pentafluorophenyl) borate; tripropylammonium tetrakis (pentafluorophenyl) borate; tri(n-butyl)ammonium tetrakis(pentafluorophenyl) borate; tri(sec-butyl)ammonium tetrakis(pentafluorophenyl) borate; N,N-dimethylanilinium tetrakis (pentafluorophenyl) borate; N,N-dimethylanilinium n-butyltris(pentafluorophenyl) borate; N,N-dimethylanilinium benzyltris(pentafluorophenyl) borate; N,N-dimethylanilinium tetrakis(4-(t-butyldimethylsilyl)-2, 3, 5, 6-tetrafluorophenyl) borate; N,N-dimethylanilinium tetrakis(4-(triisopropylsilyl)-2, 3, 5, 6-tetrafluorophenyl) borate; N,N-dimethylanilinium pentafluoro phenoxytris(pentafluorophenyl) borate; N,N-diethylanilinium tetrakis(pentafluorophenyl) borate; N,N-dimethyl-2,4,6-trimethylanilinium tetrakis(pentafluorophenyl) borate; trimethylammonium tetrakis(2,3,4,6-tetrafluorophenyl)borate; triethylammonium tetrakis(2,3,4,6-tetrafluorophenyl) borate; tripropylammonium tetrakis(2,3,4,6-tetrafluorophenyl) borate; tri(n-butyl)ammonium tetrakis(2,3,4,6-tetrafluorophenyl) borate, dimethyl(t-butyl)ammonium tetrakis(2,3,4,6-tetra fluorophenyl) borate; N,N-dimethylanilinium tetrakis(2,3,4,6-tetrafluorophenyl) borate; N,N-diethylanilinium tetrakis (2,3,4,6-tetrafluorophenyl) borate; and N,N-dimethyl-2,4,6-trimethylanilinium tetrakis(2,3,4,6-tetrafluorophenyl) borate; dialkyl ammonium salts such as: di-(i-propyl)ammonium tetrakis(pentafluorophenyl) borate, and dicyclohexylammonium tetrakis(pentafluorophenyl) borate; tri-substituted phosphonium salts such as: triphenylphosphonium tetrakis (pentafluorophenyl) borate, tri(o-tolyl)phosphonium tetrakis(pentafluorophenyl) borate, and tri(2,6-dimethylphenyl)phosphonium tetrakis(pentafluorophenyl) borate; di-substituted oxonium salts such as: diphenyloxonium tetrakis(pentafluorophenyl) borate, di(o-tolyl)oxonium tetrakis (pentafluorophenyl) borate, and di(2,6-dimethylphenyl)oxonium tetrakis(pentafluorophenyl) borate; di-substituted sulfonium salts such as: diphenylsulfonium tetrakis(pentafluorophenyl) borate, di(o-tolyl)sulfonium tetrakis(pentafluorophenyl) borate, and bis(2,6-dimethylphenyl) sulfonium tetrakis(pentafluorophenyl) borate.

Another suitable ion forming, activating cocatalyst comprises a salt of a cationic oxidizing agent and a non-coordinating, compatible anion represented by the formula:

(Ox^{e+})_{d}(A^{d-})ₑ

Formula IX wherein: Ox^{e+}is a cationic oxidizing agent having a charge of e+; e is an integer from 1 to 3; and A^{d-}and d are as previously defined.

Examples of cationic oxidizing agents include, but are not limited to, ferrocenium, hydrocarbyl-substituted ferrocenium, Ag+, or Pb⁺². Preferred embodiments of A^{d-}are those anions previously defined with respect to the Bronsted acid containing activating cocatalysts, especially tetrakis(pentafluorophenyl)borate.

Another suitable ion forming, activating cocatalyst comprises a compound which is a salt of a carbenium ion and a non-coordinating, compatible anion represented by the formula: \mathring{c}⁺A⁻, wherein \mathring{c}+is a C₁₋₂₀ carbenium ion; and A is as previously defined. A preferred carbenium ion is the trityl cation, that is triphenylmethylium.

A further suitable ion forming, activating cocatalyst comprises a compound which is a salt of a silylium ion and a non-coordinating, compatible anion represented by the formula:

R₃Si(X′)_{q}⁺A⁻

Formula X

wherein: R is C₁₋₁₀ hydrocarbyl, and X′, q and A⁻are as previously defined.

Preferred silylium salt activating cocatalysts include, but are not limited to, trimethylsilylium tetrakispentafluorophenylborate, triethylsilylium tetrakispentafluoro- phenylborate and ether substituted adducts thereof. Silylium salts have been previously generically disclosed in J. Chem. Soc. Chem. Comm., 1993, 383-384, as well as Lambert, J. B., et al., Organometallics, 1994, 13, 2430-2443. The use of the above silylium salts as activating cocatalysts for addition polymerization catalysts is disclosed in U.S. Pat. No. 5,625,087, which is incorporated by reference herein in its entirety. Certain complexes of alcohols, mercaptans, silanols, and oximes with tris(pentafluorophenyl)borane are also effective catalyst activators and may be used in embodiments of the invention. Such cocatalysts are disclosed in U.S. Pat. No. 5,296,433, which is also incorporated by reference herein in its entirety.

Another class of suitable catalyst activators are expanded anionic compounds corresponding to the formula:

(A¹₊ₐ¹)_{b}¹(Z¹J¹j¹)^{-c1}_{d}¹,

wherein: A¹ is a cation of charge +a¹, Z¹ is an anion group of from 1 to 50, preferably 1 to 30 atoms, not counting hydrogen atoms, further containing two or more Lewis base sites; J¹ independently each occurrence is a Lewis acid coordinated to at least one Lewis base site of Z¹, and optionally two or more such J¹ groups may be joined together in a moiety having multiple Lewis acidic functionality, j¹ is a number from 2 to 12 and a¹, b¹, c¹, and d¹are integers from 1 to 3, with the proviso that a¹×b¹ is equal to c¹×d¹.

The foregoing cocatalysts (illustrated by those having imidazolide, substituted imidazolide, imidazolinide, substituted imidazolinide, benzimidazolide, or substituted benzimidazolide anions) may be depicted schematically as follows:

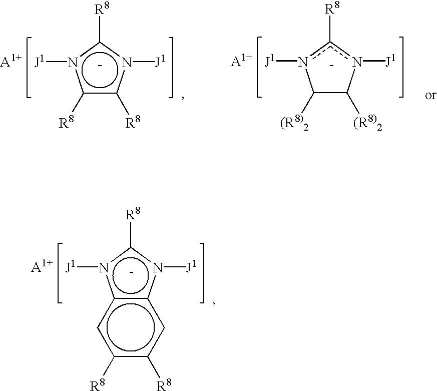

wherein: A¹⁺is a monovalent cation as previously defined, and preferably is a trihydrocarbyl ammonium cation, containing one or two C₁₀₋₄₀ alkyl groups, especially the methylbis(tetradecyl)ammonium- or methylbis(octadecyl)ammonium- cation, R⁸, independently each occurrence, is hydrogen or a halo, hydrocarbyl, halocarbyl, halohydrocarbyl, silylhydrocarbyl, or silyl, (including mono-, di- and tri(hydrocarbyl)silyl) group of up to 30 atoms not counting hydrogen, preferably C₁₋₂₀ alkyl, and J¹ is tris(pentafluorophenyl)borane or tris(pentafluorophenyl)aluminane.

Examples of these catalyst activators include the trihydrocarbylammonium-, especially, methylbis(tetradecyl)ammonium- or methylbis(octadecyl)ammonium- salts of: bis(tris(pentafluorophenyl)borane)imidazolide, bis(tris(pentafluorophenyl)borane)-2-undecylimidazolide, bis(tris(pentafluorophenyl)borane)-2-heptadecylimidazolide, bis(tris(pentafluorophenyl)borane)-4,5-bis(undecyl)imidazolide, bis(tris(pentafluorophenyl)borane)-4,5-bis(heptadecyl)imidazolide, bis(tris(pentafluorophenyl)borane)imidazolinide, bis(tris(pentafluorophenyl)borane)-2-undecylimidazolinide, bis(tris(pentafluorophenyl)borane)-2-heptadecylimidazolinide, bis(tris(pentafluorophenyl)borane)-4,5-bis(undecyl)imidazolinide, bis(tris(pentafluorophenyl)borane)-4,5-bis(heptadecyl)imidazolinide, bis(tris(pentafluorophenyl)borane)-5,6-dimethylbenzimidazolide, bis(tris(pentafluorophenyl)borane)-5,6-bis(undecyl)benzimidazolide, bis(tris(pentafluorophenyl)alumane)imidazolide, bis(tris(pentafluorophenyl)alumane)-2-undecylimidazolide, bis(tris(pentafluorophenyl)alumane)-2-heptadecylimidazolide, bis(tris(pentafluorophenyl)alumane)-4,5-bis(undecyl)imidazolide, bis(tris(pentafluorophenyl)alumane)-4,5-bis(heptadecyl)imidazolide, bis(tris(pentafluorophenyl)alumane)imidazolinide, bis(tris(pentafluorophenyl)alumane)-2-undecylimidazolinide, bis(tris(pentafluorophenyl)alumane)-2-heptadecylimidazolinide, bis(tris(pentafluorophenyl)alumane)-4,5-bis(undecyl)imidazolinide, bis(tris(pentafluorophenyl)alumane)-4,5 -bis(heptadecyl)imidazolinide, bis(tris(pentafluorophenyl)alumane)-5,6-dimethylbenzimidazolide, and bis(tris(pentafluorophenyl)alumane)-5,6-bis(undecyl)benzimidazolide.

A further class of suitable activating cocatalysts include cationic Group 13 salts corresponding to the formula:

[M″Q¹₂L′₁,]⁺(Ar^{f}₃M′Q²)⁻

wherein: M″ is aluminum, gallium, or indium; M′ is boron or aluminum; Q¹ is C₁₋₂₀ hydrocarbyl, optionally substituted with one or more groups which independently each occurrence are hydrocarbyloxy, hydrocarbylsiloxy, hydrocarbylsilylamino, di(hydrocarbylsilyl)aamino, hydrocarbylamino, di(hydrocarbyl)amino, di(hydrocarbyl)phosphino, or hydrocarbylsulfido groups having from 1 to 20 atoms other than hydrogen, or, optionally, two or more Q¹ groups may be covalently linked with each other to form one or more fused rings or ring systems; Q² is an alkyl group, optionally substituted with one or more cycloalkyl or aryl groups, said Q² having from 1 to 30 carbons; L′ is a monodentate or polydentate Lewis base, preferably L′ is reversibly coordinated to the metal complex such that it may be displaced by an olefin monomer, more preferably L′ is a monodentate Lewis base; 1′is a number greater than zero indicating the number of Lewis base moieties, L′, and Ar^{f} independently each occurrence is an anionic ligand group; preferably Ar^{f} is selected from the group consisting of halide, C₁₋₂₀ halohydrocarbyl, and Q¹ ligand groups, more preferably Ar^{f} is a fluorinated hydrocarbyl moiety of from 1 to 30 carbon atoms, most preferably Ar^{f} is a fluorinated aromatic hydrocarbyl moiety of from 6 to 30 carbon atoms, and most highly preferably Ar^{f} is a perfluorinated aromatic hydrocarbyl moiety of from 6 to 30 carbon atoms.

Examples of the foregoing Group 13 metal salts are alumicinium tris(fluoroaryl)borates or gallicinium tris(fluoroaryl)borates corresponding to the formula:

[M″Q¹₂L′₁]⁺(Ar^{f}₃BQ²)⁻

wherein M″ is aluminum or gallium; Q¹ is C₁₋₂₀ hydrocarbyl, preferably C₁₋₈ alkyl; Ar^{f} is perfluoroaryl, preferably pentafluorophenyl; and Q² is C₁₋₈ alkyl, preferably C₁₋₈ alkyl. More preferably, Q¹ and Q² are identical C₁₋₈ alkyl groups, most preferably, methyl, ethyl or octyl.

The foregoing activating cocatalysts may also be used in combination. An especially preferred combination is a mixture of a tri(hydrocarbyl)aluminum or tri(hydrocarbyl)borane compound having from 1 to 4 carbons in each hydrocarbyl group or an ammonium borate with an oligomeric or polymeric alumoxane compound.

Polymerization Process

The molar ratio of catalyst/cocatalyst employed preferably ranges from 1:10,000 to 100:1, more preferably from 1:5000 to 10:1, most preferably from 1:1000 to 1:1. Alumoxane, when used by itself as an activating cocatalyst, is generally employed in large quantity, generally at least 100 times the quantity of metal complex on a molar basis. Tris(pentafluorophenyl)borane and tris(pentafluorophenyl) aluminum, where used as an activating cocatalyst are preferably employed in a molar ratio to the metal complex of from 0.5:1 to 10:1, more preferably from 1:1 to 6:1 most preferably from 1:1 to 5:1. The remaining activating cocatalysts are generally employed in approximately equimolar quantity with the metal complex.

In general, the polymerization may be accomplished at conditions known in the art for Ziegler-Natta or Kaminsky-Sinn type polymerization reactions, that is, temperatures from −50 to 250° C., preferably 30 to 200° C. and pressures from atmospheric to 10,000 atmospheres. Suspension, solution, slurry, gas phase, solid state powder polymerization or other process condition may be employed if desired. A support, especially silica, alumina, or a polymer (especially polytetrafluoroethylene or a polyolefin) may be employed, and desirably is employed when the catalysts are used in a gas phase or slurry polymerization process. Preferably, the support is passivated before the addition of the catalyst. Passivation techniques are known in the art, and include treatment of the support with a passivating agent such as triethylaluminum. The support is preferably employed in an amount to provide a weight ratio of catalyst (based on metal):support from about 1:100,000 to about 1:10, more preferably from about 1:50,000 to about 1:20, and most preferably from about 1:10,000 to about 1:30. In most polymerization reactions, the molar ratio of catalyst:polymerizable compounds employed preferably is from about 10⁻¹²:1 to about 10⁻¹:1, more preferably from about 10⁻⁹:1 to about 10⁻⁵:1.

Suitable solvents for polymerization are generally inert liquids. Examples include, but are not limited to, straight and branched-chain hydrocarbons such as isobutane, butane, pentane, hexane, heptane, octane, and mixtures thereof; mixed aliphatic hydrocarbon solvents such as kerosene and ISOPAR (available from Exxon Chemicals), cyclic and alicyclic hydrocarbons such as cyclohexane, cycloheptane, methylcyclohexane, methylcycloheptane, and mixtures thereof; perfluorinated hydrocarbons such as perfluorinated C₄₋₁₀ alkanes, and the like, and aromatic and alkyl-substituted aromatic compounds such as benzene, toluene, xylene, ethylbenzene and the like.

Suitable solvents also include, but are not limited to, liquid olefins which may act as monomers or comonomers including ethylene, propylene, butadiene, cyclopentene, 1-hexene, 1-hexane, 4-vinylcyclohexene, vinylcyclohexane, 3-methyl-i-pentene, 4-methyl-1-pentene, 1,4-hexadiene, 1-octene, 1-decene, styrene, divinylbenzene, allylbenzene, vinyltoluene (including all isomers alone or in admixture), and the like. Mixtures of the foregoing are also suitable.

The catalysts may be utilized in combination with at least one additional homogeneous or heterogeneous polymerization catalyst in separate reactors connected in series or in parallel to prepare polymer blends having desirable properties. An example of such a process is disclosed in WO 94/00500, equivalent to U.S. Ser. No. 07/904,770, as well as U.S. Ser. No. 08/10958, filed Jan. 29, 1993. The disclosures of the patent applications are incorporated by references herein in their entirety.

The catalyst system may be prepared as a homogeneous catalyst by addition of the requisite components to a solvent in which polymerization will be carried out by solution polymerization procedures. The catalyst system may also be prepared and employed as a heterogeneous catalyst by adsorbing the requisite components on a catalyst support material such as silica gel, alumina or other suitable inorganic support material. When prepared in heterogeneous or supported form, it is preferred to use silica as the support material. The heterogeneous form of the catalyst system may be employed in a slurry polymerization. As a practical limitation, slurry polymerization takes place in liquid diluents in which the polymer product is substantially insoluble. Preferably, the diluent for slurry polymerization is one or more hydrocarbons with less than 5 carbon atoms. If desired, saturated hydrocarbons such as ethane, propane or butane may be used in whole or part as the diluent. Likewise the a-olefin monomer or a mixture of different a-olefin monomers may be used in whole or part as the diluent. Most preferably, the major part of the diluent comprises at least the a-olefin monomer or monomers to be polymerized.

Solution polymerization conditions utilize a solvent for the respective components of the reaction. Preferred solvents include, but are not limited to, mineral oils and the various hydrocarbons which are liquid at reaction temperatures and pressures. Illustrative examples of useful solvents include, but are not limited to, alkanes such as pentane, iso-pentane, hexane, heptane, octane and nonane, as well as mixtures of alkanes including kerosene and Isopar E™, available from Exxon Chemicals Inc.; cycloalkanes such as cyclopentane, cyclohexane, and methylcyclohexane; and aromatics such as benzene, toluene, xylenes, ethylbenzene and diethylbenzene.

At all times, the individual ingredients, as well as the catalyst components, should be protected from oxygen and moisture. Therefore, the catalyst components and catalysts should be prepared and recovered in an oxygen and moisture free atmosphere. Preferably, therefore, the reactions are performed in the presence of a dry, inert gas such as, for example, nitrogen or argon.

The polymerization may be carried out as a batch or a continuous polymerization process. A continuous process is preferred, in which event catalysts, solvent or diluent (if employed), and comonomers (or monomer) are continuously supplied to the reaction zone and polymer product continuously removed therefrom. The polymerization conditions for manufacturing the interpolymers according to embodiments of the invention are generally those useful in the solution polymerization process, although the application is not limited thereto. Gas phase and slurry polymerization processes are also believed to be useful, provided the proper catalysts and polymerization conditions are employed.

In some embodiments, the polymerization is conducted in a continuous solution polymerization system comprising two reactors connected in series or parallel. One or both reactors contain at least one catalyst with a function monomer added as desired. In one reactor, a relatively high molecular weight product (M_{w} from 100,000 to over 100,000,000, more preferably 200,000 to 500,000) is formed while in the second reactor a product of a relatively low molecular weight (M_{w} 2,000 to 300,000) is formed. The final product is a mixture of the two reactor effluents which are combined prior to devolatilization to result in a uniform mixing of the two polymer products. Such a dual reactor/dual catalyst process allows for the preparation of products with tailored properties. In one embodiment, the reactors are connected in series, that is the effluent from the first reactor is charged to the second reactor and fresh monomer, solvent and hydrogen is added to the second reactor. Reactor conditions are adjusted such that the weight ratio of polymer produced in the first reactor to that produced in the second reactor is from 20:80 to 80:20. In addition, the temperature of the second reactor is controlled to produce the lower molecular weight product. In one embodiment, the second reactor in a series polymerization process contains a heterogeneous Ziegler-Natta catalyst or chrome catalyst known in the art. Examples of Ziegler-Natta catalysts include, but are not limited to, titanium-based catalysts supported on MgCl₂, and additionally comprise compounds of aluminum containing at least one aluminum-alkyl bond. Suitable Ziegler-Natta catalysts and their preparation include, but are not limited to, those disclosed in U.S. Pat. No. 4,612,300, U.S. Pat. No. 4,330,646, and U.S. Pat. No. 5,869,575. The disclosures of each of these three patents are herein incorporated by reference.

The process described herein may be useful in the preparation of EP and EPDM copolymers in high yield and productivity. The process employed may be either a solution or slurry process both of which are previously known in the art. Kaminsky, J. Poly. Sci., Vol.23, pp. 2151-64 (1985) reported the use of a soluble bis(cyclopentadienyl) zirconium dimethyl-alumoxane catalyst system for solution polymerization of EP and EPDM elastomers. U.S. Pat. No. 5,229,478 discloses a slurry polymerization process utilizing similar bis(cyclopentadienyl) zirconium based catalyst systems.

The following procedure may be carried out to obtain an EPDM polymer: in a stirred-tank reactor propylene monomer is introduced continuously together with solvent, diene monomer and ethylene monomer. The reactor contains a liquid phase composed substantially of ethylene, propylene and diene monomers together with any solvent or additional diluent. If desired, a small amount of a “H”-branch inducing diene such as norbornadiene, 1,7-octadiene or 1,9-decadiene may also be added. At least one catalyst and suitable cocatalyst(s) are continuously introduced in the reactor liquid phase. A fimctional monomer is added as desired. The reactor temperature and pressure may be controlled by adjusting the solvent/monomer ratio, the catalyst addition rate, as well as by cooling or heating coils, jackets or both. The polymerization rate is controlled by the rate of catalyst addition. The ethylene content of the polymer product is determined by the ratio of ethylene to propylene in the reactor, which is controlled by manipulating the respective feed rates of these components to the reactor. The molecular weight of the polymer product is controlled, optionally, by controlling other polymerization variables such as the temperature, monomer concentration, or by a stream of hydrogen introduced to the reactor, as is known in the art. The reactor effluent is contacted with a catalyst kill agent, such as water. The polymer solution is optionally heated, and the polymer product is recovered by flashing off unreacted gaseous ethylene and propylene as well as residual solvent or diluent at reduced pressure, and, if necessary, conducting further devolatilization in equipment such as a devolatilizing extruder or other devolatilizing equipment operated at reduced pressure. In a continuous process, the mean residence-time of the catalyst and polymer in the reactor generally is from 5 minutes to 8 hours, and preferably from 10 minutes to 6 hours, more preferably from 10 minutes to 1 hour.

As described above, the use of the FM is not process limited and can be employed in solution, slurry, or gas phase polymerizations. The polymerizations can be conducted under conditions where the catalyst and/or the polymer is soluble in the reaction medium, or under conditions where the resulting polymer is not soluble in the continuous phase (slurry). The slurry polymerization can be conducted in a non-reactive media (either organic or inorganic in nature), or the continues phase can be conducted in bulk monomer where the resulting polymer is not soluble, e.g. propylene. The continuous phase in the slurry polymerizations may optionally be liquid or in the supercritical state, provided that the FM has a sufficiently low vapor pressure, under the appropriate reaction conditions, the polymerization can be conducted in the gas phase where the catalyst is attached to a solid support, to which the growing polymer is physically bound.

The monomers which can be polymerized in the presence of the FM are those that are known in the art to be capable of undergoing coordination polymerization in the presence of a Ziegler-Natta catalyst or single site catalyst (either early or late transition metal based). Such monomers include, but are not limited to, ethylene, propylene, styrene, methyl acrylate (and other acrylic monomers), as well as higher alpha-olefins; these monomers can be either homopolymerized or copolymerized in the presence of one or more additional monomers.

The formed polymers/macromonomers can be either amorphous or semi-crystalline polymers. Amorphous polymers include, but are not limited to, LLDPE, atactic polypropylene, ethylene/propylene rubbers, high styrene content ethylene/styrene copolymers, etc. Semi-crystalline polymers include, but are not limited to, substantially isotactic polypropylene, substantially syndiotactic polypropylene, substantially syndiotactic polystyrene, LLDPE, HDPE, MDPE, etc. Additionally, the resulting polymers/macromonomers may contain a mixture of substantially semi-crystalline and substantially amorphous segments.

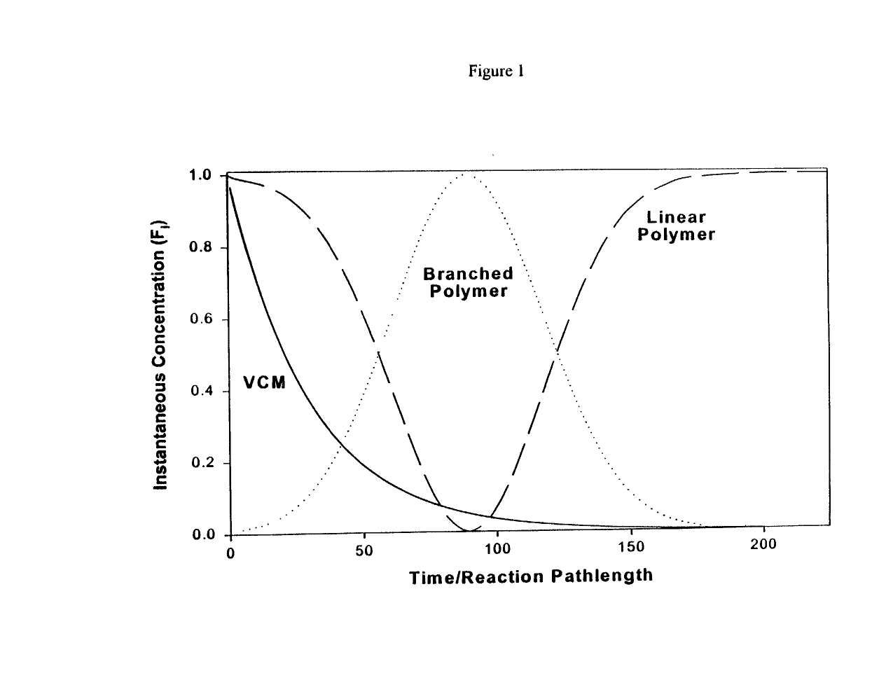

It is an embodiment of this invention that by variation of the reaction conditions, it is possible to control the composition and/or architecture of the polymer. The degree of branching in the molecule can be attenuated or controlled by variation of the reaction or residence time in a reactor. Initially, there is no macromonomer present when the FM and the monomer(s) are contacted with the catalyst. As the reaction progresses and the FM is consumed the concentration of the formed macromonomer is increased. Thus at lower conversions, substantially linear macromonomers will be formed. If the reaction is allowed to continue, then the macromonomers will be incorporated into the growing polymer chain, resulting in the formation of a branch point. Additionally, if all monomer and/or FM is consumed, a relatively high concentration of macromonomer will remain. The catalyst will then begin to polymerize the macromonomer, and any remaining lower molecular weight monomer, forming a highly branched polymer. This is schematically illustrated in FIG. 1 for one such embodiment of the invention.

Homopolymerization, or copolymerization with relatively low concentrations of comonomer, of the FM will result in the formation of vinyl terminated species, which as these are polymerized will themselves be terminated by reaction with the FM to yield, higher molecular weight, vinyl terminated structures. As these can also be incorporated by the catalyst into a polymer chain and then reaction with FM, branches upon branches can be introduced to the polymer architecture. In essence, a hyperbranched polymer will be formed. It is a preferred embodiment that for the formation of hyperbranched polymers, the concentration of the FM be greater than, or equal to, 10 mol % of the polymerizable monomers, even more preferred is that the concentration be greater 25 mol %, and most preferred is that the concentration of FM be greater than 50 mol % of the polymerizable monomers.

It is a fuirther embodiment of the invention that the FM concentration can be very low, so as that other chain termination reactions, e.g., beta-hydride elimination, may compete with the FM being incorporated by the catalyst into the growing polymer. The result is a mixture of polymers with and without vinyl terminated chain ends. Such a result is useful if the desired polymer material should have only a spare number of branched chains, with those chains being of high molecular weight. In a similar fashion, chain transfer agents, such as, but not limited to, hydrogen, can be added to the reaction so as to compete with FM in reacting with the catalyst of the growing polymer chain, thus leading to mixtures of saturated and vinyl terminated chain ends. The relative proportion of the two will be dependent on the concentration of the FM and/or hydrogen, as well as their relative reactivity to the catalyst at the growing polymer chain end. Thus is it further possible to attenuate the relative amount of branched polymer chains.

Removal of the FM from the reaction, either by isolation of the macromonomer and recontacting with monomer or by simple evaporation of the FM, followed by continued polymerization by the catalyst in the presence of macromonomer and monomer will result in the formation of graft copolymers, where the monomer will comprise the backbone and the macromonomer will comprise the side chains. By attenuating the relative concentration of the macromonomer to monomer, the amount of branching in the polymeric material can be controlled and/or varied. Such graft copolymers may contain varied compositions, where the backbone is of differing composition than the side chains; these may be different amorphous, or semi-crystalline, or a combination of the two, polymer compositions.

As a further embodiment, the control of the concentration of FM in a continuous process can allow for the preparation of unique polymeric materials through the generation of a compositional gradient in a reactor or a series of reactors. For example, but not limited to, in a plug-flow type reactor, i.e., horizontal gas phase, solution or slurry flow reactors, FM can be added at a single point, or various points, along the reaction pathway. In an example, but not meant to be limiting, FM and a monomer are added and the head of the plug-flow reactor, with only monomer being continuously fed to the reaction along the length of the reaction pathway. Initially, the concentration of the FM is high, but will gradually decrease along the reaction path length as illustrated in FIG. 1. As the concentration of the FM is decreasing until its concentration is below detectable limits, the concentration of macromonomer will increase leading to the formation of branched polymer. After a period of time the concentration of the macromonomer will be such that a significant proportion of the formed polymer chains will incorporate at least one branch. Eventually, the concentration of the macromonomer will be sufficiently reduced by incorporation into the growing chains until such a point where substantially linear polymer chains are formed by the reaction between catalyst and monomer. Such a distribution of topologies in the final material are expected to provide for unique physical/mechanical/rheological properties of the bulk material. By changing the point of addition or using multiple addition points for the FM, the shape and distribution of the curves can be varied, e.g., FM added in the middle of the reaction pathway to yield linear polymer at first, and branched polymer later in the reaction pathway; there is no limit to the diversity of profiles that can be prepared. Additionally, various comonomers and transfer agents can be added at various points along the reaction pathway so as to provide for even more variation in the polymeric material, i.e., composition (amorphous, semi-crystalline, comonomers) and chain length (hydrogen, chain transfer agents).

The composition of the polymer chains formed with vinyl end groups by reaction with the FM can be varied by use of any suitable copolymerization technique. For example, but not limited to, semi-crystalline polymers of ethylene or propylene (and their copolymers), as well as syndiotactic polystyrene can be formed using known catalysts for their polymerization. Additionally, amorphous polymers can be prepared by copolymerization of ethylene or propylene with higher alpha-olefins or copolymers of ethylene and styrene, as well as atactic polyolefins, i.e., polypropylene. As either amorphous or semi-crystalline polymers can be prepared with vinyl end groups, it follows that branched polymers of these compositions can be readily formed by copolymerization of FM with one or more desired monomers. Preferable compositions include homopolymers of ethylene, propylene, higher alpha-olefins, and styrene. Other preferable compositions include copolymers of ethylene with olefins (styrene, propylene, butene, pentene, hexene, heptene, 4-methyl-1-pentene, octene, or decene), propylene with olefins (ethylene, butene, pentene, hexene, heptene, 4-methyl-1-pentene, octene, or decene). The density of the polyolefin materials can be chose from the range of 0.845 g/cc to 0.985 g/cc.

The degree of polymerization of the prepared macromonomers and polymers prepared by reaction with said macromonomers of the present invention are of at least three, preferably at least 5 and more preferably at least 10. The preferred number average molecular weights are of at least 50 g/mol, and may be up to 10,000,000 g/mol.

It is an embodiment of this invention that the macromonomers of desired composition (semi-crystalline, amorphous) can be further copolymerized with monomer(s) of similar or differing composition as those used to prepare the macromonomer. Combination of monomer(s) and macromonomer of similar composition will lead to branched structures which are expected to have novel Theological properties than completely linear analogs. Copolymerization of macromonomers with monomer(s) of differing composition will lead to polymers with unique physical/mechanical properties. For example, but not meant to be limiting, crystalline macromomers which are copolymerized with a monomer or monomers, which when polymerized in the absence of the macromonomer would lead to the formation of a polymer with a phase transition (either glass transition, T_{g}, or melt transition, Tₘ) at a lower temperature than the T_{g} or Tₘ of the macromonomer (whichever is highest), will lead to the formation of a polymer with a “soft” backbone and “hard,” pendent side chains. Such a polymer with hard and soft segments, is known in the art to behave as a thermoplastic elastomer, i.e., a rubber-like material. The side chains (macromonomers) need not be semi-crystalline but may be amorphous with phase transitions which occur at higher temperatures than the backbone polymer. Additionally, the side chains may be of such composition so as to be the “soft” segment, while the monomer(s) for the backbone will be the “hard” segment. Some exemplary compositions, but not meant to be limiting, include: poly((ethylene-co-octene)-g-ethylene), poly((ethylene-co-octene)-g-propylene), poly((ethylene-co-octene)-g-(ethylene-co-styrene)), poly((ethylene-co-styrene)-g-ethylene), poly((ethylene-co-styrene)-g-(ethylene-co-styrene)), poly((ethylene-co-propylene)-g-ethylene), poly((ethylene-co-propylene)-g-propylene), poly((ethylene-co-octene)-g-styrene), poly((ethylene-co-octene)-g-styrene), poly((ethylene-co-propylene)-g-styrene), poly((ethylene-co-propylene)-g-styrene) (the last four examples styrene may optionally be substantially syndiotactic), poly((a-propylene)-g-ethylene), poly((a-propylene)-g-propylene), poly((a-propylene)-g-(ethylene-co-styrene)), poly((a-propylene)-g-styrene), (in the last example styrene may optionally be substantially syndiotactic); where a-propylene indicates substantially atactic polypropylene.

It is a further embodiment that these grafted and/or branched structures can be used as rheological modifiers, blend compatiblizers, or thermoplastic elastomers.

Some polymers described herein have a high level of vinyl terminated chain ends. Such polymer have a backbone chain and a plurality of side chains and the polymer is characterized by a Rᵥ value of greater than about 0.85, wherein Rᵥ is defined as:

$${R}_{v} = \frac{[ vinyl ]}{[ vinyl ] + [ vinylidene ] + [ cis ] + [ trans ]}$$

wherein [vinyl] is the concentration of vinyl groups in the olefin polymer expressed in vinyls/l,000 carbon atoms; [vinylidene], [cis] and [trans] are the concentration of vinylidene, cis and trans unsaturations in the olefin polymer expressed in the number of the respective groups per 1,000 carbon atoms. Some polymers have an Rᵥ of about 0.90 or greater. In other polymers Rᵥ is 0.95 or greater. In some polymers, essentially all end groups are vinyl groups.

It is a further embodiment of the invention that the vinyl end group formed by reaction of the growing catalyst with the FM can be modified using chemistry known in the art to form other functional groups. Such groups, include, but are not limited to, halide, amine, azide, carboxylic acid (and its esters), epoxide, alcohol, silane, siloxane, boron, cyano, isocyanate, phosphonium, sulfate, and ammonium.

Further, the macromonomers may be reacted with each other using known acyclic diene metathesis (ADMET) chemistry (J. E. O'Gara, et al. Macromolecules, 26, 2831 (1993), which is incorporated by reference) to couple two vinyl terminated polymer chains, yielding a polymer with an internal alkene and ethylene which is evaporated from the reaction as it is a gas as illustrated in Scheme 2. Such a methodology can lead to the increase in the average molecular weight of polymeric material. Additionally, two or more macromonomers can be combined using ADMET to prepare block copolymers, where one segment is of differing composition from the other.

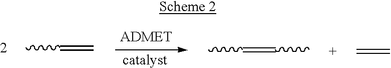

Applications

The polymers made in accordance with embodiments of the invention have many useful applications. For example, fabricated articles made from the polymers may be prepared using all of the conventional polyolefin processing techniques. Useful articles include films (e.g., cast, blown and extrusion coated), including multi-layer films, fibers (e.g., staple fibers) including use of an interpolymer disclosed herein as at least one component comprising at least a portion of the fiber's surface), spunbond fibers or melt blown fibers (using, e.g., systems as disclosed in U.S. Pat. No. 4,430,563, U.S. Pat. No. 4,663,220, U.S. Pat. No. 4,668,566, or U.S. Pat. No. 4,322,027, all of which are incorporated herein by reference), and gel spun fibers (e.g., the system disclosed in U.S. Pat. No. 4,413,110, incorporated herein by reference), both woven and nonwoven fabrics (e.g., spunlaced fabrics disclosed in U.S. Pat. No. 3,485,706, incorporated herein by reference) or structures made from such fibers (including, e.g., blends of these fibers with other fibers, e.g., PET or cotton) and molded articles (e.g., made using an injection molding process, a blow molding process or a rotomolding process). Monolayer and multilayer films may be made according to the film structures and fabrication methods described in U.S. Pat. No. 5,685,128, which is incorporated by reference herein in its entirety. The polymers described herein are also useful for wire and cable coating operations, as well as in sheet extrusion for vacuum forming operations.

Specific applications wherein the inventive polymers disclosed herein may be used include, but are not limited to, greenhouse films, shrink film, clarity shrink film, lamination film, extrusion coating, liners, clarity liners, overwrap film, agricultural film, high strength foam, soft foam, rigid foam, cross-linked foam, high strength foam for cushioning applications, sound insulation foam, blow molded bottles, wire and cable jacketing, including medium and high voltage cable jacketing, wire and cable insulation, especially medium and high voltage cable insulation, telecommunications cable jackets, optical fiber jackets, pipes, and frozen food packages. Some such uses are disclosed in U.S. Pat. No. 6,325,956, incorporated here by reference in its entirety. Additionally, the polymers disclosed herein may replace one or more of those used in the compositions and structures described in U.S. Pat. No. 6,270,856, U.S. Pat. No. 5,674,613, U.S. Pat. No. 5,462,807, U.S. Pat. No. 5,246,783, and U.S. Pat. No. 4,508,771, each of which is incorporated herein by reference in its entirety. The skilled artisan will appreciate other uses for the novel polymers and compositions disclosed herein.

Useful compositions are also suitably prepared comprising the polymers according to embodiments of the invention and at least one other natural or synthetic polymer. Preferred other polymers include, but are not limited to, thermoplastics, such as styrene-butadiene block copolymers, polystyrene (including high impact polystyrene), ethylene vinyl alcohol copolymers, ethylene acrylic acid copolymers, other olefin copolymers (especially polyethylene copolymers) and homopolymers (e.g., those made using conventional heterogeneous catalysts). Examples include polymers made by the process of U.S. Pat. No. 4,076,698, incorporated herein by reference, other linear or substantially linear polymers as described in U.S. Pat. No. 5,272,236, and mixtures thereof. Other substantially linear polymers and conventional HDPE and/or LDPE may also be used in the thermoplastic compositions.

### EXAMPLES

The following examples are given to illustrate various embodiments of the invention. They do not intend to limit the invention as otherwise described and claimed herein. All numerical values are approximate. When a numerical range is given, it should be understood that embodiments outside the range are still within the scope of the invention unless otherwise indicated. In the following examples, various polymers were characterized by a number of methods. Performance data of these polymers were also obtained. Most of the methods or tests were performed in accordance with an ASTM standard, if applicable, or known procedures.

Unless indicated otherwise, the following testing procedures are to be employed:

Density is to be measured in accordance with ASTM D-792. The samples are annealed at ambient conditions for 24 hours before the measurement is taken.

The molecular weight of polyolefin polymers is conveniently indicated using a melt index measurement according to ASTM D-1238, Condition 190° C./2.16 kg (formerly known as “Condition E” and also known as I₂). Melt index is inversely proportional to the molecular weight of the polymer. Thus, the higher the molecular weight, the lower the melt index, although the relationship is not linear. The overall I₂ melt index of the novel composition is in the range of from 0.01 to 1000 g/10 minutes. Some polymers have an I₂ value of about 1, about 2, about 5, about 7 or about 10 g/10 minutes. Others have an I₂ of about 15, about 20 or about 50 g/10 minutes. Of course, depending on the application, other polymers may have a melt index of about 100, about 200, about 300 or about 500 g/10 minutes.

Other measurements useful in characterizing the molecular weight of ethylene interpolymer compositions involve melt index determinations with higher weights, such as, -for common example, ASTM D-1238, Condition 190° C./10 kg (formerly known as “Condition N” and also known as I₁₀). The ratio of a higher weight melt index determination to a lower weight determination is known as a melt flow ratio, and for measured I₁₀ and the I₂ melt index values the melt flow ratio is conveniently designated as I₁₀I₂. Some polymers have melt flow ratio of about 5, about 7, about 8, or about 10. Others have melt flow ratio of about 15, about 20 or about 50.

Certain polymers are characterized by their thermal and mechanical properties. Differential Scanning Calorimetry (DSC) measurements were carried out on a TA (Dupont) DSC apparatus. Each sample was melted at 190° C. for 5 min., cooled at 10° C./min., and the conventional DSC endotherm was recorded by scanning from −60° C. to 190° C. at 10° C./min (i.e. the second heat). Dynamic mechanical properties of compression molded samples were monitored using a Rheometrics 800E mechanical spectrometer. Samples were run in solid state torsional rectangular geometry and purged under nitrogen to prevent thermal degradation. Generally, the sample was cooled to −100° C. and a strain of 0.05% was applied. Oscillation frequency was fixed at 10 rad/sec and the temperature was ramped in 5° C. increments.

Gel Permeation Chromatography (GPC) data were generated using either a Waters 150C/ALC, a Polymer Laboratories Model PL-210 or a Polymer Laboratories Model PL-220. The column and carousel compartments were operated at 140° C. The columns used were 3 Polymer Laboratories 10 micron Mixed-B columns. The samples were prepared at a concentration of 0.1 grams of polymer in 50 milliliters of 1,2,4 trichlorobenzene. The 1,2,4 trichlorobenzene used to prepare the samples contained 200 ppm of butylated hydroxytoluene (BHT). Samples were prepared by agitating lightly for 2 hours at 160°C. The injection volume used was 100 microliters and the flow rate was 1.0 milliliters/minute. Calibration of the GPC was performed with narrow molecular weight distribution polystyrene standards purchased from Polymer Laboratories. These polystyrene standard peak molecular weights were converted to polyethylene molecular weights using the following equation (as described in Williams and Ward, J. Polym. Sci., Polym. Let., 6, 621 (1968).:

M_{polyethylene}=A×(M_{polystyrene})^{B}

where M is the molecular weight, A has a value of 0.4316 and B is equal to 1.0. The molecular weight calculations were performed with the Viscotek TriSEC software.

The column and carousel compartments were operated at 140° C. The columns used were 3 Polymer Laboratories 10-micron Mixed-B columns. The solvent used was 1,2,4-trichlorobenzene. The samples were prepared at a concentration of 0.1 grams of polymer in 50 milliliters of solvent. The solvent used to prepare the samples contained 200 ppm of butylated hydroxytoluene (BHT). Samples were prepared by agitating lightly for 2 hours at 160° C. The injection volume used was 100 microliters and the flow rate was 1.0 milliliters/minute.

Calibration of the GPC column set was performed with narrow molecular weight distribution polystyrene standards purchased from Polymer Laboratories. The calibration of the detectors was performed in a manner traceable to NBS 1475 using a linear polyethylene homopolymer. ¹³C NMR was used to verify the linearity and composition of the homopolymer standard. The refractometer was calibrated for mass verification purposes based on the known concentration and injection volume. The viscometer was calibrated with NBS 1475 using a value of 1.01 deciliters/gram and the light scattering detector was calibrated using NBS 1475 using a molecular weight of 52,000 Daltons.

The Systematic Approach for the determination of multi-detector offsets was done in a manner consistent with that published by Mourey and Balke, Chromatography of Polymers: T. Provder, Ed.; ACS Symposium Series 521; American Chemical Society: Washington, D.C., (1993) pp 180-198 and Balke, et al., ; T. Provder, Ed.; ACS Symposium Series 521; American Chemical Society: Washington, D.C., (1993): pp 199-219., both of which are incorporated herein by reference in their entirety. The triple detector results were compared with polystyrene standard reference material NBS 706 (National Bureau of Standards), or DOW chemical polystyrene resin 1683 to the polystyrene column calibration results from the polystyrene narrow standards calibration curve.

Verification of detector alignment and calibration was made by analyzing a linear polyethylene homopolymer with a polydispersity of approximately 3 and a molecular weight of 115,000. The slope of the resultant Mark-Houwink plot of the linear homopolymer was verified to be within the range of 0.725 to 0.730 between 30,000 and 600,000 molecular weight. The verification procedure included analyzing a minimum of 3 injections to ensure reliability. The polystyrene standard peak molecular weights were converted to polyethylene molecular weights using the method of Williams and Ward described previously. The agreement for M_{w} and Mₙ between the polystyrene calibration method and the absolute triple detector method were verified to be within 5% for the polyethylene homopolymer.

The intrinsic viscosity data was obtained in a manner consistent with the Haney 4-capillary viscometer described in U.S. Pat. No. 4,463,598, incorporated herein by reference. The molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, N.Y. (1987)). The overall injected concentration used for the determination of the intrinsic viscosity and molecular weight were obtained from the sample refractive index area and the refractive index detector calibration from the linear polyethylene homopolymer and all samples were found to be within experimental error of the nominal concentration. The chromatographic concentrations were assumed low enough to eliminate the need for a Huggin's constant (concentration effects on intrinsic viscosity) and second virial coefficient effects (concentration effects on molecular weight).

For samples that contain comonomer, the measured g′ represents effects of both long chain branching as well as short chain branching due to comonomer. For samples that have copolymer component(s), the contribution from short chain branching structure should be removed as taught in Scholte et al., discussed above. If the comonomer is incorporated in such a manner that the short chain branching structure is proven both equivalent and constant across both the low and high molecular weight components, then the difference in long chain branching index between 100,000 and 500,000 may be directly calculated from the copolymer sample. For cases where the comonomer incorporation cannot be proven both equivalent and constant across both the high and low molecular weight components, then preparative GPC fractionation is required in order to isolate narrow molecular weight fractions with polydispersity lower than 1.4. ¹³C NMR is used to determine the comonomer content of the preparative fractions.

Additionally, a calibration of g′ against comonomer type for a series of linear copolymers of the same comonomer is established in order to correct for comonomer content, in cases where comonomer incorporation cannot be shown to be both equivalent and constant across both the high and low molecular weight components. The g′ value is then analyzed for the isolated fraction corresponding to the desired molecular weight region of interest and corrected via the comonomer calibration function to remove comonomer effects from g′. Estimation of number of branches per molecule on the high molecular weight species.

The number of long chain branches per molecule was also determined by GPC methods. High temperature GPC results (HTGPC) were compared with high temperature GPC light scattering results (HTGPC-LS). Such measurements can be conveniently recorded on a calibrated GPC system containing both light scattering and concentrations detectors which allows the necessary data to be collected from a single chromatographic system and injection. These measurements assume that the separation mechanism by HTGPC is due to the longest contiguous backbone segment through a polymer molecule (i.e. the backbone). Therefore, it assumes that the molecular weight obtained by HTGPC produces the backbone molecular weight (linear equivalent molecular weight) of the polymer. The average sum of the molecular weight of long chain branches added to the backbone at any chromatographic data slice is obtained by subtracting the backbone molecular weight estimate from the absolute molecular weight obtained by HTGPC-LS. If there is a significant comonomer content differential between the high and low molecular weight species in the polymer, it is necessary to subtract the weight of the comonomer from the HTGPC-LS results using knowledge of the high molecular weight catalyst.

The average molecular weight of the long chain branches that are added to the high molecular weight polymer is assumed to be equivalent to the number-average molecular weight of the bulk polymer (considering both high and low molecular weight species). Alternatively, an estimate of the average molecular weight of a long chain branch can be obtained by dividing the weight-average molecular weight of the low molecular weight species (obtained through de-convolution techniques) by a polydispersity estimate of the low molecular weight species. If there is a significant comonomer content differential between the high and low molecular weight species in the polymer, it is necessary to add or subtract the differential total weight of comonomer from the number average molecular weight results first using knowledge of the comonomer incorporation for the low molecular weight catalyst.

The number of long chain branches at any chromatographic slice is estimated by dividing the sum of the molecular weight of the total long chain branches by the average molecular weight of the long chain branch. By averaging this number of long chain branches weighted by the deconvoluted high molecular weight peak, the average amount of long chain branching for the high molecular weight species is determined. Although assumptions are made in regard to GPC separation and the fact that the polymer backbone can be extended due to a long chain branch incorporating near to the chain ends of the backbone segment, we have found this measure of number of branches to be very useful in predicting resin performance.

Tetrahydrofuran (THF), diethyl ether, toluene, hexane, and ISOPAR E (obtainable from Exxon Chemicals) were used following purging with pure, dry nitrogen and passage through double columns charged with activated alumina and alumina supported mixed metal oxide catalyst (Q-5 catalyst, available from Engelhardt Corp). All syntheses and a handling of catalyst components were performed using rigorously dried and deoxygenated solvents under inert atmospheres of nitrogen or argon, using either glove box, high vacuum, or Schlenk techniques, unless otherwise noted. Rac-(dimethylsilylbis(indenyl)hafnium dimethyl was purchased from Albemarle Corporation.

The ethylene and propylene monomers were passed through a oxygen scrubber prior to addition to the reactors. Weight average molecular weights were determined by light scattering. DSC data (Tₘ,ΔH_{f}) were obtained on the second heating at 10° C./min. NMR analysis was performed at 110° C. in o-dichlorobenzene on a 400 MHz instrument. “VCM” used herein refers to vinyl chloride monomer.

Catalyst Preparation

CATALYST A is (C₅Me₄SiMe₂N^{t}Bu)Ti(η⁴- 1,3-pentadiene). CATALYST A can be synthesized according to Example 17 of U.S. Pat. No. 5,556,928, the entire disclosure of which patent is incorporated herein by reference. For convenience, an exemplary synthesis is provide here as well.

In an inert atmosphere glove box 0.500 g (1.36 mmol) of (C₅Me₄SiMe₂N^{t}Bu)TiCl₂ was dissolved into approximately 50 niL of dry, degassed hexane. To this yellow solution was added 2.70 mL of technical grade piperylene (27.1 mmol) followed by 1.09 mL of n-butyl lithium (BuLi) (2.72 mmol, 2.5M in mixed hexanes). Addition of the latter resulted in an immediate color change to a dark reddish color. The reaction mixture was refluxed for 45 to 60 minutes after which time the reaction mixture was cooled to room temperature. The hexane solution was filtered through Celite™ brand filtering aid, using 10 mL of additional hexane to wash the insolubles. The combined hexane filtrate was taken to dryness under reduced pressure giving the product, (C₅Me₄SiMe₂N^{t}Bu)-Ti(η⁴-1,3-pentadiene), as a very dark reddish purple solid in 96.5 percent yield (0.97 g). NMR characterization: ¹H NMR (C₆D₆, ppm, approximate coupling constants were determined with the aid of simulation): Δ4.01 (overlapping dd, CHH=CH—CH=CHCH₃,1H, J_{HH}=9.5, 7.3 Hz); 3.84 (overlapping ddd, CHH=CH—CH=CHCH₃, 1H, J_{HH}=13.3, 9.5, 9 Hz); 2.97 (overlapping dd, CHH=CH—CH=CHCH₃, 1H, J_{HH}=9, 8 Hz); 2.13 (s, C₅Me₄, 3H); 2.1 (multiplet, partly overlapped by two singlets, CHH=CH—CH=CHCH₃, 1H, J_{HH}=8, 5.5 Hz); 2.05 (s, C₅Me₄,3H); 1.88 (d, CHH=CH—CH=CHCH₃, 3H, J_{HH}=5.5); 1.75 (dd, CHH=CH—CH=CHCH₃, 1H, J_{HH}=13.3, 7.3 Hz); 1.23, 1.21 (s each, C₅Me₄, 3H each); 1.16 (s, ^{t}Bu, 9H); 0.76, 0.73 (s each, SiMe₂, 3H each).

CATALYST B is rac-[dimethylsilylbis(1-(2-methyl-4-phenyl)indenyl)] zirconium 1,4- diphenyl-1,3-butadiene).

Catalyst B can be synthesized according to Example 15 of U.S. Pat. No. 5,616,664. According to Example 16, In an inert atmosphere glove box, 106.6 mg (0.170 mmol) of rac-[dimethylsilanediylbis(1-(2-methyl-4-phenyl)indenyl)]zirconium dichloride and 35.1 mg (0.170 mmol) of trans,trans-1,4-diphenyl-1,3-butadiene were combined in approximately 50 ml toluene. To this mixture was added 0.14 ml of 2.5M butyl lithium in mixed alkanes (0.35 mmol). After stirring at about 25° C. for two hours the mixture had turned from yellow to orange. The mixture was heated in toluene (about 80° C.) for three hours during which time it had turned dark red. The solution was cooled and filtered through Celite™ brand filter aid. The volatiles were removed from the solid under reduced pressure to give a red solid. This was dissolved in 15 ml mixed alkanes which was then removed under reduced pressure. ¹H NMR spectroscopy showed the desired π-diene product as well as some butylated material. The solid residue was dissolved in toluene and heated to reflux for five hours. Volatiles were then removed under reduced pressure and the residue dissolved in a small amount of mixed alkanes (ca 10 ml) and the resulting solution was cooled to −30° C. A solid was isolated by decanting the solution from the solid and removing the remaining volatiles from the solid under reduced pressure. ¹H NMR spectroscopy showed the desired compound, rac-[dimethylsilanediylbis (1 -(2-methyl-4-phenyl)indenyl)]zirconium (trans,trans-1,4-diphenyl-1,3-butadiene) as the major component containing an indenyl type ligand.

CATALYST C is 1,3-pentadiene[N-(1,1 -dimethylethyl)- 1,1 -dimethyl-[1,2,3, 4,5-η)-1,5,6, 7-tetrahydro-2-methyl-s-indacen-1-yl]silanaminto(2-)-N]titanium (also referred to as dimethylsilyl(2-methyl-s-indacenyl)(t-butylamido)titanium 1,3-pentadiene).

Catalyst C can be prepared according to Example 23 of U.S. Pat. No. 5,965,756 incorporated herein by reference in its entirety. According to Example 23, (t-Butylamido)dimethyl(η⁵-2-methyl-s-indacen-1-yl)silanetitanium dichloride (0.300 grams, 0.72 mmol) is suspended in 50 mL of cyclohexane in a 100 mL round bottom flask. Ten equivalents of 1,3-pentadiene (1.08 mL, 10.81 mmol) are added to the contents of the flask followed by two equivalents of a 2.5 M hexane solution of n-BuLi (0.58 mL, 1.44 mmol). The flask is fitted with a condenser and the reaction mixture is heated to reflux for three f hours. Upon cooling, volatiles are removed under reduced pressure to leave a residue that is then extracted with hexane and filtered through a diatomaceous earth filter aid (Celite™) on a 10-15 mm glass frit. The hexane is removed under reduced pressure to afford 0.257 g of a brown oily solid (86 percent yield) of the desired product is obtained. The product is isolated as a mixture of the prone and supine isomers resulting from the orientation of 1,3-pentadiene.

CATALYST D is (1H-cyclopenta[1]phenanthrene-2-yl)dimethyl(t-butyl amido) silane titanium dimethyl.

Catalyst D can be prepared according to Example 2 of U.S. Pat. No. 6,150,297 incorporated herein by reference in its entirety. According to Example 2, 50 ml of diethylether was added dropwise 0.75 ml of a 3.0 M solution of MeMgBr in diethylether to a 100 ml round bottom flask containing 0.480 g (0.00104 mole) of (1H-cyclopenta[1]phenanthrene-2-yl)dimethyl(t-butylamido)silanetitanium dichloride. The reaction mixture was allowed to stir for 0.5 h. The volatiles were removed under reduced pressure and the residue was extracted with hexane and then filtered. The desired product was isolated by removing the solvent under reduced pressure to give 0.196 g (44.8 percent yield) of a yellow solid.

Catalyst E is a high surface area MgCl₂ supported TiCl₄ Ziegler-Natta catalyst such as those described in include U.S. Pat. Nos. 4,243,785, 4,659,685, 5,661,097, 6,187,424, incorporated herein by reference in their entirety.

General Experimental Description 1 (GED1)

The following experimental procedures were used for those polymerizations conducted in a 300 ml Parr, stirred stainless steel reactor unless noted otherwise. The reactor had six ports: 1) catalyst injection, 2) gas inlet and pressure gauge, 3) thermocouple, 4 and 5) inlet/outlet for coolant loop, and 6) pressure relief disc (rated at 1000 psi).

In a dry-box, two stainless steel bombs with valves at either end were connected in series, where one bomb contained catalyst, MAO (0.6 ml of a 0.178 M solution, 0.107 mmol), and methyldi(octadecyl)ammonium tetrakispentafluorophenyl)borate, the ammonium cation of which is derived from a mixture of amines available commercially as methyl bis(tallow)amine (0.3 ml of a 0.1 M solution, 3×10⁻⁵ mol) and 10 ml of toluene; the second bomb contained 90 ml of toluene. The bombs were sealed and removed from the drybox and connected to the 300 ml reactor. All connections to the reactor were made and the reactor pressure tested with nitrogen at 150 psi for 5 min. Then the reactor was placed under vacuum at 85° C. for 15 min. With the gas port closed, the catalyst was washed into the reactor by the 90 ml of toluene and the reaction mixture brought to 70° C. The VCM and ethylene or propylene monomer was then charged to the reactor. This was done using an HPLC sample injector loop which was filled with the desired amount of VCM. The injection loop was in-line with the gaseous monomer manifold and the reactor; the VCM was charged to the reactor under pressure from the gaseous monomer. When the reactor reached the desired pressure, the gas inlet on the reactor head was sealed and the reaction allowed to proceed for the desired period of time. The reactor was then vented, and pad/de-padded with 100 psi of nitrogen. The reactor head was then removed from the reactor body and the toluene solution precipitated into methanol. Any polymer product was then isolated by filtration and dried under vacuum at 85-90° C.

General Procedure for Determining R, and Comonomer Incorporation

One method to quantify and identify unsaturation in ethylene-octene copolymers is ¹H NMR. The sensitivity of ¹H NMR spectroscopy is enhanced by utilizing the technique of peak suppression to eliminate large proton signals from the polyethylene back bone. This allows for a detection limit in the parts per million range in approximately one hour data acquisition time. This is in part achieved by a 100,000-fold reduction of the signal from the -CH₂- protons which in turn allows for the data to be collected using a higher signal gain value. As a result, the unsaturated end groups can be rapidly and accurately quantified for high molecular weight polymers.

The samples were prepared by adding approximately 0.100g of polymer in 2.5ml of solvent in a 10mm NMR tube. The solvent is a 50/50 mixture of 1,1,2,2-tetrachloroethane-d2 and perchloroethylene. The samples were dissolved and homogenized by heating and vortexing the tube and its contents at 130° C. The data was collected using a Varian Unity Plus 400MHz NMR spectrometer. The acquisition parameters used for the Presat experiment include a pulse width of 30 μs, 200 transients per data file, a 1.6 sec acquisition time, a spectral width of 10000Hz, a file size of 32K data points, temperature setpoint 110° C., D1 delay time 4.40 sec, Satdly 4.0 sec, and a Satpwr of 16.

Comonomer content was measured by ¹³C NMR Analysis. The samples were prepared by adding approximately 3 g of a 50/50 mixture of tetrachloroethane-d2/orthodichlorobenzene to 0.4g sample in a 10 mm NMR tube. The samples were dissolved and homogenized by heating the tube and its contents to 150° C. The data was collected using a JEOL Eclipse 400 MHz NMR or Varian Unity Plus 400 MHz spectrometer, corresponding to a ¹³C resonance frequency of 100.4 MHz. The data was acquired using NOE, 1000 transients per data file, a 2 sec pulse repetition delay, spectral width of 24,200Hz and a file size of 32K data points, with the probe head heated to 130° C.

### COMPARATIVE EXAMPLE 1

In a dry-box, catalyst (CATALYST A, 147 μL, 0.087 M), RIBS-2 (132 μL, 0.1588 M), MAO (390 μL, 6.45 wt %), and toluene (5.0 ml) were charged to a 45 ml stainless steel bomb. The bomb was sealed with a pressure transducer and a inlet valve attached to the head. The bomb was connected to a manifold at the inlet valve, and the line purged of air by three vacuum/nitrogen cycles. The manifold was pressurized with 150 psi of ethylene, the inlet valve opened, and the pressure allowed to equilibrate. The inlet valve was closed, the bomb disconnected from the manifold and the bomb placed in a heated (70° C.) shaker. The reaction was run for 30 min, when the reactor was vented. The reaction mixture was washed with 1M HC1, and the solid polymer obtained by decanting off the liquid layers. The polymer was washed with isopropanol and acetone, then dried overnight under vacuum at 80 ° C. Yield: 0.32 g, Tm =131.3 ° C, AHf =149.1 J/g. Material was insufficiently soluble for GPC and NMR analysis.

### EXAMPLE 2

Procedure is the same as Example 1, except that prior to addition of ethylene, the bomb was weighed, VCM added and the bomb re-weighed; the amount of VCM added (0.3 g) was determined by weighing by difference. Ethylene was then added and the bomb placed in the heated shaker for 30 min. The polymer was worked up as above. Yield: 0.25 g, M,=36,000. Tm =130.5 ° C, AHf=167.1 J/g. NMR analysis showed 0.0862 mol% vinyl end groups.

### COMPARATIVE EXAMPLE 3

In a dry-box, catalyst (CATALYST C, 8 mg), methyldi(octadecyl) ammonium tetrakis(pentafluorophenyl)borate as described above in the General Experimental Description (130jiL, 0.1588 M), MAO (390 lL, 6.45 wt%), and toluene (5.0 ml) were charged to a 45 ml stainless steel bomb. The bomb was sealed with a pressure transducer and a inlet valve attached to the head. The bomb was connected to a manifold at the inlet valve, and the line purged of air by three vacuum/nitrogen cycles. The manifold was pressurized with 150 psi of ethylene, the inlet valve opened, and the pressure allowed to equilibrate. The inlet valve was closed, the bomb disconnected from the manifold and the bomb placed in a heated (70 ° C) shaker. The reaction was run for 30 min, when the reactor was vented. The reaction mixture was washed with 1M HCl, and the solid polymer obtained by decanting off the liquid layers. The polymer was washed with isopropanol and acetone, then dried overnight under vacuum at 80 ° C. Yield: 0.41g, Tm =132.5 ° C, AHf =149.9 J/g. NMR analysis showed no vinyl end groups. Material was insufficiently soluble for GPC analysis.

### EXAMPLE 4

Procedure is the same as Example 3, except that prior to addition of ethylene, the bomb was weighed, VCM added and the bomb re-weighed; the amount of VCM added (0.2 g) was determined by weighing by difference. Ethylene was then added and the bomb placed in the heated shaker for 30 min. The polymer was worked up as above. Yield: 0.51 g, Mw=31,000. Tm =130.5 OC, AHf=167.1 J/g. NMR analysis showed 0.0821 mol% vinyl end groups.

### COMPARATIVE EXAMPLE 5

In a dry-box, catalyst (CATALYST B, 5 mg), methyldi(octadecyl) ammonium tetrakis(pentafluorophenyl)borate as described above in the General Experimental Description (130 pL, 0.1588 M), MAO (390 lL, 6.45 wt%), and toluene (5.0 ml) were charged to a 45 ml stainless steel bomb. The bomb was sealed with a pressure transducer and a inlet valve attached to the head. The bomb was connected to a manifold at the inlet valve, and the line purged of air by three vacuum/nitrogen cycles. The manifold was I5 pressurized with 150 psi of ethylene, the inlet valve opened, and the pressure allowed to equilibrate. The inlet valve was closed, the bomb disconnected from the manifold and the bomb placed in a heated (70 ° C) shaker. The reaction was run for 30 min, when the reactor was vented. The reaction mixture was washed with IM HCl, and the solid polymer obtained by decanting off the liquid layers. The polymer was washed with isopropanol and acetone, then dried overnight under vacuum at 80 ° C. Yield: 0.52 g, Tm =131.0 ° C, AHf =148.6 J/g. NMR analysis showed no vinyl end groups. Material was insufficiently soluble for GPC analysis.

### EXAMPLE 6

Procedure is the same as Example 5, except that prior to addition of ethylene, the bomb was weighed, VCM added and the bomb re-weighed; the amount of VCM added (0.2 g) was determined by weighing by difference. Ethylene was then added and the bomb placed in the heated shaker for 30 min. The polymer was worked up as above. Yield: 0.18 g, M,=142,000. Tm =131.6 ° C, AHf=153.9 J/g. NMR analysis showed 0.0230 mol% vinyl end groups.

### COMPARATIVE EXAMPLE 7

In a dry-box, catalyst (CATALYST B, - 5 mg), methyldi(octadecyl) ammonium tetrakis(pentafluorophenyl)borate as described above in the General Experimental Description (130 gL, 0.1588 M), MAO (390 pL, 6.45 wt%), and toluene (5.0 ml) were charged to a 45 ml stainless steel bomb. The bomb was sealed with a pressure transducer and a inlet valve attached to the head. The bomb was connected to a manifold at the inlet valve, and the line purged of air by three vacuum/nitrogen cycles. The manifold was pressurized with 130 psi of propylene, the inlet valve opened, and the pressure allowed to equilibrate. The inlet valve was closed, the bomb disconnected from the manifold and the bomb placed in a heated (70 ° C) shaker. The reaction was run for 30 min, when the reactor was vented. The reaction mixture was washed with IM HCI, and the solid polymer obtained by decanting off the liquid layers. The polymer was washed with isopropanol and acetone, then dried overnight under vacuum at 80 ° C. Yield: 0.88 g, Tm =151.5 ° C, MHf =84.5 J/g. NMR analysis showed no vinyl end groups; 0.0287 mol% vinylidene end groups were detected. M,=88,000.

### EXAMPLE 8

Procedure is the same as Example 5, except that prior to addition of propylene, the bomb was weighed, VCM added and the bomb re-weighed; the amount of VCM added (0.1 g) was determined by weighing by difference. Propylene was then added and the bomb placed in the heated shaker for 30 min. The polymer was worked up as above. Yield: 0.50 g, M, =33,000. Tm =145.8 ° C, AHf =96.2 J/g. NMR analysis showed 0.0572 mol% vinyl end groups and 0.0287 mol% vinylidene end groups were detected.

### EXAMPLE 9

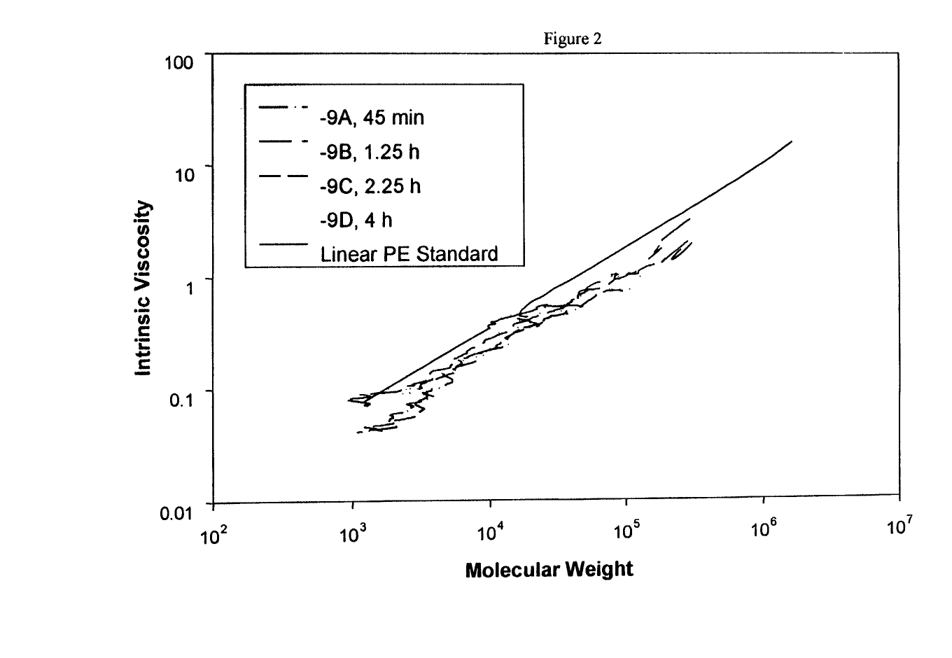

In a dry-box, catalyst (CATALYST C, - 8 mg), methyldi(octadecyl) ammonium tetrakis(pentafluorophenyl)borate as described above in the General Experimental Description (130 pL, 0.1588 M), MAO (390 lL, 6.45 wt%), and toluene (5.0 ml) were charged to a 45 ml stainless steel bomb. Three other bombs were prepared in a similar manner. The bombs were sealed with a pressure transducer and a inlet valve attached to the head. Each bomb was connected to a manifold at the inlet valve, and the line purged of air by three vacuum/nitrogen cycles. The bomb was weighed, VCM added and the bomb re- weighed; the amount of VCM added was determined by weighing by difference. Ethylene (150 psi) was then added, the inlet valve closed, the bomb disconnected from the manifold and the bomb was then placed in a heated (70 OC) shaker. The reaction was run for the desired time, then the reactor was vented. The reaction mixture was washed with 1M HCl, and the solid polymer obtained by decanting off the liquid layers. The polymer was washed with isopropanol and acetone, then dried overnight under vacuum at 80 ° C. All samples showed branching as evidenced by the lower intrinsic viscosities than that observed for the linear polyethylene standards at the same molecular weights, which is illustrated in FIG. 2.

TABLE I

| | Run Time | VCM | | | NMR (mol % vinyl |
|---|---|---|---|---|---|
| Sample | (h) | (g) | DSC, Tₘ (° C.) | GPC (M_{w}, M_{w}/Mₙ) | end groups) |
| 9A | 0.5 | 0.2 | 123.0 | 6,300 (2.03) | 0.0749 |
| 9B | 1.0 | 0.2 | 121.1 | 5,500 (6.25) | 0.0950 |
| 9C | 2.0 | 0.3 | 122.9 | 6,900 (2.46) | 0.1852 |
| 9D | 4.0 | 0.3 | 121.9 | 5,900 (5.36) | 0.1070 |

### EXAMPLES 10-13

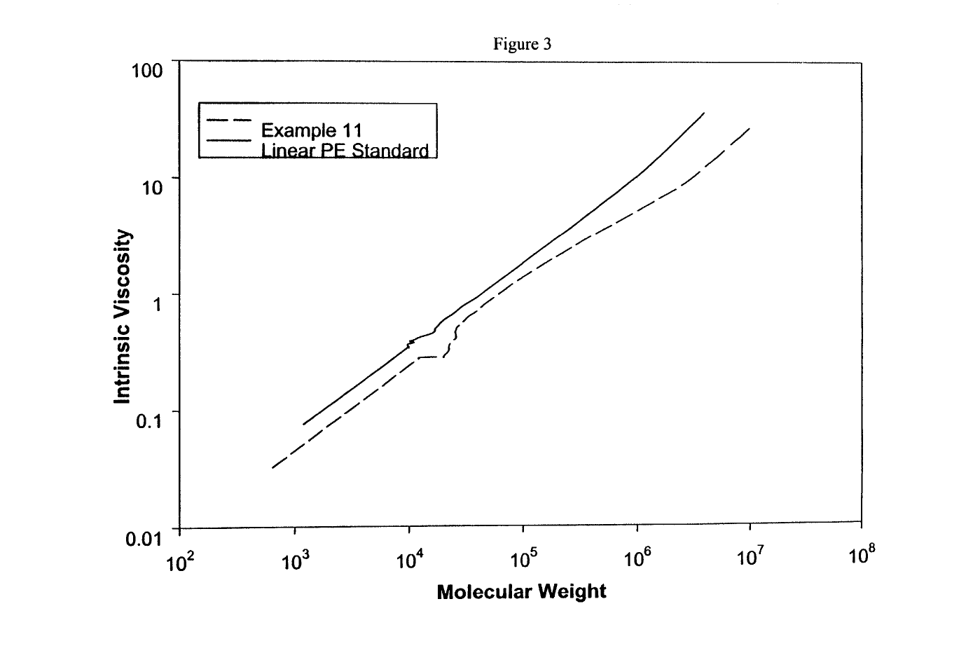

In a dry-box, catalyst ( 8 mg), methyldi(octadecyl) ammonium tetrakis(pentafluorophenyl)borate as described above in the General Experimental Description (130pL, 0.1588 M), MAO (390 IL, 6.45 wt%), and toluene (5.0 ml) were charged to a 45 ml stainless steel bomb (Except Example 12: Catalyst E (5 lmol Ti), TEAl (200 plL, 1 M) and toluene (5.0 ml) were added). Three other bombs were prepared in a similar manner. The bombs were sealed with a pressure transducer and a inlet valve attached to the head. Each bomb was connected to a manifold at the inlet valve, and the line purged of air by three vacuum/nitrogen cycles. The bomb was weighed, VCM added and the bomb re- weighed; the amount of VCM added was determined by weighing by difference. Ethylene (150 psi) was then added (propylene, 130 psi, for Example 13) and the bomb placed in a heated shaker (70 ° C) for 13 hours. The reactor was then vented. The reaction mixture was washed with IM HCl, and the solid polymer obtained by decanting off the liquid layers. The polymer was washed with isopropanol and acetone, then dried overnight under vacuum at 80° C. FIG. 3 is a Mark-Houwink plot for the ethylene polymer of Example 11 as compared to a linear polyethylene polymer with no long chain branching. As can be seen in FIG. 3, the ethylene polymer of Example 11 has a lower intrinsic viscosity at the same molecular weight, indicating that it has long chain branching.

TABLE II

| | | | | | NMR (mol % |
|---|---|---|---|---|---|
| | | VCM | DSC | GPC (M_{w}, | vinyl end |
| Example # | Catalyst | (g) | Tₘ (° C.) (ΔHf J/g)) | M_{w}/Mₙ) | groups) |
| 10 | CATALYST C | 0.2 | 120.6 (173.7) | 4,900 (4.08) | 0.1124 |
| 11 | CATALYST B | 0.3 | 128.5 (203.1) | 205,000 (6.9) | 0.0010 |
| | | | | (Branching | |
| | | | | observed) | |
| 12 | CATALYST E | 0.2 | 132.2 (221.1) | 98,900 (52.0) | 0.0002 |
| 13 | CATALYST B | 0.2 | 147.3 (144.5) | 13,800 (3.13) | 0.1463 |
| | (Propylene) | | | | |

### EXAMPLE 14

In a dry-box, catalyst (CATALYST D, 5 mg), methyldi(octadecyl) ammonium tetrakis(pentafluorophenyl)borate as described above in the General Experimental Description (130jiL, 0.1588 M), MAO (390 lL, 6.45 wt%), and toluene (5.0 ml) were charged to a 45 ml stainless steel bomb. Three other bombs were prepared in a f0 similar manner. To two bombs (Examples 14A and 14B) styrene was added (2.0 ml, 17.5 mmol); to the others (Examples 14C and 14D) a smaller amount of styrene was added (0.23 ml, 2 mmol). The bombs were sealed with a pressure transducer and a inlet valve attached to the head. Each bomb was connected to a manifold at the inlet valve, and the line purged of air by three vacuum/nitrogen cycles. The bomb was weighed, VCM (0.5 ml) added to Examples 14A and 14C. Ethylene (150 psi) was then added to each of the bombs, which were then placed in a heated shaker (70 ° C) for 50 min. The reactor was then vented. The reaction mixture was washed with IM HCl, and the solid polymer obtained by decanting off the liquid layers. The polymer was washed with isopropanol and acetone, then dried overnight under vacuum at 80° C.

TABLE III

| | | | | | | NMR |
|---|---|---|---|---|---|---|
| | | | Mol % | | | (mol % |
| Ex- | Styrene | VCM | Comonomer | | GPC (M_{w}; | vinyl end |
| ample # | (ml) | (ml) | Feed^{a} | Polymer^{b} | M_{w}/Mᵤ) | groups)^{a} |
| 14A | 2.0 | 0.5 | 55 | 41 | 52,800; 8.9 | 0.02 |
| 14B | 2.0 | 0 | 55 | 40 | 67,100; 12.4 | nd |
| 14C | 0.23 | 0.5 | 12 | 8 | 92,200; 15.4 | 0.2 |
| 14D | 0.23 | 0 | 12 | 7 | 148,000; 9.2 | nd |

^{a}Compositions based on estimated 15 mmol of ethylene (40 ml headspace, 70° C., 150 psi.)
^{b}Compositions determined by ¹H NMR.

### EXAMPLE 15

Experimental conditions were those as described in GED1. The catalyst used was CATALYST C (0.5 ml of a 0.05 M solution in benzene-d₆, 2.5 x 10-⁵ mol) with methyldi(octadecyl)ammonium tetrakis(pentafluorophenyl)borate as described above in the General Experimental Description as the activator. 1-Octene (2.95 ml, 18.75 mmol) was added to the bomb containing 90 ml of toluene prior to removal from the drybox. The amount of vinyl chloride added was 500 luL, with ethylene at 150 psi. The reaction was allowed to run for 80 min. Yield: 3.39 g; NMR: mol % vinyl end groups =0.02; GPC: M, =48,300, M,/Mn =6.9.

### EXAMPLES 16A-C

Experimental conditions were those as described in GEDI. For all reactions, the catalyst bombs were prepared and the reactions conducted in an identical manner; only the amount of VCM was varied. The catalyst used was CATALYST C (0.5 ml of a 0.05 M 20 solution in benzene-d₆, 2.5 x 10-5 mol) with methyldi(octadecyl)ammonium tetrakis(pentafluorophenyl)borate as described above in the General Experimental Description as the activator. The amount of vinyl chloride added for the examples was: 16A =500 [tL ]16B =100 gL, 16C =25 gL, with ethylene at 150 psi. The reaction was allowed to run until the ethylene pressure dropped to - 90 - 100 psi (approx. 2 min).

TABLE IV

| | VCM | | | | |
|---|---|---|---|---|---|
| Monomer | (μL) | Mₙ | Cₛ × 10⁴ | 1/Xₙₒ × 10⁴ | r₁(=1/Cₛ) |
| Ethylene | 500 | 55 700 | 35.8 | 2.88 | 279.3 |
| | 100 | 85 100 | | | |
| | 25 | 86 108 | | | |

### EXAMPLES 17A-C

Experimental conditions were those as described in GEDI. For all reactions, the catalyst bombs were prepared and the reactions conducted in an identical manner; only the amount of VCM was,varied. The catalyst used was CATALYST B (0.5 ml of a 0.044 M, 2.2 x 10-5 mol) with methyldi(octadecyl)ammonium tetrakis(pentafluorophenyl)borate as described above in the General Experimental Description as the activator. The amount of vinyl chloride added for the examples was: 17A =500 ,L, 17B 100 SL, 17C=25 PL, with ethylene at 120 psi. The reaction was allowed to run until the ethylene pressure decreased by 30 psi (approx. - 2 min).

TABLE V

| | VCM | | | | |
|---|---|---|---|---|---|
| Monomer | (μL) | Mₙ | Cₛ × 10⁴ | 1/Xₙₒ × 10⁴ | r₁(=1/Cₛ) |
| Ethylene | 500 | 59 500 | 24.9 | 2.98 | 401.6 |
| | 100 | 77 900 | | | |
| | 25 | 98 400 | | | |

### EXAMPLES 18A-C

Experimental conditions were those as described in GED1. For all reactions, the catalyst bombs were prepared and the reactions conducted in an identical manner; only the amount of VCM was varied. The catalyst used was CATALYST B (0.5 ml of a 0.044 M, 2.2 x 10-5 mol) with methyldi(octadecyl)ammonium tetrakis(pentafluorophenyl)borate as described above in the General Experimental Description as the activator. The amount of vinyl chloride added for the examples was: 18A =500 tL, 18B =250 lIL, 18C=100 lL, 18D =25 tL with propylene at 120 psi. The reaction was allowed to run until the propylene pressure decreased by 70 psi (approx. 2 min).

TABLE VI

| | VCM | | | | |
|---|---|---|---|---|---|
| Monomer | (μL) | Mₙ | Cₛ × 10⁴ | 1/Xₙₒ × 10⁴ | r₁(=1/Cₛ) |
| Propylene | 500 | 18 900 | 721 (682)^{a} | 11.2 (10.7)^{a} | 1.4 (1.5) |
| | 250 | 19 300 | | | |
| | 100 | 30 300 | | | |
| | 25 | 39 300 | | | |

### EXAMPLES 19A-C

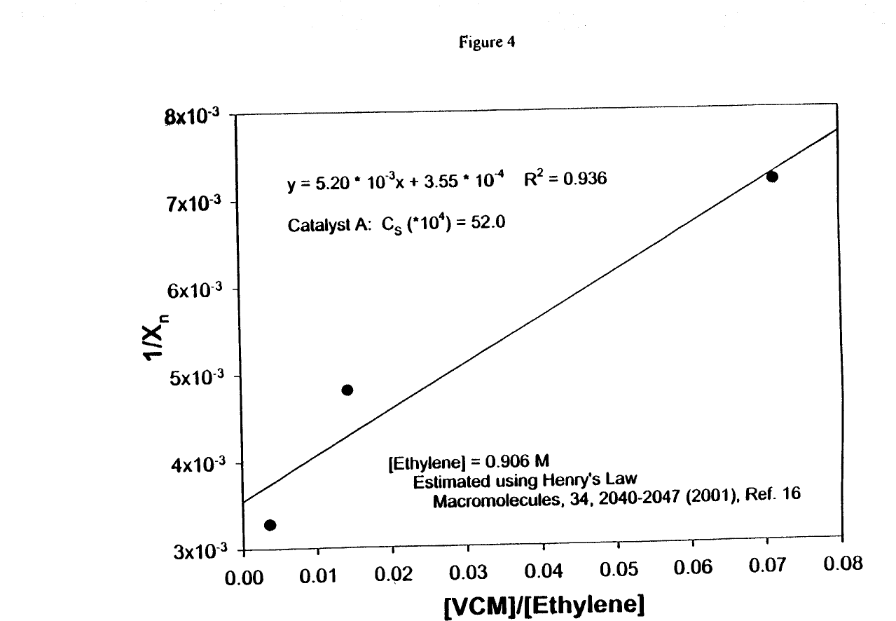

Experimental conditions were those as described in GEDI. For all reactions, the catalyst bombs were prepared and the reactions conducted in an identical manner; only the amount of VCM was varied. The catalyst used was CATALYST A (0.4 ml of a 0.065 M, 2.6 x 1 -5mol) with methyldi(octadecyl)ammonium tetrakis(pentafluorophenyl)borate as described above in the General Experimental Description as the activator. The amount of vinyl chloride added for the examples was: 19A 500 pL, 19B 100 [L, 19C=25 pL, with ethylene at 160 psi. The reaction was allowed to run until the ethylene pressure decreased by -50 psi (approx. - 3 min). FIG. 4 illustrates a determination of CS from this example.

TABLE VII

| | VCM | | | | |
|---|---|---|---|---|---|
| Monomer | (μL) | Mₙ | Cₛ × 10⁴ | 1/Xₙₒ × 10⁴ | r₁(=1/Cₛ) |
| Ethylene | 500 | 39 000 | 52.0 | 3.55 | 192.3 |
| | 100 | 58 100 | | | |
| | 25 | 85 200 | | | |

### Example 20A-B

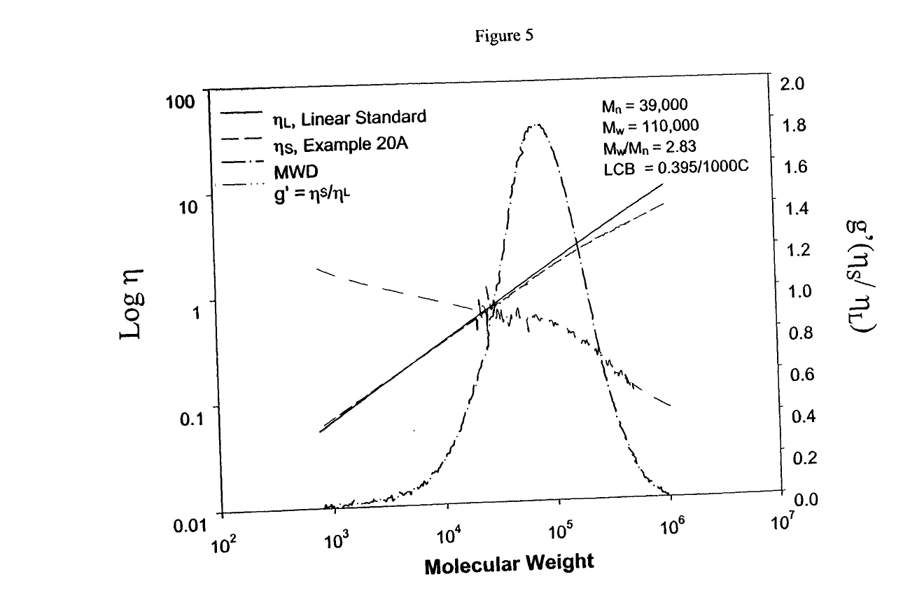

Example 20A: Experimental conditions were those as described in GED1. The catalyst used was CATALYST B (1.0 ml of a 0.025 M solution, 2.5 x 10-⁵ mol) with methyldi(octadecyl)ammonium tetrakis(pentafluorophenyl)borate as described above in the General Experimental Description as the activator. No MAO was added but triisobutylaluminum (2.4 ml of a 0.404 M solution) was added instead. The amount of vinyl chloride added was 100 pL, with propylene at 120 psi; when pressure dropped to 100 psi (a 30 seconds) propylene was added until reactor pressure was 120 psi again. The reaction was allowed to run for 90 min. Yield: 7.59 g; GPC: Mw =1 10,00, M,/Mn =2.83, LCBF =0.395 branches/l000carbons. FIG. 5 is a Mark-Houwink plot for the ethylene polymer of Example 20A as compared to a linear polyethylene polymer with no long chain branching. As can be seen in FIG. 5, the ethylene polymer of Example 20A has a lower intrinsic viscosity at the same molecular weight, indicating that it has long chain branching.

Example 20B: The above reaction was repeated as above but modified to produce a lower molecular weight polymer. Yield: 7.59 g; GPC: Mv =63,300, Mw/Mn =3.40, LCBF =0.390 branches/i O00carbons. FIG. 5 is a Mark-Houwink plot for the ethylene polymer of Example 20A as compared to a linear polyethylene polymer with no long chain branching. As can be seen in FIG. 5, the ethylene polymer of Example 20A has a lower intrinsic viscosity at the same molecular weight, indicating that it has long chain branching.

Examples were also analyzed to determine the effect of vinyl chloride functional monomer on vinyl endgroup content of polymers. Analysis by ¹H NMR showed that the VCM produced polymers with vinyl end groups. The polymers prepared in the absence of VCM showed very little, if any, vinyl end groups. The vinylidene unsaturation observed for the polypropylene was to be expected, as P-hydride elimination from the backbone carbon adjacent to the pendent CH₃ group is a common chain breaking step in propylene polymerization. Conversely, the polymers prepared with VCM showed significant amounts of vinyl end groups, with the exception of the polyethylene prepared using catalyst E. It is notable that for most of the polymers prepared with VCM, the vinyl end groups were the only vinyl unsaturations observed.

In the propylene polymerization, the mol % of vinylidene end groups remained unchanged upon addition of VCM to the reaction, but that the mol% of vinyl end groups increased from zero to 0.0572 mol%, relative to the -CH₂7 units in the polymer. This observation indicates that the presence of the VCM in the reaction mixture does not interfere with the general propagation and termination/transfer mechanisms that are involved in the polymerization of propylene by catalyst B. VCM simply behaves as a chain transfer agent, undergoing P-Cl elimination after insertion in the carbon-metal bond during propagation. 1218] Analysis by GPC showed that the polymers produced with VCM were of significantly lower molecular weight than those prepared in the absence of VCM. The lowered molecular weights were consistent with the hypothesis that the VCM acted as a chain transfer agent.

TABLE VIII

| | Catalyst | | mol % Cis & | mol % | Total mol % |
|---|---|---|---|---|---|
| Example | (Polymer^{a}) | mol % Vinyl^{b} | Trans^{b} | Vinylidene^{b} | Unsaturation^{b} |
| Ex. 2 | Catalyst A | 0.0862 | 0.0000 | 0.0000 | 0.0862 |
| | (HDPE/VCM) | | | | |
| Ex. 4 | Catalyst C/ | 0.0821 | 0.0000 | 0.0000 | 0.0821 |
| | (HDPE/VCM) | | | | |
| Ex. 6 | Catalyst B | 0.0230 | 0.0000 | 0.0000 | 0.0230 |
| | (HDPE/VCM) | | | | |
| Comp. Ex. | Catalyst B (PP) | 0.0000 | 0.0000 | 0.0287 | 0.0287 |
| 7 | | | | | |
| Ex. 8 | Catalyst B | 0.0572 | 0.0000 | 0.0281 | 0.0853 |
| | (PP/VCM) | | | | |

^{a}HDPE = polymerization conducted with ethylene as the monomer; PP = polymerization conducted with propylene as the monomer.
^{b}mol % is relative to total —CH₂— in the polymer.

Polymer products were also analyzed by DSC to determine the effect of vinyl chloride functional monomer on melting point, heat of formation, and crystallinity of the polymers. As general rule the results show that for substantially similar reaction conditions, polymers incorporating the vinyl chloride monomer have higher degree of crystallinity and slightly reduced melting points.

TABLE IX
DSC results for screening polymerizations
using VCM with a variety of catalysts.

| Catalyst | Monomer | VCM | Tₘ (° C.) | ΔH_{f} (J/g) | % XL |
|---|---|---|---|---|---|
| Catalyst A | Ethylene | Yes | 130.5 | 167.1 | 61.9 |
| Catalyst A | Ethylene | No | 131.3 | 149.1 | 55.2 |
| Catalyst C | Ethylene | Yes | 124.1 | 154.3 | 57.1 |
| Catalyst C | Ethylene | No | 132.5 | 149.9 | 55.5 |
| Catalyst B | Ethylene | Yes | 131.6 | 153.9 | 57.0 |
| Catalyst B | Ethylene | No | 131.0 | 148.6 | 55.0 |
| Catalyst E | Ethylene | Yes | 130.1 | 179.1 | 66.3 |
| Catalyst E | Ethylene | No | 134.1 | 187.9 | 70.0 |
| Catalyst B | Propylene | Yes | 145.8 | 96.2 | 58.3 |
| Catalyst B | Propylene | No | 151.5 | 84.5 | 51.2 |

As demonstrated above, embodiments of the invention provide a new process for making olefin polymers. The novel process may offer one or more of the following advantages. First, it is now possible to independently control the macromer formation and its concentration and the molecular weight of the polymer. This flexibility allows molecular engineering of desirable polymers. Polymers with highly branched long chains can be manufactured. Second, the costs associated with this process are similar to those for metallocene catalyzed processes. The processability of the polymer produced by the process is often better than that of a metallocene catalyzed polymer produced with a single catalyst. Therefore, it is now possible to produce an interpolymer with better processability without sacrificing efficiency and thus incurring higher costs. By proper selection of catalysts and functional monomers, it is also possible to design the structure and the level of long chain branching. Moreover, a comb-like long chain branching structure is obtained.

The polymers produced in accordance with embodiments of the invention may offer one or more of the following advantages. First, the processability and optical properties of certain of the interpolymers are similar to LDPE, while the mechanical properties of certain of the interpolymers are better than LDPE. Moreover, the improved processability is not obtained at the expense of excessive broadening of the molecular weight distribution. The interpolymers also retain many of the desired characteristics and properties of a metallocene catalyzed polymer. In essence, some interpolymers prepared in accordance with embodiments of the invention combines the desired attributes of LDPE and metallocene catalyzed polymers. Additional advantages are apparent to those skilled in the art.

While the invention has been described with a limited number of embodiments, these specific embodiments are not intended to limit the scope of the invention as otherwise described and claimed herein. Modification and variations from the described embodiments exist. For example, while the process is exemplified by vinyl chloride, other functional monomers (especially those with more than one polar groups) can be used. Although the process is described with reference to the production of interpolymers, homopolymers, such as homopolyethylene, homopolypropylene, homopolybutylene, etc. may also be produced by the process described herein. These homopolymers are expected to have a high level of long chain branching and thus exhibit improved processability while maintaining the desired characteristics possessed by the homopolymers produced by one metallocene catalyst. It should be recognized that the process described herein may be used to make terpolymers, tetrapolymers, or polymers with five or more comonomers. The incorporation of additional comonomers may result in beneficial properties which are not available to copolymers. While the processes are described as comprising one or more steps, it should be understood that these steps may be practiced in any order or sequence unless otherwise indicated. These steps may be combined or separated. Finally, any number disclosed herein should be construed to mean approximate, regardless of whether the word “about” or “approximate” is used in describing the number. The appended claims intend to cover all such variations and modifications as falling within the scope of the invention.

What is claimed is:

1. A polymerization process, comprising:
contacting at least one polymerizable monomer in the presence of a metal catalyst in a reactor;
effectuating polymerization of the monomer;
adding a substituted olefin having at least one polar group to the reactor, the substituted olefin being different from the monomer.

2. The process of claim 1 further comprising forming an olefinic macromer from the olefinic monomers and the substituted olefin.

3. The process of claim 2 further comprising incorporating the olefinic macromer into a polymer backbone so that the macromer becomes a long chain branch of the polymer backbone.

4. The process of claim 3 wherein the polymer is a substantially linear polymer having vinyl end groups.

5. The polymerization process of claim 1, wherein the polymerization process is characterized by a chain transfer constant Cs =kₜᵣk ₚ, in the range from about 10,000 to about 0.0000001

6. The polymerization process of claim 1, wherein the Cₛ is in the range from about 1,000 to about 0.000001.

7. The polymerization process of claim 1, wherein the Cₛ is in the range from about 100 to about 0.00001.

8. The polymerization process of claim 1, wherein the Cₛ is in the range from about 10 to about 0. 00001.

9. The polymerization process of claim 1, wherein the Cₛ is in the range from about 1 to about 0.0001.

10. The polymerization process of claim 1, wherein the Cₛ is in the range from about 0.1 to about 0.001

11. The polymerization process of claim 1, wherein the metal catalyst is a Ziegler-Natta catalyst.

12. The polymerization process of claim 1, wherein the metal catalyst is a metallocene catalyst.

13. The polymerization process of claim 1, wherein the metal catalyst is a constrained geometry catalyst.

14. The polymerization process of claim 1, wherein the metal catalyst is a non-metallocene single site catalyst.

15. The polymerization process of claim 1, wherein the monomer is α-olefin.

16. The polymerization process of claim 1, wherein the substituted olefin is selected from the group consisting of vinyl fluoride, vinyl chloride, vinyl bromide, vinyl iodide, vinyl acetate, methyl acrylate, methyl vinyl ether, vinyl ketones, isobutyl vinyl ether, vinyl amines, vinyl amides, acrylonitrile, acrylamide, vinyl oxazoles, vinyl thiazoles, and vinyl ethers.

17. The polymerization process of claim 1, wherein the substituted olefin is vinyl chloride.

18. The polymerization process of claim 1, wherein vinyl terminated macromers are formed.

19. The polymerization process of claim 18, wherein the concentration of the macromers is controlled by the concentration of the substituted olefin.

20. The polymerization process of claim 18, wherein the macromers are copolymerized with the monomer.

21. The polymerization process of claim 18, wherein the macromers are homopolymerized.

22. The polymerization process of claim 18, wherein two of the macromers are coupled together via an acyclic diene metathesis reaction.

23. A polymer made by the process of claim 1.

24. A polymer of an olefin monomer and a substituted olefin, comprising:
a backbone chain; and
a plurality of side chains,
wherein the polymer is characterized by a Rv value of greater than about 0.85, as defined in the following:
$${R}_{v} = \frac{[ vinyl ]}{[ vinyl ] + [ vinylidene ] + [ cis ] + [ trans ]}$$
wherein [vinyl] is the concentration of vinyl groups in the olefin polymer expressed in E vinyls/1,000 carbon atoms; [vinylidene], [cis] and [trans] are the concentration of vinylidene, cis and trans groups in the olefin polymer expressed in the number of the respective groups per 1,000 carbon atoms

25. A polymer of an olefin monomer and a substituted olefin, comprising:
a backbone chain having endgroups; and
a plurality of side chains,
wherein about 85% to 100% of the backbone chain endgroups have at least one vinyl group.

26. A polymer of an olefin monomer and a substituted olefin, comprising:
a backbone chain having endgroups; and
a plurality of side chains,
wherein about 85% to 100% of the backbone chain endgroups have at least one selected from the group consisting of halide, amine, azide, carboxylic acid, ester, epoxide, alcohol, silane, siloxane, boron, cyano, isocyanate, phosphonium, sulfate, and ammonium groups.

27. The polymer of any of claims 23 to 26, wherein the polymer is characterized as having 0.01 or more long chain branches per 1000 carbon atoms.

28. The polymer of any of claims 23 to 26, wherein the polymer is characterized as having 0.1 or more long chain branches per 1000 carbon atoms.

29. The polymer of any of claims 23 to 26, wherein the polymer is characterized as having 1 or more long chain branches per 1000 carbon atoms.

30. The polymer of any of claims 23 to 26, wherein the polymer is characterized as having 2 or more long chain branches per 1000 carbon atoms.

31. The polymer of any of claims 23 to 26, wherein the polymer is characterized as having 5 or more long chain branches per 1000 carbon atoms.

32. The polymer of any of claims 23 to 26, wherein the polymer is characterized as having 10 or more long chain branches per 1000 carbon atoms.

33. The polymer of any of claims 23 to 26, wherein the polymer is characterized as having a o long chain branch for each repeating unit .

34. The polymer of claim 24 wherein Rᵥ is about 0.90 or greater.

35. The polymer of claim 24 where Rᵥ is 0.95 or greater.

36. The polymer of any of claims 23 to 26 having a molecular weight distribution (Mw/Mn) ranging from about 1.5 to about 100.

37. The polymer of any of claims 23 to 26 having a molecular weight distribution (Mw/Mn) ranging from about 1.5 to about 10.

38. The polymer of any of claims 23 to 26 having a molecular weight distribution (Mw/Mn) ranging from about 2.5 to about 8.

39. The polymer of any of claims 23 to 26 having a molecular weight distribution (Mw/Mn) ranging from about 3 to about 6.

40. The polymer of any of claims 23 to 26 having a molecular weight (Mv) ranging from about 1000 to about 100,000,000.

41. The polymer of any of claims 23 to 26, wherein the olefin monomer is an α-olefin.

42. The polymer of any of claims 23 to 26, wherein the olefin monomer is ethylene, propylene, 1-butene, 1-hexene, 1-octene, 1-decene, vinyl-cyclohexene, styrene, ethylidene norbomene, norbomadiene, 1,5-hexadiene, 1,7-octadiene, and 1,9-decadiene.

43. The polymer of any of claims 23 to 26 wherein the substituted olefin is selected from the group consisting of vinyl fluoride, vinyl chloride, vinyl bromide, vinyl iodide, vinyl acetate, methyl acrylate, methyl vinyl ether, vinyl ketones, isobutyl vinyl ether, vinyl amines, vinyl amides, acrylonitrile, acrylamide, vinyl oxazoles, vinyl thiazoles, and vinyl ethers.

44. The polymer of any of claims 23 to 26 wherein the substituted olefin is vinyl chloride monomer.

45. The polymer of any of claims 23 to 26, wherein the polymer is characterized my an 12 ranging from 0.01 to 1000 grams/10 minutes.

46. The polymer of any of claims 23 to 26 wherein the polymer is characterized by an 110/12 ranging from about 1 to about 20.

47. The polymer of any of claims 23 to 26 wherein the polymer is characterized by an 110/l2 ranging from about 2 to about 10.

48. The polymer of any of claims 23 to 26 wherein the polymer is characterized by an 110/12 ranging from about 6 to about 8.

49. The polymer of any of claims 23 to 26 wherein the polymer has a comb-like structure.

50. The polymer of any of claims 23 to 26, wherein the polymer is a substantially linear polymer.

51. An article of manufacture comprising the composition of any of claims 23 to 26.

52. The article of manufacture claim 51 wherein the article is a film, a fiber, a molding, a coating, a profile, a pouch, a sealant film, a carpet backing, a liner, a shrink film, a stretch film, an extrusion coating, a laminating film, a rotomolding, a sack, a bag, or a pipe.

53. The bag or sack of claim 52 wherein the bag or sack is fabricated using form-fill-seal (FFS) equipment or vertical form-fill-seal equipment.
